(19) United States
(12) Patent Application Publication
(10) Pub. No.: US 2005/0240756 A1
(43) Pub. Date: Oct. 27, 2005

(54) System and method for improving the efficiency, comfort, and/or reliability in Operating Systems, such as for example Windows.

(76) Inventor: Yaron Mayer, Jerusalem (IL)

Correspondence Address: YARON MAYER, 21 AHAD HAAM ST., JERUSALEM, 92151, IL

(21) Appl. No.: 10/907,274

(22) Filed: Mar. 28, 2005

Related U.S. Application Data
(63) Continuation-in-part of application No. 10/775,027, filed on Feb. 8, 2004.
(63) Continuation-in-part of application No. 10/756,839, filed on Jan. 11, 2004.
(60) Provisional application No. 60/557,454, filed on Mar. 28, 2004.
(60) Provisional application No. 60/561,160, filed on Apr. 9, 2004.
(60) Provisional application No. 60/575,981, filed on May 31, 2004.
(60) Provisional application No. 60/602,946, filed on Aug. 20, 2004.

(30) Foreign Application Priority Data
Feb. 7, 2003 (IL) 154349
Jan. 12, 2003 (IL) 153893
Sep. 29, 2003 (CA) 2,444,685
Jan. 6, 2004 (CA) 2,257,957
May 3, 2003 (CA) 2,428,628
Feb. 9, 2004 (CA) 2,457,981
Oct. 5, 2004 (GB) 0422065.3
Jan. 5, 2005 (GB) 0500002.1

(51) Int. Cl. G06F 15/177

(52) U.S. Cl. 713/2

(57) ABSTRACT

Although MS Windows (in its various versions) is at present the most popular OS (Operating System) in personal computers, after years of consecutive improvements there are still various issues which need to be improved, which include for example issues of efficiency, comfort, and/or reliability. The present invention tries to solve the above problems in new ways that include considerable improvements over the prior art. Preferably the system allows for example a “Reset” function, which means that preferably an Image of the state of the OS (including all loaded software) is saved immediately after a successful boot on the disk or other non-volatile memory and is preferably automatically updated when new drivers and/or software that change the state after a boot are added, so that if the system gets stuck it can be instantly restarted as if it has been rebooted. Other features include for example solving the problem that the focus can be grabbed while the user is typing something, allowing the user to easily define or increase or decrease the priority of various processes or open windows, a powerful undo feature that can include preferably even any changes to the hard disk, improved undo features in word processing, improved file comparison features, being able for example to track changes retroactively, improved backup features, and many additional improvements. The application covers also improvements that are related for example to Word processing (since for example in Microsoft Windows, Word behaves like an integral part of the system) and things that are related to the user's Internet surfing experience (This is important since for example in Microsoft Windows, Internet Explorer is practically an integral part of the OS). The invention deals also with some preferable improvements in the performance of the hard disk.

This Patent application is a CIP of U.S. application Ser. No. 10/775,027 of Feb. 8, 2004, which claims priority from Israeli application 154349 of Feb. 7, 2003, hereby incorporated by reference in its entirety, and also claims benefit and priority from U.S. provisional application 60/464,171 of Apr. 14, 2003 and from Canadian application 2,444,685 of Sep. 29, 2003 and from Canadian application 2,257,957 of Jan. 6, 2004, hereby incorporated by reference in their entireties.

This patent application is also a CIP of U.S. application Ser. No. 10/756,839 of Jan. 11, 2004, which claims priority of from Israeli application 153893 of Jan. 12, 2003 and from U.S. Provisional patent applications 60/452,362 of Mar. 2, 2003 and Ser. No. 60/464,171 of Apr. 14, 2003, and from Canadian patent application 2,428,628 of May 3, 2003, hereby incorporated by reference in their entireties.

This patent application also claims priority from Canadian application 2,457,981 of Feb. 9, 2004, and from U.S. provisional application 60/557454 of Mar. 28, 2004, and from U.S. provisional application 60/561,160 of Apr. 9, 2004, and from U.S. provisional application 60/575,981 of May 30, 2004, and from U.S. provisional application 60/602,946 of Aug. 17, 2004, and from U.S. application Ser. No. 10/939,494 of Sep. 14, 2004, and from British application GB0422065.3 of Oct. 5, 2004, and from British application GB0500002.1 of Jan. 5, 2005, hereby incorporated by reference in their entireties.

### BACKGROUND OF THE INVENTION

1. Field of the Invention

The present invention relates to operating systems, and more specifically to a System and method for improving the efficiency, comfort, and/or reliability in Operating Systems, such as for example Microsoft Windows. This can include for example also things that are related for example to Word processing (since for example in Microsoft Windows, Word behaves like an integral part of the system) and things that are related to the user's Internet surfing experience (This is important since for example in Microsoft Windows, Internet Explorer is practically an integral part of the OS). The invention deals also with some preferable improvements in the performance of the hard disk.

2. Background

Although MS Windows (in its various versions) is at present the most popular OS (Operating System) in personal computers, after years of consecutive improvements there are still various issues which need to be improved, which include for example issues of efficiency, comfort, and/or reliability. In the area of efficiency, one of the things that still need improvement is the time it takes the system to boot. For example if windows 98 gets stuck, the user might have to re-boot the system, a process which can take up to a few minutes, especially if there are many programs in the start-up folder and/or if the system starts to scan the disks (If the user does not interrupt the disk scan). Although Windows Me and XP for example include a Hibernate function, it does not help much if the system gets stuck, since Hibernate is mainly useful if the user requests the system on his own initiative to “go to sleep” for fast awakening afterwards. This is accomplished typically by saving an Image of the current state of the computer's memory on the disk when the user issues the “Hibernate” command, and reloading it quickly when the user requests “wake-up”. U.S. patent application 20020078338 filed on Dec. 15, 2000 by IBM, describes an improvement in which the Image is saved automatically immediately after the normal boot sequence has finished, so that, during the next boot, the boot can be automatically set to much faster if there is an Image of the state of the computer and the OS at the end of the last boot. However, this still does not solve the problem completely, since for example if Scandisk is needed, it can still take considerable time, such as for example a number of minutes or even more, and also for example some peripheral devices checks and/or initializations might still be needed and can take for example even up to a minute even during the “instant” boot. The IBM patent does not even mention the problem of the peripheral devices or drivers. Issues of convenience can include for example the fact that various things happen automatically in Windows without asking the user's permission - for example one thing that can aggravate users is the ability of other programs to suddenly snatch the focus from the current Window. If this happens for example while the user is trying to type something, it can be very irritating, especially if it's for example some pop-up commercial advertisement in a browser window while the user is surfing the web and is trying for example to type some data in a form input line or in the URL line. Another convenience issue is for example the problem that when installing a new version of Windows over an existing system, typically the user has a choice of either overwriting the current system, in which case the desktop will remain the same as much as possible (but the user will have to give up the option of still booting the old system), or to install it in a new partition, in which case the user typically has to install almost everything again from scratch. An example of a reliability issue is the fact that making errors, such as for example launching a program which contains a virus or a malicious code, or installing a program which accidentally causes damage for example to the Windows registry or to various directories, can be very difficult to correct. Although, for example, starting from windows ME, there is an option to undo the last installation, it is typically limited to only very specific types of changes in the system, such as for example changes in the registry, but cannot undo other changes, such as for example ruining other directories or files.

Clearly it would be desirable to have improved versions of Windows or of similar Operating Systems, where such problems are solved.

### SUMMARY OF THE INVENTION

The present invention tries to solve the above problems in new ways that include considerable improvements over the prior art.

Regarding the boot problem, preferably the system allows a “Reset” function which means that preferably an Image of the state of the OS (including all loaded software) is saved immediately after a successful boot on the disk and/or on other non-volatile memory and is preferably automatically updated when new drivers and/or software that changes the state after a boot is added. Another possible variation is that more than one Image can be saved, so that for example if something goes wrong after updating the Image, the system can preferably go back for example to the previous Image. Whenever the system gets stuck (and/or for example if the user simply wants to clear the computer's memory and go back to a state like after a normal boot), preferably the user is able for example to press some special button or some key or keys on the keyboard in a way that causes the computer's memory to instantly Reset from the saved Image, without a need to go through a boot sequence at all. The special button or key is preferably sensed either by hardware or by some process which preferably runs below the Operating system and thus in not affected even when the system becomes stuck. In addition, preferably any cut & paste buffers are automatically saved also on the disk and/or other non-volatile memory, so that they can be immediately available on the next boot or after the next Reset. Similarly, preferably any currently edited files or windows are preferably automatically saved on the disk and/or on other non-volatile memory preferably after sufficient minimal changes have accumulated (such as for example after at least 10 new characters, or any other convenient number, have been added or changed) or every short while (for example every 30 seconds), so that they can be immediately available on the next boot or after the next Reset. Preferably, during or after a fast-boot or a Reset that uses the memory Image (and/or even during or after a normal boot), if the FAT of the disks needs to be checked, preferably it is done in the background and without significantly slowing down the disk or the CPU, after the user can already start working, since waiting for scandisk to finish can take several minutes and can be very aggravating to most users. Preferably the system runs a minimal scandisk in advance at most only on the area where the image itself is stored or does that only if there is for example some CRC problem when trying to get the image, since only that area might have to be scanned before the boot or Reset if there is a problem. Another possible variation is that the Scandisk (or similar software) is backed up by hardware, for example in a way similar to the hardware that supports automatic disk rollback, described below. Preferably this is done by using hard-disks or other non-volatile memory wherein a special area or areas is dedicated for FAT information, and preferably independent head or heads or other access means are used for read and write in those areas. This has the further advantage that any reading or writing of files can become faster even if they are fragmented, since less movements of the heads are needed to access the FAT area each time some jump is needed (Of course the FAT can be also for example loaded into RAM or into cache memory for reading, but due to safety reasons changes to the FAT have to written to the hard-disk or other non-volatile media as soon as possible, and that is why these improvements are very important). Since each disk can have more than one partition, preferably the FAT areas of all partitions are kept in the same special area or areas. Preferably these areas are also guarded better in terms of security, so that for example any write-access to them is monitored more closely. Of course the Image and/or any other saved data can be kept also, in addition or instead, on any non-volatile type of memory, such as for example MRAM (Magnetic RAM), which will become available in a few years, 3d Nano-RAM chips, etc. In such cases, instead of separate or independent heads, for example separate or independent access channels or processors can be used. Another possible variation is that for example the hard disk has one or more separate heads which are used for example only for checking the media for errors and for example move automatically all the time or periodically once in a while to check this without interfering with the normal function of the hard disk. Another problem is that for example in Windows XP many times after a program has finished installing it requests the user to do a complete restart of the computer, which can take considerable time especially for example if the motherboard contains a RAID driver for some of the devices (typical for example in new motherboards which support for example both IDE and SATA), while in almost all cases logging-off and logging-on again into Windows would be quite sufficient and of course much faster. Full restart should normally be required only for example if a new hardware has been added (in most cases this requires turning off the power so a full restart happens anyway) or for example in some cases of rewriting the flash memory of some devices. So preferably by default either the OS automatically determines if a full restart is needed (for example according to the nature of the new installation), and then preferably the OS automatically performs just logoff and logon instead of a full restart whenever it can determine that this is sufficient, and/or for example standard installers are improved so that the software vendors can easily indicate (for example through some flag or flags) if logoff-logon is sufficient (for example even mark it as a set of automatic conditional rules, depending for example on various parameters, such as for example the OS version and/or various hardware parameters). Another possible variation is that preferably when the user himself/herself initiates a restart command (especially for example if no new software has been installed since the last boot and/or for example if the user has not recently inserted a bootable diskette or CD into one of the drives), preferably the OS automatically asks the user if he/she really wants a full reboot and, if not, preferably offers the user to automatically perform logoff-logon instead. Another possible variation is that at least for example the logon/logoff is added also to the normal Restart/Turnoff menu, so that for example instead of showing only 3 options (Standby, Turnoff and Restart) preferably the option of fast Logoff/Logon is also added. Another possible variation is that preferably if the user chooses for example full reboot and/or even if he/she chooses just logoff and the system begins to close applications, preferably first of all only user applications are closed and not system processes and preferably the user can still for example press some key if he/she changes his/her mind in order to abort the reboot, and then for example the attempt to reboot is preferably aborted if it has not gone too far, and/or the system can automatically undo the process and even return the OS to the state it was before the reboot was requested (for example by keeping in one or more buffers also the state of the open files and processes so that they can be restored automatically to their state before the reboot was requested).

Of course, various combinations of the above and other variations can also be used.

Regarding the focus-grabbing problem, preferably when the user is in the middle of typing something, preferably the focus cannot be automatically snatched away by another program, so that for example the change of focus can occur only after the user has stopped typing for a certain minimal period, such as for example a few seconds or more. Another possible variation is that other programs can snatch the focus only in case of emergency, such as for example an event that is intercepted by the computer's security system, the firewall, or the OS. Preferably this is done by allowing this only to the OS and/or the security system of the computer and/or for example the firewall, and/or any other software which has been given explicit permission by the user to have such rights. Another possible variation is that programs are not allowed to snatch away the focus while the user is in the middle of typing something, as above, but for example in case of emergency, for example instead of snatching away the focus, important messages can be displayed for example by flashing a message on some part of the screen and/or by any other conspicuous visual means and/for example or by audible sound (for example a spoken vocal message), so that the user's attention can be immediately grabbed, without automatically disturbing his typing efforts. Another possible variation is that if the focus is snatched while the user was typing, preferably his keystrokes continue to be kept for example in a special buffer, so that when the user notices that the focus has changed and goes back to the original window where he was typing, the keys that he typed while the focus has changed are again available. This can be done for example by a special process (for example part of the OS, or some dedicated service) that keeps a copy of the most recent keystrokes and can replay them even if the keystrokes were supposedly wasted in another process that popped up during the typing. Of course, various combinations of the above and other variations can also be used.

Another possible variation that is also related to the focus issue, is that for example clicking with the mouse on any part of the desktop (or for example pressing some key or keys on the keyboard) will immediately bring the desktop fully into the foreground like clicking on any other windows, so that there is no need to click for example on the special icon in the taskbar to do that, as exists today for example in Windows. In the prior art clicking on the desktop does not cause other windows that cover parts of it to move down to the task bar, eventhough it can change the focus, so the user has to click on a special icon if he wants to get a clear view of the desktop. Preferably this option is made available to the user in addition to and not instead of the icon that brings the desktop to the foreground, since sometimes there is no piece of the desktop available for clicking on it, but on the other hand, if part of the desktop is in view, it is much easier to click on it than to have to go down to the specific location of the small icon, and also in the currentprior art situation it can be quite frustrating that clicking on a visible part of the desktop does not automatically bring the desktop to the foreground, unlike any other windows where clicking on any part of it does bring it automatically to the foreground. Another possible variation is that for example the clear desktop view is automatically added to the list of available options when pressing for example Alt-Tab (or other similar keys for jumping between open windows or applications), so that the user can also jump to the clear desktop by keeping the Alt key pressed and pressing Tab until the correct icon is reached, and/or simply pressing for example one or more keys on the keyboard in order to jump directly to the clear desktop. priorities. Although Windows XP for example allows the user to choose between more or less priority to background processes in general, this does not allow the user to choose it for individual processes, and the user has to go into the control panel to reach the place where it can be changed. On the other hand, in Windows XP the user may choose among a few priority levels for each process by pressing Control-Alt-Del and entering the task manager, however this does not show automatically the priority for each process, and the user has to click on each process in the task manager separately and choose from a menu in order to view or change its priority. On the other hand the user may for example use the Process Viewer (Pviewer.exe), a tool on the Windows NT Resource Kit 4.0 CD, to change also the priority of individual processes, but this requires entering a special window where all the processes are listed. Similarly for example a shareware called Priority Master (version 3.2) includes even more options, and can indicate for example the priority of a process if the user hovers the mouse for about a second above an item in the bottom task bar, and also shows this indeed on the title line of an open window. However, the above suggested improvement of constantly displaying the priority near each square in the task bar is more convenient and more efficient. Another possible improvement is that the taskbar can show automatically for example also how much percent of CPU is being used on average by each open process. Although windows XP for example allows the user to view CPU usage of various processes in a special window, preferably the user can also see this directly on the task bar without having to go through special menus for that. Another possible variation is that the priority of background and/or foreground processes is automatically dynamically increased according to the type of the work the user is doing in the foreground window, so that if the user is for example typing on Word or surfing with Netscape, more CPU resources can be automatically allocated to the background programs. This is especially important for example when DOS programs are involved since in the prior art usually if they are in the background for example in Windows 98, they can remain with very low priority even if the user is just typing or even if the computer is not really doing anything, whereas much more CPU could have been allocated to them. Another possible variation is that for example when the user enters the task manager (for example by pressing Control-Alt-Del), he/she can for example mark multiple programs (for example by dragging the mouse over a range of them) and tell the OS to close all of them at once, instead of the prior art where the user has to mark and close them one at a time and also press Control-Alt-Del again each time. Another preferable variation is that preferably the task manager automatically shows near each process also to which program and/or path and file name (for example on the hard disk) it belongs. Another possible variation is that preferably the user can choose to automatically sort the processes shown in the task manager for example alphabetically and/or according to how much resources they consume (for example CPU, memory, Internet bandwidth, disk space, etc.), and/or for example according the programs they belong to,

Another possible variation that is also related to the focus issue is to add for example a feature that allows the user more easily to define or increase or decrease the priority of various processes or open windows, since for example many times the user wishes some program to continue working on something lengthy in the background while he is doing other things, but many times the OS automatically assumes that if the user diverted the focus to something else, the processes that are in the background (i.e. not in focus) can be given much lower priority and so left to work much slower, so that the user finds that very little progress has been made when he goes back for example to a process that could have been finished in a few minutes if it was in the foreground or given higher priority (This can happen for example especially with programs that are running in a DOS window for example in Windows 98). Preferably the user can easily define the desired priority level for such background processes, for example in terms of percentages, and/or in terms of increasing or decreasing some default values for example in a few discrete steps, and/or for example in terms of more general definitions such as for example “Very high, high, medium, low, very low”, etc. Although typically a programmer can define the level of priority for a process, the user for example in Windows 98 does not have such a choice except in a few programs in which the programmers chose to explicitly give the user such an option, and also the user does not typically know which priority was set by the programmer. So preferably the OS also indicates to the user clearly, for example by colors (for example brighter colors for higher priority process) and/or by numeric and/or textual values and/or by appropriate icons, the level of priority that has been given to each process, for example by indicating it near or on each square in the for example bottom taskbar that shows active processes, and/or indicating it for example at the top line of the window of each process. For example on the square in the taskbar it can be more preferable to indicate this by a color, since there is little space, and for example on the top line of a window it is easier to indicate this for example by a combination of color and/or for example more exact numeric indication. Therefore, the default first priority shown to the user can be for example a default priority automatically set by the OS or the priority set by the programmer, or for example the priority set by the user the last time the program was run. Preferably the user can easily change the priority for example by clicking on the place where the priority is indicated at or near the taskbar and/or on the window of the process (for example at the top line), so that for example the clicking opens a preferably small windows where the user can choose the priority or for example a lever is shown which the user can pull up or down. Preferably the OS remembers the priorities given by the user to various processes and uses these defaults or at least takes them into consideration for assigning automatically the priorities the next time the user does similar things or activates the same processes, unless the user again changes the and/or other criteria. Another problem is that for example in windows 98 many times the user has to try multiple times to close an application through Control-Alt-Del (or for example when the system tells the user that the application performed an illegal action and asks the user if to close it) until the application is really closed. So preferably in case it hasn't been closed the OS automatically tries again repeatedly to close it, preferably for example at least for a certain number of times and/or till a certain time limit, and preferably the OS lets the user know if there is still a problem after the number of times and/or the time limit has been reached if the OS was still unable to close the application. (Preferably the automatic re-attempting is also accompanied by some visual indicator) Of course, various combinations of the above and other variations can also be used.

Regarding installation of a new operating system in a new directory or partition, preferably during the installation the new system preferably automatically copies the desktop configuration and links from the old system into the desktop of the new system. Since some installed components will not work the same between two different versions of Windows (such as for example when running installed components of windows 98 on windows XP), preferably the system automatically checks which programs can work automatically without problems also in the new system (for example applications that don't have to access the registry, etc.), and preferably for example indicates to the user which applications might need some adjustment and/or tries automatically to solve this problem for those applications too. There are a number of possible preferable solutions for this, of which preferably at least one is used:

During installation of the new system, preferably the system tries to automatically convert components that are different between the two systems to work on the new system, for example by automatically converting system calls, memory structures (if needed), etc.

During installation of the new system, preferably the system tries to locate the original files which were used for the installation and then tries to reinstall automatically the correct drivers or components that are needed for the new system. For this, preferably each Windows system keeps information (for example in the registry and/or in one or more of the directories where the installed program or component or drivers resides) about the path and name of the original file from which it was installed, so that the installation can be automatically repeated into the new system, this time with the components that are needed for the new system.

If the system does not succeed in converting the relevant links or components to work on the new system or for example the original installation program is limited only to the old system (for example Windows 98) and does not contain for example drivers for the new system (for example Windows XP), then preferably the system marks the relevant links on the new desktop as non-operational (for example by giving them dim gray color) and encourages the user to look for other versions of those programs that are fitted to work on the new system. Another possible variation is that in such cases the system allows the link to activate the version that runs under the old system (or for example creates another copy of it) and uses emulation of the old system when needed in order to let it run. Another possible variation is that the system can automatically try to locate on the Internet any needed variations or drivers that will work on the new OS and for example recommends them to the user and/or for example can download them automatically from certified sources (preferably of course only after user authorization for each downloaded file). (This is relevant mainly for example for shareware programs).

Preferably a new protocol for installing programs is implemented so that each installation of new software preferably installs both the appropriate drivers or components (for example Windows 98 drivers on a windows 98 system) and one or more sets of alternate drivers or components (for example for Windows NT/XP or other Operating Systems), and preferably each time the program is loaded into memory the appropriate set of drivers or components is automatically chosen by the OS. However, since in some programs part of the installation requires for example updating registries and/or installing various components in system directories, preferably those parts of the installation are suspended and are executed automatically for example the first time that the new OS is activated for the first time after installing it.

Of course, various combinations of the above and other variations can also be used.

Regarding the undo problem, preferably any changes in the entire hard disk or other types of preferably fast mass storage non-volatile memory after or during the installation of new software, are completely undo-able at least for a certain time period. This is more comprehensive than the current “undo” feature that Microsoft for example offers after installing new software, since the current features only allow restoring the registry and system files, and even that not always completely, whereas any other changes to directories or files cannot be undone. A more extreme variation is that for example any changes at all that happen on the hard disk or other non-volatile memory (and possibly even on other connected media) at any time are completely undo-able at least for a certain time period, in a way similar for example to the undo feature in a single Word document. The above Undo features are preferably accomplished by keeping one or more rollback log, preferably backed up by appropriate hardware on the disk—as explained below in the reference to FIG. 2.

Other possible improvements in word processing programs such as for example Microsoft Word can include preferably at least one of the following:

Adding to word processors such as for example Word, for example a smart file-compare features that can show exactly the textual differences between two or more files while disregarding irrelevant data such as line breaks, fonts, etc. In the prior art this can be done for example by a text file compare program after saving the word file as text files with line breaks, but then the comparison might show many irrelevant changes for each paragraph because of changes in line breaks for example if even one word was changed near the beginning of the paragraph. Another possible variation is to allow the program to merge for example two files into a single file with highlighted changes just as if one of the files was created out of the other while keeping the “highlight changes” option to On. This is very useful for example for checking changes between a current version of a file and any of the previous versions retroactively even if no change tracking was used during the time that the changes were made. In order to accomplish this preferably the changes are checked in a way similar to the non-merging file comparison, except that the results are displayed in the form of the merged file. Another possible variation is that for example cut & paste of one file over another file (and/or in fact cut & paste s section, such as for example a few words or a few lines or one or more paragraphs, over another section) when “highlight changes” is set to ON automatically generates the highlighted changes between the two sections as if they were made by actually changing one to the other, instead of the current prior art in which the results of such cut & paste are that the old text area is simply marked as deleted by strikeover and the new text is simply marked as added (this is preferably accomplished, again, by simple comparison between the original text and the pasted text, and marking the differences by the conventions of highlighted changes, as if the changes were made manually). Although Microsoft Word currently allows an option of file comparison, which marks the changes between the two files as if the “track changes” was set to On between the old file and the new file, as explained above comparing sections by cut and paste does not work (the previous text is simply marked as deleted and the pasted text is marked as new, instead of making a comparison), and even the comparison of two files is not sufficiently reliable and has at least the following problems:

If at least one of the two compared files already contains marked changes, Word warns you that it may not be able to show all the changes, and there is no differentiation between previous marked changes and the changes that are indicated by the comparison itself. In order to solve this preferably in such cases a different indication is used between the old changes and the new changes generated by the comparison, for example by using additional colors, and/or using for example different special icons and/or marks near the old changes and/or near the new changes, and/or using for example different special squares and/or other frames around the old and/or the new changes, and/or using for example special fonts and/or other font characteristics, etc. However, using different colors could be problematic since different colors are already used for indicating who made each set of changes, so this might be confusing, and in addition, if such a file (that resulted from a comparison) is then again compared with another file, more and more colors might be needed. A more preferred variation is that for example in each stage of the comparison the old changes are automatically marked for example by more faded or less lit colors (but preferably keeping the original colors), and if comparison steps continue then preferably at the next step preferably all previous changes now become faded, and the new comparison changes are marked with brighter colors. However, these are just examples and any type different marking can be used. Another possible variation is that for example a summary table or other type of index is automatically generated so that the table or index indicates which color was added on which date (preferably taken automatically from the date of the file which each color of changes represents), so that the user can clearly see which change was entered at each date (and/or time). Another possible variation is that, in addition or instead, the date in which each section or element was added or changed is automatically indicated near the relevant text, for example by a bubble that is shown when the user points the cursor or the mouse on the relevant section, but more preferably this is marked all the time, preferably at the side of each section, so that it is clearly visible even without having to indicate the section, and preferably it is clearly visible also in the printed version near each section. In order to accomplish this preferably the files are automatically sorted by date before creating the comparison, and each new section or element is dated automatically according to the first time it appeared. Another possible variation is to use similar fading for example also with normal incremental changes when track changes is used, so that for example the user can use a command that fades (or otherwise changes) the color of preferably all the older changes so that all the new changes from that point on will stand out. This is very important for example when a file in changed in incremental steps and each time for example the new version is sent by email to someone else. Another possible variation is that for example the OS and/or the word processor can identify automatically incremental updates of the same file (for example according to the beginning of the file name and/or date and/or for example by keeping automatically a log of the sequence of updating a file incrementally), so that the OS and/or the word processor can use the knowledge of the update sequence of a series of files for example to search for example for each section or sentence when was the first time that it was entered.

The file comparison is not always reliable and may get sections confused, so that for example when comparing two patent files, the comparison can confuse for example between a claims section and a specification section, thus marking entire areas as deleted and added instead of properly comparing them. In order to prevent this, preferably the system uses preferably various heuristics in order to extract from the document important information about its structure, so that for example a section that appears after a clear headline (which is typically for example on a separate line and is typically emphasized for example by boldface and/or by underline and/or sometimes for example by capital letters) is preferably automatically recognized as a different section of the documents, and this way for example a section that appears after the headline CLAIMS will not be confused with a specification section. In addition, the system can use for example other cues about each section, since for example the claims section is clearly characterized by short paragraphs that each start with a consecutive number, which is unlike any other part in the document. Such cues and/or heuristics are preferably used in a fuzzy manner, so that they are considered as part of the evidence but not as absolute guidelines, so that for example if there is more evidence that indicates otherwise, such cues can preferably also be ignored. For example a thorough academic article from 1988 about file comparisons at http://citeseer.nj.nec.com/cache/papers/cs/6985/http:zSzzSzwww.ime.usp.brzSz˜iszSzpapirzSzsct.pdf/simon88sequence.pdf shows that the file comparison problem is theoretically and practically not completely solved yet, but this article deals mainly with various methods of increasing the speed of such algorithms (which is far less critical today, now that computers are thousands of times faster than 15 years ago), and much less with how to improve the reliability of such algorithms. U.S. Pat. No. 6,526,410, issued on Feb. 25, 2003 to the Hitachi company, shows how to improve such algorithms in explicitly structured documents, such as for example XML documents, by making the comparison first between the XML structures, and then comparing the text only between structures that are determined to be within the corresponding sub-structure, and typically working with a table of explicit comparison rules. However their solution does not solve the problem for example for Word documents, which are the most common type of documents for example in legal documents such as for example contracts and for example patent applications, where file comparison can be very important. Therefore, the above suggested solution is much more general since it can work for example also with word processing documents, such as for example Word documents, where there is no explicit hard-definition structure, but smart heuristics can easily use relevant cues to identify actual sections, and in addition the above solution is more flexible since the identified sections preferably don't become absolutely binding, so that for example if other criteria (such as for example the percent of the common sequences found) indicate that it is better to ignore one or more apparent section indicators, this is preferably done. In addition, preferably the same principles are used and applied recursively when needed. Another possible variation is that for example if the user sees that a certain part of the documents (or more than one part) has not been properly merged (for example the end of the specification together with the claims), then the user can preferably for example mark, for example with the mouse, the problematic section or sections, and then tell the system to try again to merge more properly the problematic section or sections.

Only 2 files can be compared at each step. So instead, preferably the system allows to compare also more than two files in each step, and so in the merged file of for example 3 files, changes that come from different files are preferably marked in different colors (for example in a way similar to marking changes that were added by different people in different colors), or marked differentially by other methods, for example such as those mentioned in clause ‘a’ above.

Another big problem with the current track-changes features that exist for example in Word 2000 and Word 2002 is that if the user for example breaks an automatically numbered paragraph, where for example each part is automatically marked by a letter or by a number (such as for example in patent claims) into two paragraphs, the part after the break becomes marked (typically in red) as if it is a new text, instead of marking only the real change, which is the new line break and the changes in the subsequent automatic numbers. On the other hand, if the user makes the changes without the track-changes feature On and then uses file-compare, the comparison does not mark the text after the break as a new text (which is good) but now the showing of the changes in the subsequent automatic numbers is not done). This is of course a problematic lack of consistency. So preferably this is improved so that when the track changes feature is On and the user breaks an automatically numbered paragraph, only the new break and the change in subsequent renumbering is shown and the part after the break is not marked as new text, and when comparing files the same consistent difference is shown. In addition there is a problem that when a text is marked as deleted, for example as a result of track changes or of file comparison, if the user wants to undelete it or part of it, the user cannot do it directly (unless it is the most recent change and can be restored by normal Undo), and the user cannot even mark and copy the deleted text and convert it to non-deleted text. So preferably this is improved so that when a text is marked as deleted as a result of track changes or of file comparison, the user can mark the deleted text or part of it and press for example a key or button or otherwise execute a command which can instantly undelete it. In addition, the user can preferably also mark and copy text that is marked as deleted or any part of it and can preferably paste it back at the same place or elsewhere for example as normal text. (Another possible variation is that he can choose for example if to paste it as normal text or as text marked as deleted). Another preferable improvement is that preferably the user can switch between the Track changes On and Off states also by some control key instead of having to go through a series of menu choices, as it is currently in Word. In addition, preferably when the user copies and pastes text that contains marked changes, the user can preferably define, preferably when pasting, if he/she wants the pasted text to contain the marks or not. Another possible variation is that the user can for example mark one or more areas in which track changes is marked as On (or Off), so that the other areas for example remain with track changes Off (or On), etc. This can be very useful for example with the new required format for amendments in the USPTO, since when answering for example an Office action the user typically has to use track changes when making changes in the area that contains the amended claims but remove the track changes when moving to the comments section. In addition, in the prior art, even when just working on the section of the amended claims, the user has to switch to track changes Off when adding for example the words “(Original)” or “(Currently amended)” at the beginning of the claim and then switch back to track changes On when changing the claim itself, etc. So preferably, the user can for example automatically add for example the default of the word “Original” at the beginning of each claim for example by using the command that allows defining an automatic rule for this structure, as explained above, and then for example define or choose in the automatic rules command (or for example mark the entire claims area and define in the claims area) a mode which automatically adds for example the “(Currently amended)” when the user makes changes in that claim, so that the user does not have to switch to Track changes off, and the words “(Currently amended)” are automatically added without track changes. Similarly, in this mode preferably for example deleting an entire claim preferably automatically causes the deleted text to disappear, and the word “(Canceled)” to automatically appear instead, as if track changes has been temporarily suspended. Similarly, for example when adding new claims at the end of the claims section, preferably the track changes is automatically set to Off and the word “(New)” is preferably automatically inserted at the beginning of the new claim. Another possible variation is that if the user for example made a mistake and typed text in “track changes off” mode and wants to make the new text marked, he can for example use AZ to temporarily remove the newly entered text, activate the track changes and then for example type Ay and the new text preferably automatically becomes marked. Another problem with the track changes feature is that typically on the screen the changes are most conspicuous when shown in color (especially for example in red, which is the default for example in Word, if only one user makes the changes), however when printing the file for example in laser printers the red typically becomes a weak gray shade which can be difficult to read. Although Word allows the user to change the color of the marked changes for example from the typical red/blue to black, in the prior art this affects both the on-screen display and the printing, which is very inconvenient for the above reasons. So instead preferably this is improved so that the user can preferably define separate colors for displaying the changes on the screen and when printed. Preferably by default the on-screen display is the automatic colors, and the printing is preferably by default in black if a black and white printer driver is used and preferably automatically by default in color if a color printer is used (or for example black by default also in color printers unless the user changes it). Another possible variation is that the user can for example also change these definitions in a way that applies only to a given file, instead of being able only to change it globally in a way that affects all files until changed again by the user, and/or for example change these defaults for all the files in the same directory and/or for example change it automatically in all the files with have a very similar file name or for example identical first characters (for example first 7 characters or for example first 50% of characters, etc), or for example all files which are previous versions of the same current file (which means that preferably the word processor also keeps automatic track of version history and/or for example generates this automatically for example according to file names and/or sequential numerals and/or time & date, etc.). Preferably the word processing program can ask the user automatically for various types changes in the way the word processor operates if the change is intended only for the current file or for example for all the files in the same directory or for example all of the files of the same sequence all the files in generalI or for example one of the other options detailed above. Another problem is that that the strikeout on some characters is almost invisible—for example the digit 4 has a horizontal line almost at the exact position of the strikeout line. So preferably the strikeout line is automatically moved higher or lower on such characters, or for example in a line or a word or a section where such characters exist the entire strikeout line is automatically made lower or higher as needed, and/or for example the strikeout line is automatically made of a different thickness and/or length and/or angle and/or color (for example just over the problematic character or over the problematic word or section or line). Another problem is that for example in Microsoft Word if the cursor stands on a word that is marked as deleted and the user enters the dictionary, the word is not seen by the dictionary, and trying to access it in the dictionary can also cause the cursor to jump one word backwards. So this is preferably improved so that the striked-out words behave like normal words on the dictionary. Another possible variation is that for example when a section (for example one or more characters or words) is deleted and then reentered next to the deleted text (for example a deleted digit 9 next to a newly entered digit 9), preferably the word processor can automatically integrate then by removing the deleted redundant part, since it adds no information and looks confusingly like a change where there is really no change. Another possible variation is that preferably the word processor allows the user to choose by himself/herself what color his/her new changes will be, since in the prior art this is determined automatically and sometimes for example Word can assign to the user by mistake a color that already belongs to one set of changes even if these comments were not made by him/her.

Preferably the word processing program behaves consistently with cut & paste where Internet pages are involved, so that for example images are kept properly as an internal part of the document (preferably including also any internet links that the images are pointing to), just as if they were included out of a file for example. For example the way Microsoft Word currently behaves is that if you save a remote Internet page by cut & paste (such as for example http://news.google.com) then the images don't show up at all. On the other hand, if you first save the page locally and then use cut & paste then the images do show up, however they are linked to the local directory where the images were saved, so if the user for example later sends the same Word file to someone else then the images are again missing when that someone else opens the file. (This same problem happens also if the page that was saved locally is properly opened by Word as a local web page and for example is then saved as a Word document). This is inconsistent with the behavior of other images, which become an integral part of the file. This is preferably solved as follows: If the links are to local images then preferably they are automatically inserted into the document file itself, and if they are based on links to the actual Internet then preferably they are also included internally in the document and/or are saved as links (preferably the user is asked which these options he prefers).

Preferably the word processing program (or other programs that deal with opening files, such as for example other Office programs) remembers automatically for example in the “Open file” dialogue box and/or in the “Save” dialogue box if the user typed last time a filename (or path) in English or in another language (for example Hebrew) and preferably leaves this as the default for the next time. This is very important since it can be very aggravating if the program for example insists each time to start the dialogue box in Hebrew even though the user wants each time to type a name in English. Preferably this default is remembered of course also after closing and re-opening the word processor (for example by saving it automatically in some preferably small configuration file). Preferably the word processor also remembers similarly according to the last internal search in which language the user prefers to perform the search within the file. Another possible variation is that preferably the word processor and/or other applications and/or the dialogue box for example remembers and displays automatically the last requested file pattern when the user tries to open a new file (for example ‘f:\pats\betwin*13*’) and for example if the user for example enters new input—instead of for example pressing enter (to use this pattern) or for example using the arrows and making changes—then the pattern is removed, instead of the prior art, where the input line is empty and the user has to search in a scroll list to find previous search patterns. Another problem is that if for example Word and/or Windows crashes, the next time that the user opens the word processor he/she is typically given the option to re-edit an automatically saved copy of the files that were open before the crash, but if he/she closes them he/she cannot automatically regain access to them, even if for example he/she later finds out that he/she does indeed need one or more of them. So preferably the word processor is improved so that even after the user closes those automatically offered files, he/she can preferably still activate an option that restores them, preferably even if the user in the meantime closes the word processor and then later reopens it. For this preferably the word processor keeps one or more buffers which point to these automatically saved files and preferably has an indication which groups of files belong together and/or to which crash event they are related, and preferably these files are kept in the original directories of the relevant files (and/or for example in a special directory) for example at least for a certain time period and/or for example as long as there is sufficient disk space and/or for example until their cumulative total space exceeds some value (and then preferably the oldest files are deleted if needed).

Preferably the user can use for example AZ (Control-z) (or other similar commands) to undo the last changes even after closing and reopening a file, unlike the prior art, in which this can only be done as long as the file remains open. This is preferably done either by saving the undo data in the file itself, or (more preferably) by saving it preferably in another local file, so that the original file preferably only contains a link to the associated local undo file. This has the advantage that when sending for example the file to someone else the previous versions and last changes are not transmitted together with that file to the other person, and yet the original user has flexibility to use the undo even after the file was already closed, as explained above.

Preferably the word processor program allows the user also options of searching and/or substituting for example based on style (including of course for example text color and/or background color and/or underline and/or boldface and/or italics and/or font type and/or any other feature) and/or shape and/or size instead of just character strings, so that for example the user can request to find the next underlined word (or words or section), or for example the next words that are in italics or for example to jump to the next marked change (when changes where marked for example by using the “track changes” feature or the file comparison feature) or for example request to automatically convert all the words that are in italics to underline or vice versa, or for example to automatically convert all fonts of size 1 3 to size 1 4 without affecting other font sizes, or for example to increase automatically all the font sizes by a certain additive or multiplicatory factor (so that for example each font size will increase by 1 pixel), or for example to convert one or more word to another word or words and define that the new word or words will for example be marked by underline and/or other style and/or shape and/or size in each occurrence that is thus substituted, etc. (Although when activating the “accept changes option” Word for example allows the user to jump to the next marked change, this is much less convenient and for example marks the found change in black block, and the user has to click on a number of menu options to reach this whereas it would be much more convenient if it became a standard available search option like any other search, so that the user can preferably also afterwards for example simply jump to the next such text for example by simply pressing Ctrl-PgDn, like in other repeat-searches). Another problem is that when the user for example tries to make a repeated change in Word but confirm it at each step (instead of just global change), the position of the search-and-replace dialogue box many times changes (if otherwise it would cover the relevant text), which forces the user to move the mouse to the new position instead of just keeping his/her hand at the same place and just pressing the Replace or Find-next buttons. So preferably instead, either the position of the search-and-replace dialogue box is always kept constant and the text itself is automatically always scrolled so that the relevant part is visible, or if the position of the search-and-replace dialogue box does move, preferably the mouse cursor automatically jumps with it, so the user does not have to move the mouse to correct for the change is the position of the search-and-replace dialogue box. Another possible variation is that the user can mark one or more areas in the file and activate the “accept changes” command and then the “accept changes” (for example accept ALL changes) can be automatically done only in the marked areas. Another possible variation is that when there are for example different sets of marked changes (for example according to the time or file version in which the set of changes was made, and/or according to the source of the changes), preferably the user can for example instruct the word processor to automatically accept all the changes but only for example from a certain date or dates or a certain source or sources. For this preferably the word processor automatically shows the user a menu of the available options and allows him/her to choose for example by marking one or more of the desired options. Another possible variation is to include in the search also logical paragraph numbering, so that the user can for example search for a clause that starts with an automatically numbered letter or number (for example “a.” or “35.”). Another possible variation is to allow the user for example to automatically reformat all the logically numbered paragraphs and/or for example to use a certain constant indentation factor without having to mark them, so that for example in patent claims (numbered automatically with numbers, in which some of the claims contain for example sub-clauses marked automatically by letters), the user does not have to mark and move the sub-clauses for each claim separately (as he would have to do in the prior art, since marking for example all the claims together would change both the clauses and the sub clauses to the same indentation) but can for example change some global definition that automatically affects each type of automatically numbered element or for example affects all of them only in the marked section (for example all the claims)—for example a definition for all the 1^{st} level clauses, a definition for all the 2^{nd} degree sub clauses, etc., or for example the user can define general indentation rules, so that for example for each sub-level the indentation is defined for example as 3 more characters to the right, then the previous level, etc. Similarly, preferably the user can also preferably easily define other rules which apply to all similar structures (preferably by defining an example or choosing for example from general rules), so that for example the user can easily define that in structures such as patent claims each sub-clause within a claim will automatically end for example with a “;” and only the last sub-clause will automatically end with a “.”, etc. Another preferable variation is that the user can for example mark one or more sections (for example with the mouse) and then for example toggle automatically between modes so that for example automatic numbers and/or letters can become manual letters and/or numbers and vice versa (for example in the CLAIMS section of a patent). This is much better then the prior art, where the user has to manually convert each number or letter one at a time from automatic mode to real numbers and letters one after the other, or vice versa. (Of course, a conversion from automatic to real numbers and/or letters can be done for example by saving the Word document as a text file, but that is much less convenient and has other disadvantages because it entails losing other format features).

In the prior art Microsoft Word, deleting the “Enter” between two paragraphs can cause for example the first paragraph to change automatically its font (for example become bigger or smaller or a different font or in a different style) for example according to some qualities of the empty line that was deleted between the paragraphs or some other reason. Since obviously the user does not intent to create such changes by merely deleting an empty line between two paragraphs, preferably no such changes are created. Preferably fonts and/or style are automatically changed for example only in the 2^{nd} paragraphs after connecting it with the 1^{st} paragraph (for example to become like in the first paragraph), and even that is preferably not done automatically but only if the user allows this by default or requests this specifically for example by pressing some key or some button.

Another problem with word processors such as for example Word, is that URL links (typically Internet links) (for example http://www.opnix.com/products_services/orbit1000/Middle_Mile_Mayhem.pdf) are not treated properly when paragraphs are automatically aligned, so that for example a URL link that is too long can jump to the next line and cause the words in the previous line to become with too many spaces between them (as it happens for example with the above exemplary link), and if the user manually fixes this for example by breaking the URL for example at the position of one of the slashes, this will cause the link not to work properly, and also, if the paragraph is then changed again, the broken part of the link might come back to the previous line, thus causing the link to appear as if there is a space between the two parts. On the other hand, if the link is too long to fit even an independent line, it is currently broken by Word at the last character that fits the line (as happens in the above exemplary link), instead of breaking it more smartly, preferably according to the closest slash. So preferably this is improved, so that links are preferably automatically and dynamically broken and restored between the lines as the paragraph changes, preferably according to slashes (and/or for example sometimes underlines and/or dots and/or other special characters), and preferably when the user presses the link, it is treated as one consecutive link regardless of this automatically changing break between the lines. Another very serious problem with URL links is that for example if the user copies and pastes a new http link over a previous http link for example in Word, the address appears as if it has been changed, but when the user presses the link he actually gets the original link. So preferably the word processor (or other application) automatically replaces also the internal link to automatically comply with the visible link, or for example saves only the visible link and uses that information when the user tries to access the link.

Another problem is that in large files if the user wants to mark large areas with the mouse (for example from a certain point till the end of the file), he/she must continue to hold the mouse pointer near the bottom of the page with the mouse key pressed, which can be quite annoying. So preferably for example while the mouse key is still pressed, the user can for example use other location commands, such as for example Control-PageDown or Control-End or search commands, and then preferably the entire area till the next location becomes marked, instead of having to wait for the page to scroll. Another possible variation is that for example pressing some key can significantly increase the speed of the scrolling or for example moving the mouse further to a more extreme position significantly increases the speed of the scrolling (preferably this is linear, so that the speed changes gradually according to how extreme the position of the mouse is). Another possible variation is that if the user already marked a section for example with the mouse and then for example uses the mouse to click on something else and then wants to go back and for example increase or decrease the marked area, he/she can still use the mouse and/or other keys for example to go back and extend or reduce the section without having to start marking again from the beginning. This can be also useful for example if the user first uses for example Aa to mark the entire file and then for example uses the mouse and/or other keys to reduce the marked section or remove parts of it. Another possible variation is that the user can mark more than one area with the mouse at the same time, for example by pressing some key that tells the application not to remove the mark from the previous marked area or areas. Of course these and/other features can be used also with other types of files and not just in word processing programs, such as for example with Internet browsers, etc.

Another important improvement is that preferably the user can for example choose a specific font color and/or for example specific font attribute (for example underline) which preferably is kept automatically until changed again, so that this text preferably appears wherever the user adds it to previous text, regardless of the color or other attributes of the section of the previous text in which the new text in inserted. This is very convenient for example for keeping track of additions (for example when the user does not want to activate the automatic track changes), or for example for adding comments for example in another color. This is in contrast to the prior art, where for example in Word such options must be chosen again in each section, otherwise when the user starts to add text at a different place it automatically assumes the color and attributes of the surrounding text.

Another improvement is that preferably the word processor can allow the user to easily define page numbering that starts from a certain value other than 1, for example since page 50 (or any other desired number) since for example sometimes the user might want to print pages that will be attached after other already printed pages as if they are part of the same file. This can be defined for example by letting the user use a formula, so that for example if the current page number is marked for example in Word as “#”, the user can preferably specify for example “#+49”, so the page numbering will start for example from 50 instead of 1, and then preferably for example the total number of pages is automatically updated accordingly even if the user does not enter the formula there too. Another possible variation is that for example when the user enters for example in the top page title for example the # mark, which in Microsoft Word means automatic page number, the system automatically shows for example a scroll window near it with the default of 1 and the user can instantly for example increase the number by scrolling the window or typing a different number there. (Although for example Word allows the user to cause the page numbering to start at a different number, it is done in a much less intuitive way since the user has to go to the “addition” menu, then choose “page numbers”, then go to “Pattern” and then indicate a page number to start from).

Another problem is that for example Word sometimes decides to move paragraphs to the next page without any apparent reason, thus leaving sometimes a large empty space in the previous pages. So preferably the user can for example click in any such case for example on the empty space or on the moved paragraph and/or for example enter a command that tells the word processor that the user does not want such empty spaces, and/or for example the user can activate a command that automatically fixes all such unnecessary empty spaces globally and/or prevents them from being created.

Another problem is that in Word for example when switching between the Hebrew dictionary to the English dictionary or vice versa, the language in the small window where the checked word is entered does not automatically change in accordance, so many times the user has also to press Alt-Shift in order to switch to the desired language in the small window, which can be very aggravating if the user starts typing and then sees that the language is the wrong language. So preferably this is improved so that switching the dictionary also automatically switches the language correspondingly in the small window or area where the word has to be entered, so that for example if the user switches to Hebrew/English dictionary then the language in the small window preferably automatically becomes Hebrew, and when the user switches the English/Hebrew the language in the small window or area where the word has to be entered preferably automatically becomes English. Another preferable improvement is that when switching language, if the user has already entered a word in the translation window, preferably the word is not automatically erased when the user switches the language. Similarly, if the user for example switches the language in the small window, preferably this can automatically switch the direction of the dictionary accordingly, so that for example if the user changes to typing a Hebrew word the dictionary automatically becomes Hebrew→English, and vice versa. Another possible improvement is that preferably when using the dictionary the user can use also forward and/or backwards movement (for example by clicking on an appropriate icon or a keyboard key), so that he can go back or forward to previously checked words (in a way similar to browsing a directory or to browsing the Internet). Of course this preferably done with any relevant languages. Another preferable improvement is that the dictionary preferably allows the user to use back arrows in order to go back to previous points in the dictionary for example if the user clicks on various words in a sequence. Another preferable improvement is that when the thesaurus is used preferably the dictionary shows near each newly found word of the thesaurus also its translation to the other language (for example Hebrew) and/or a short description of its more precise meaning in a few words, for example within brackets next to the word, and for example clicking on any of the words or explanation words or the translated words (for example in Hebrew) preferably activates the thesaurus and/or the dictionary again recursively on the clicked word. In addition, preferably the thesaurus and/or the dictionary automatically takes into consideration the context in which the word exists in the file (for example the next few words and/or the sentence and/or the general subject) so that preferably when displaying semantic trees or groups of semantic branches preferably the groups or branches are pre-sorted according to the most likely meaning when taking said context into consideration and/or for example only the most likely meaning branch is shown. Similarly, preferably the automatic typing-error-correction system preferably also takes into account also the context and so preferably chooses the word most likely according to context when there is more then one reasonable correction (and/or for example in cases the system is not sure it preferably shows the user that there is more than one likely correct word and asks him/her to choose the correct one for example by scrolling to the preferred one), since in the prior art many times this system for example in Word corrects a word which contains a spelling error into a different word which the user didn't mean at all and then if the user doesn't notice it the sentence might be perhaps even dangerously wrong. Another possible variation is that the user can for example activate a command which automatically indicates all the words in which spelling errors were previously automatically corrected the word processor, so that the user can check specifically these words to see if there were any such errors of changing the word to something that was not indented by the user. Another preferable improvement for example in words processors, and especially for example in editors that are used for editing software programs, is that preferably the editor can mark automatically matching pairs of brackets in a way that the user can easily see the matching pairs—preferably by automatically showing each pair in a different color. Another possible variation is to show them for example, instead or in addition, in a different style or for example in a somewhat different height, however changing the color is more preferable since it is more conspicuous and much more variations are available. Another possible improvement is that when the user wants for example to correct intermittently two (or more) sections in the same file (for example the claims and the relevant part of the specification in a patent application), preferably the user can for example press a key or combination of keys which causes the position in the word processor to jump automatically between the various last edited sections. This is preferably done by the Word processor preferably automatically saving a buffer of all the last separate positions that the cursor was last on (for example if the distance between them is more than N characters), and then pressing for example some key or key combination moves the position accordingly (This can be done for example automatically between the last two places, and if the user wants more jumps backwards preferably a different command is used). Another preferable variation is that preferably the automatic error checking of the word processor includes also at least some statistical and/or semantic checking of unreasonable words or word combinations that are probably a typing error eventhough there is such a word and/or eventhough it is grammatically possible, such as for example if the user writes by mistake “any pother way” instead of “any other way”. Since the word “pother” does exist and the combination is apparently grammatically possible, Word does not indicate any error, eventhough any normal human reader would immediately see that it is a mistake and the correct word is “other”. In order to accomplish this preferably the word processor uses at least some taxonomy of semantic knowledge, and/or at least the word processor preferably has a preferably large database of typical texts, for example form newspapers and/or books and/or web pages, and preferably all single words and/or up to a few word combinations are indexed according to how many time they appear, so that preferably the word processor can instantly check for example for highly irregular combinations and/or at least run the check for example when a rare word is involved, etc., and preferably the word processor issues the error message especially if there is clearly a very similar word combination that is much more common. Preferably the word processor also takes into account for example the layout of the typical keyboard (so that for example an error of adding a ‘p’ before the ‘o’ or for example substituting ‘o’ with a ‘p’ or vice versa is much more likely than for example making a substitution of far letters) and/or also takes into account acoustic information (for example words that sound alike, etc.). Another possible variation is that the word processor for example learns from the user's own behavior when such errors are made and then corrected by user (especially for example of this occurs repeatedly), and then preferably warns the user automatically when such errors are made again. Of course various combinations of the above and other variations can also be used.

Another problem is that when opening files for example with the windows dialogue box (for example from Word) the dialogue box does not display the full file name if the file name is too long. In windows 98 the problem was even worse since the dialogue box cannot even be enlarged at all, whereas in Windows XP at least the user can enlarge the window of the dialogue box by dragging for example its bottom right corner with the mouse. However, this is still not convenient, since the system allows for example to define file names of length up to 256 characters, but the dialogue box by default will typically display only up to a little more than 80 characters. So preferably this is improved so that the dialogue box preferably automatically adjusts its size to a size that is sufficiently large to display the full file name if one or more of the file names that are displayed is longer than the default, and/or for example a slide bar is added (for example at the bottom) that allows the user to scroll and see the full name. In the prior art the slide bar is enabled only if more file names are displayed sideways, but moving the slide barjumps one column to the side without letting the user see the rest of the name if the name is too long. The automatic resizing can be done for example also in other types of Windows, so that for example when sending email with attachments for example in Netscape preferably the size of the right internal window that shows the attached file names preferably automatically increases if the file name is longer, at least for example if there is sufficient room, since typically the email addresses on the left internal window are not very long. Another preferable improvement is that for example when deleting a file in the dialogue box that displays existing file names, preferably by default immediately after the deletion the display is updated so that the list of files is displayed more or less in the same position (preferably the display up to the deleted file remains the same, and is updated only from the deleted position onwards), since typically the user will want to continue at the same place after the deletion. In the prior art deleting a file in the dialogue box causes the display to jump back automatically to the beginning of the list. Another problem is that the dialogue box that allows the user to choose directories and files and the explorer Window show file extensions only when the file type is unknown, so for example if the same file name exists both as an rtf file and as a Word doc file the user has no indication which is which (unless he/she tells for example Word to show only files of one of the types). So preferably this is improved so that in the dialogue box and/or in the explorer Window the extension is shown even when the associated application is known. Another problem is that when the user searches for a specific file or file pattern (for example a file name with a wild card) the explorer window shows first directory names and only afterwards files, which can be very inconvenient if there is a large number of sub-directories in the directory where the relevant files are. So preferably in the windows explorer and/or in similar utilities either the files are displayed by default before the directory names or for example the user can easily indicate which of these orders he/she prefers. Another possible variation is that for example instead of or in addition to the icon that shows the associated application (for example Word) the window can show also an Icon that represents the general type of the file (for example music file, video file, word processing file, C program file, HTML file, etc.) regardless of the associated application. Another possible variation is that for example even when an internal Window of a program is in front of a background window of that program and does not allow accessing the background window for example until the front window is closed, preferably the OS automatically allows the user at least to move the previous window and/or perform at least other acts that preferably do not change the way the software behaves but allows the user at least to control the view of the background window.

Another problem for example in Word is that drawing tools are very limited so that for example various lines can only be positioned at certain minimal jumps of a few mm distance from each other instead of at any desired pixel positions. This creates unnecessary limitations on the available resolution and other problems. So preferably this limitation is removed, so that the user can preferably position any object on any position where a valid pixel exists. Similarly there is a problem that the user cannot for example simply mark one or more images for example with the mouse, for example in order to delete it or cut and paste it elsewhere. In the prior art Word the marking usually works only on a group of images depending for example if there is a text before and after them that can be included in the marked block, and so that normally the user has to mark manually multiple elements in an image in order to copy or move it. So preferably this is improved so that the user can simply mark any area in an image or part of it (for example even according to pixel lines and/or columns) and then for example delete it or copy it or move it. Another possible variation is that for example after the user marks such a section he/she can for example not only cut& paste and/or copy or delete the marked section but also for example rotate it so that preferably all the elements in the marked section are rotated in synchrony, etc. (for example in any desired amount of degrees, etc.).

Another possible variation is that preferably for example in word processing programs and/or for example Internet browsers and/or other software preferably the user can move any icon and/or for example any menu item and/or sub-menu item (preferably including for example within pull-down menus) to any desired position (preferably simply by dragging it with the mouse) and preferably the same icon and/or menu item automatically continues functioning on the new position, and this new position is preferably saved automatically also after the user closes the application, but preferably the user can also undo any such changes, preferably even after the application has been closed and reopened (which is preferably accomplished by keeping a rollback log in a separate configuration file). This is better than the prior art in which for example the user can sometimes move certain groups of elements together but not in a consistent manner and not for each item independently (for example in Microsoft Word). This feature is preferably supported automatically for example by compilers such as for example visual C, so that preferably the programmer does not have to do almost anything in order to enable it. Another possible variation is that the user can also for example change the position of the normal boxes on the taskbar that represent normally running programs (preferably by dragging them with the mouse), so that the user can conveniently re-arrange their position without having to close and reopen these programs.

Another possible variation is that preferably the user can for example mark an area in the word processor with the mouse and preferably activate a command which for example automatically removes any table or other structured formatting from that area, so that preferably the text is still divided preferably the same way, but after this the user can for example make any other changes as if the table or other structure never existed. Another possible variation is the opposite—so that the user can for example enter text that looks like in a table but without the actual structure and then activate a command which automatically adds the structure—for example by guessing the most likely structure that fits the given shape of the text.

Another possible variation is that for example the copy command (typically AC) can also be activated cumulatively (for example by activating some flag), so that for example a certain sequence of AC commands can create a cumulative buffer of for example consecutively pasted texts, so that afterwards for example AV at a certain position will preferably paste back the consecutive group of pasted texts as one sequence.

Another possible variation is that preferably the word processor automatically checks the date in the system in short intervals (for example every few minutes) and thus updates the date field automatically whenever it has changed (for example when the user has included the date field in each page header), and not just if the user reopens file or prints it, as is done for example in the prior art Word. Another possible variation is that for example the user can change page definitions (for example size of top and bottom margins and/or other parameters) also for example for a single page or range of pages and not just automatically for all the pages as in the prior art Word.

Of course, like other features of this invention, these features can be used also independently of any other features of this invention.

Additional improvements in the OS preferably include also at least one of the following:

Preferably the OS allows the user to define at least one User which the system (such as for example Windows NT or XP) will enter by default and without a password if the user does not request to enter a particular User after a certain time (for example 50 seconds) after the system reaches the menu that's asks to choose a User. This has the advantage that for example after a temporary power failure the system can automatically resume the original User. Preferably this is accompanied by the ability to define for example a sequence of actions to be taken upon entering this User by default, such as for example connecting with the Internet and activating a server and/or whatever other program or programs need to be resumed after a power failure. This is somewhat similar to programs in the startup menu, except that this feature is preferably more powerful, so that it enables for example to define also various sequences of actions or for example to carry on automatically certain activities only if the User was entered automatically by default. Another possible variation is that if the system enters the default User without password, preferably it enters a limited mode where for example it takes no commands from the keyboard or mouse and/or has other limitations, for example until the user for example comes back and enters some password. For example the system can enter immediately the state that it would be in if a screen saver was activated and a password is needed to resume operation with the keyboard or mouse.

Preferably if the user uses for example write-once CD's (and/or for example DVDs) for backup and uses direct writing software, such as for example DirectCD, if the user copies the same file more than once onto the same CD (to the same directory), then preferably the backup software can automatically rename the old files for example with some automatically sequenced extension, so that the user can automatically keep and track also older versions this way. This is quite useful for version tracking and is better than simply overwriting the file, since in such CDs the old data cannot really be overwritten anyway. Of course, preferably the user has an option of turning this feature on or off, and/or for example can activate it retroactively for example for write-one CD's or DVD's in which it has not been used (in this case preferably the system automatically reconstructs the version sequencing according to the time and date each “deleted” previous version was saved). Another possible variation is to apply such automatic sequencing automatically for example also to other drives and/or directories that the user defines as back-up drives or directories and/or to other types of backup devices. Another possible variation is to enable by default (or for example to allow the user to request it) automatic backup of important files to the default backup directory and/or drive and/or device, so that for example each doc file (or for example program source file, or other for example office type of file) that has been created or changed and has not been updated for more than a certain time period (for example 1 day or a few hours), and/or for example after a certain threshold amount of change even if less time has elapsed, is automatically backed-up on the default back-up media, and/or for example browser bookmark files are back-up like this, etc. (The important types of files are preferably defined automatically by default and/or user-defined). This can be a great help for example for users who forget to make backups. After the media becomes full and/or for example shortly before that the system can for example report this to the user and prompt him/her for example to insert a new blank writeable CD (or other media), etc. (In case of the bookmarks file for example, if for some reason the latest version has crashed or was damaged in anyway, preferably the system can automatically reconstruct the latest version for example by taking the last backed-up version and adding to it preferably automatically all the links that were visited from that time onwards, for example according to the browser's recent history list). Another possible variation is that for example normal CD creation programs which write a CD file image as a single transaction, such as for example CD Creator, preferably enable compressing files on the fly (for example as zip or other common compression formats). This is better than the to the prior art, where such compression is available only when the CD is accessed like a disk, for example through programs like “Direct CD”, which when there is a large number of files write to the CD significantly slower than for example programs like CD creator. Another possible variation is that the user can for example select files for backup according to a certain range of sizes (for example backup automatically all the files that are smaller than 1 megabytes or 10 megabytes, etc.) or for example define automatic backup rules for files according to their types (so that for example every new doc file is backed up automatically for example more frequently than less important files, etc.). Another preferable improvement is that like smaller pocket-sized CD's, preferably DVDs and/or similar larger capacity drives (such as for example blue-ray or High Definition DVDs) support also smaller pocket-size DVD's, preferably both as burn-able media and as ready pre-recorded media. Another preferable variation is to improve DVD capacity even much more for example by using UV or extreme-UV lasers instead of red or blue. However, preferably the media for such DVDs are made sensitive to writing only at a strength and/or frequency which is sufficiently different from normal UV radiation from the Sun, so that for example exposure to the Sun will not have a degrading effect on the media. Another possible variation is that preferably the bookmarks list automatically shows also near each bookmark for example the date it was entered, and/or for example the bookmarks are automatically grouped for example by days, for example with a different color for each group and/or some border marked between the groups, and then for example the date can appear once for the entire group instead of near each bookmark in the group.

Preferably the OS allows the user to access at least one CD-ROM drive even when the OS is started for example in “safe mode”, otherwise it can be very frustrating when the user might not be able to fix various things for example because he cannot fix anything from the installation CD while in safe mode. In addition, if for example the OS becomes unstable or cannot complete a boot for example because of a problem with some driver, preferably the system is able to automatically remove and/or ignore and/or report to the user the driver that is causing the problem. Even if the problem for example crashed the computer completely so that the OS could not report anything, preferably during each boot the system for example keeps a log of all successful steps in the boot, and so even if a certain step causes a crash so that the system can't even report the problem, preferably in the next boot the system knows by the incomplete step in the log exactly where it crashed the last time and can preferably automatically complete the boot this time without the problematic step and preferably reports to the user exactly what the problem was and/or preferably automatically removes the problem and/or offers the user for example to chose among a few possible corrections to the problem so that the problem does not occur at all again after that. Another possible variation is that various data (such as for example the condition of the CPU, heat, various memory parameters and/or other parameters) are constantly kept at preferably small intervals, for example in one or more circular buffers, and preferably for example a special mark is added to the current position of the buffer after each new boot, so that if for example the system crashes for an unknown reason and resets (for example even while being unattended), the user and/or the OS can automatically know after the next boot what caused the crash. Another possible variation is that whenever the system crashes these parameters are automatically saved for example by some special application that preferably runs below the OS and can still perform this operation even if the OS is completely stuck. This application can for example also be responsible for an automatic reset if it senses that the system has indeed crashed or got stuck or for example if it senses that the CPU or some other element or device has become too hot or is otherwise dangerously malfunctioning (in which case preferably an automatic shutdown is activated instead of and automatic reset), and/or for example some special hardware element is responsible for that. Of course, various combinations of the above and other variations can also be used.

On the other hand, preferably the user can disable the Autorun feature that enables programs on CD's to start running automatically when the CD is inserted into the computer, preferably without having to disable for that the Auto insert notification for that drive, since this feature is very unsafe in terms of security. In the prior art the user can disable this in Windows only by disabling also the auto insert notification, which is not desirable, since disabling the auto insert notification can cause other problems.

Preferably the Windows OS allows executing files in DOS mode also by clicking on or near their name instead of having to type it. This is very important for example in Windows NT or XP, since, unlike for example Windows 98, the user has to type the whole name of the command instead of being able to type also instead only the 8 character DOS name of it. Since for example in Windows NT and XP the user can in DOS mode click on the mouse in order for example to mark a name for cut and paste, preferably the execute command is added for example to the menu of these available options. (Of course there are programs that can be used for example for automatic file completion, but this is another option that allows more flexibility and convenience to the user).

Preferably the OS itself and/or various relevant applications can display for certain activities approximately how much time it is going to take and/or for example the percent completed and/or the percent remaining—even if these are complex activities such as for example when scanning for viruses. Although many applications do give such information—these are typically application that deal with a single file or a pre-specified list of files, whereas for example virus scanning programs do not, which can be aggravating to users, since such activities can typically take for example anywhere between 5-20 minutes. So preferably the relevant applications and/or the OS can automatically calculate for example the number of files and/or their cumulative size (preferably of course only for the relevant types of files that are to be scanned), and thus for example the application and/or the OS can display to the user an estimate of time and/or percent done and/or percent remaining. Preferably this is made available for example also to the application's programmer, for example as an OS function that can return for example the total number of files of a certain type and/or extension and/or their cumulative sizes, for example on the entire computer or for example on a given drive or directory (preferably automatically including all of its sub-directories). Another possible variation is that if the user for example aborts a virus scan and later wants to continue, the program can automatically continue from the last point reached. This can be done for example by saving the position in the directory structure and continuing automatically from there, preferably for example if the time since the last scan is no longer than a certain time (for example 1 hour or any other reasonable time gap), and for example if the time gap is bigger then the program asks the user if he/she wants to continue from the same point or restart the scan.

Preferably commands such as for example “copy” are extended so that multiple destinations can be used, so that for example copy “bet*.doc l:n:” will copy all the relevant files to all the destination drives/directories. Another possible improvement is that preferably when copying a large group of files (for example from one directory to another, for example in a DOS window or with the Windows explorer) the user also has an option of “No to all” if he is asked if to overwrite files with the same name. In the prior art the user has to answer this for each file that has the same name individually or can choose “yes to all”.

Preferably various Undo commands are applied also to various memory related commands where they do not yet exist, so that for example if the user works with an Internet browser and presses a “clear form” button, preferably the user can undo it for example by pressing control-z or for example pressing for example some undo button for example on the browser. Similarly, preferably the browser itself keeps in memory for example recent changes to various form fields in the same page and/or for example also on previous pages, so that for example jumping back to a previously filled field on the same page or for example also on previous pages will still allow the user for example to undo changes in that field, for example by pressing \hat{ }z. In addition, preferably, as explained also in Canadian applications 2,455,342 of Dec. 17, 2003 and 2,452,778 of Dec. 29, 2003 by the present inventor, preferably the HTML command set and/or for example the Javascript command set is improved, so that preferably it is possible to define for example which button (or buttons) will be activated by default for example if the user presses for example the Enter Key and/or for example the Space Key, and/or for example what action (if any) is to be performed when various keys are pressed. Preferably the keys can be linked for example to javascript buttons for example by a definition in each button (however, if for example in more than one button the same key is defined as activating the button then preferably there are rules that define which button overrules), and/or for example additional commands are added (preferably within HTML tags that define directly various actions that can be performed and/or buttons that should be activated when a certain key is pressed). This is very important since for example in standard HTML forms there is a problem that pressing the Enter key for example when an input text line (or even for example a radio button or a checkbox button) is in focus can cause the form to be submitted. Sometimes this is undesirable (for example when the user is required to fill a form with multiple items), and in the prior art the only solution is adding various Javascript checks and issuing error messages for example if there are still empty fields. But if the user pressed enter for example after filling in a text line and did not intend to submit the form, such messages are aggravating. So preferably to prevent this, the above additional commands can be used for example to generally define for example that pressing the Enter key for example anywhere in the form (for example by adding the appropriate command within the “<form . . . ” tag that appears at the beginning of the form or for example within the tag that defines the submit button) will have no effect or at least will not cause the form to be submitted, or for example this can be defined in specific fields (for example within the tag that defines the field).

Another problem with Internet browsers is that in some cases lines are truncated when printed, which can happen sometimes for example when forms or tables are used. In order to prevent this, preferably the browser and/or the OS and/or the printer driver preferably automatically check if this is about to happen and, if so, this is preferably automatically prevented, for example by automatically converting to landscape mode, and/or by automatic additional line wrapping if possible (for example, if it does not damage a format of a table), and/or for example by automatically reducing the left and/or right page margins and/or by automatically reducing the font size (for example just in the horizontal dimension or both horizontally and vertically, in order to keep the aspect ratio), and/or for example informing the user about the problem and asking him to choose from a number of possible solutions (such as for example any of the above described solutions) and/or allowing the user for example to decide to truncate less important parts on the left of the pages (for example if the user is printing an article and the left column for example contains only links and/or advertisements and/or irrelevant images). Another possible variation is that the user can for example mark just part of the displayed HTML page (for example with the mouse)—for example just a specific column, and then use a command that prints only the marked area. (Of course in the current prior art the user can for example mark an area in the page that is displayed by the Internet browser and then use copy and paste and print it for example from Word, but the above option allows the user preferably to do this in a faster and more convenient way, and also the url address is preferably automatically also printed, even if only part of the page has been marked and printed). Another preferable improvement is that for example the browser or the printer driver shows the number of pages that will be printed before the user starts the actual printing. (For example the browser can show the logical division of pages if the Internet page will be printed or at least show the total number of printed pages at the bottom of the page display on the screen, or for example when the user presses Control-P, preferably the print dialogue window shows the projected number of pages that will be printed). In the prior art the user has to start the printing of normal html pages in the browser and wait till the first page has been printed in order to see on the first page how many pages will be printed from the displayed Internet page. In addition preferably the user can easily reduce or increase the size of the printed fonts, for example by a specific command when printing, or by reducing or increasing the size of the fonts on the screen so that this affects automatically also the printing. In the prior art for example in Netscape the user can reduce or increase the font size of web pages on the screen by pressing Control+or Control−, but these changes have no effect on the printing of web pages, and also they affect only the fonts and not the images. Preferably this reducing or increasing of fonts can be also done for a specific web page and/or for a specific site instead of Globally, since for example in Netscape the changed size remains also when the user moves to other web pages (however preferably the browser remembers the changed size of the page or for the site for which it was made). Another possible variation is that the same command that reduces or increase the font size on the page (and/or another command) can cause also the images to automatically grow or shrink in addition to or instead of the fonts, and this preferably also affect also the printing (for increasing the image sizes, preferably the images are vector-based images, or for example the browser simply enlarges them eventhough the resolution remains the same, or for example the http protocol is improved so that images are automatically saved by web servers and/or by relevant web authoring tools in more than one size and for example the browser can automatically request the same image again with some parameter that tells the server to send it in a larger size and then the server automatically sends again the same image in a larger size. If the last variation is used then it means that preferably the web page designer includes an image of higher resolution and preferably the web authoring tool or the web server can automatically generate also the reduced resolution versions). Another possible variation is that the user can mark a section (or sections) of the page and then preferably these changes can affect for example only the marked section. Another possible variation is that the user can for example reduce the size of fonts and/or icons and/or images on the computer's desktop by a similar command that preferably affects the entire desktop (and/or for example a marked section in it) automatically, preferably by any desired factor, and preferably without having to restart the computer to see the change. Preferably this change is seen instantly, like when increasing or reducing for example the font size in the browser. In addition, if for example increasing the size of fonts and/or of icons on the desktop and/or changing the screen resolution causes a problem that some icons no longer fit on the desktop, preferably this is automatically handled by creating vertical and/or horizontal scroll bars at the edge of the desktop, like in a normal directory window in which there items that don't fit in the Window. This way the user can for example drag items back in and/or resize the desktop in order to get rid of the scroll bars. Another possible variation is that in this case the system can automatically reduce spaces between icons and/or recommend to the user the maximum size that can be used without problems. In addition, the OS preferably supplies the user with an Undo command (and preferably also a Redo command) for example for changes in the desktop icon sizes and/or for moving icons (and/or for example also for other changes, such as for example removing or adding or changing the position of items that constantly appear near the taskbar, for example at the top or the side of the taskbar, etc.), and this undo is preferably also available for example when moving and/or resizing icons in a directory and/or in other windows. Preferably this undo is incremental, so that the user can preferably roll back till the start of the changes (Preferably this is accomplished by automatically saving the positions or the changes between the various configurations for example each time after the movement of one or more icon has been completed or for example after the user closes the window). (In the prior art windows undo is not available for resizing windows and/or changing positions of icons). This is much better than the prior art in which changing the font size and/or the resolution might cause icons to become invisible on the desktop or to crowd over each other. Another problem in the prior art (for example in Windows XP) is that reducing the resolution and/or increasing the system font size can cause the window that asks if to keep the new resolution to appear outside of the desktop (i.e. become invisible) and/or cause the text is various system message windows to appear truncated. This is preferably automatically prevented, and for this preferably the system automatically calculates the new size and ratios and thus makes sure that all the message windows appear in a visible area and that the text size in them fits the message window, and if not then preferably the message window's size is automatically adjusted as needed and/or the font size in the message window is automatically reduced as needed and/or for example scroll bars are added to it as needed. Although Microsoft recently announced that the new Longhorn version of Windows will contain smooth scaling (a feature which exists already in Macintosh OS X), there is no indication that the above described features regarding the desktop will be included, and the smooth scaling is apparently relevant mainly to flicker free animation and to DPI scaling or window scaling instead of only window resizing, i.e. the ability to automatically change the size of text and images through the graphics card, so the some of the above described features will be easier to implement (but without the above features, changing for example the scaling of the desktop can lead to exactly the problems that some of the above features are intended to solve). Also, preferably the ability so increase or decrease for example the size of the text and/or of the images and/or icons for example in web pages or in other windows as described above is preferably independent of the size of the window, since scaling the size of the text and images automatically by the window size is more relevant for special animation effects involving the windows (such as for example juggling or rotating windows around the screen), but when the user wants to work on the window typically he/she would want to be able to choose the most desirable size of fonts and/or images regardless of the size of the window (This means that for these purposes the resizing is preferably done by reformatting the page, like in the above described Netscape feature, and not by some purely graphic effect performed by the graphics card). Another possible variation is that for example if the user changes the screen resolution the fonts and/or icons on the desktop and/or in other places or applications by default remain more or less the same size (unless the user explicitly requests to change them, which can preferably be done independently of any change in screen resolution), preferably by using for example the smooth scaling to automatically correct for the changes caused by the changed resolution, so that if the user increases the resolution the fonts and/or icons and/or images can be automatically increased in size to compensate for this and if the user decreases the resolution the fonts and/or icons and/or images can be automatically reduced in size to compensate for this. So if the user for example switches from a resolution of 1024×768 to a resolution of 1280×1024, the fonts and/or icons are preferably automatically increased in size by the appropriate factor (in this example preferably they are increased in width by 25% and increased by height by 33%, and/or the aspect ratio is maintained by default so that the width and height are for example both increased by the higher value or by the lower value or for example by some average value. If for example the default is the average, this has the advantage that by default the minimum change in icon shapes will be perceived. However since, as explained above, the desktop preferably remains the same size, preferably by default at least the distances between the icons are corrected in each direction by its appropriate ratio of change, i.e. in the above example preferably 25% in width and 33% in height. Preferably the user can choose among these options). Of course various combinations of the above and other variations can also be used. Another possible variation is that if the user for example wants to copy more than one application at the same time for example from the “all programs” pop-up list which is activated through the Start button, for example to the desktop, then preferably he/she can mark more than one item at a time (for example by dragging the mouse to darken a group of them and/or for example by marking a group with CTRL or Shift pressed) and/or the list remains open even after dragging an item (unlike the prior art, where immediately after dragging the first item to the desktop the list disappears and has to be opened again from the Start button, unlike for example a window created through Explore). Another possible variation is that preferably the user can drag a shortcut also for example from normal open application on the taskbar and/or for example by dragging something for example from the top and/or other parts of an open window (for example by clicking on the right mouse button, for example onto the desktop), and/or for example from the file name as it appears in a DOS or cmd window. Similarly, if the user for example wants to uninstall more than one program at the same time (for example in the control panel), preferably the user can mark multiple programs (for example with the convention of shift or control pressed while selecting items) and then preferably all the marked programs are uninstalled automatically (preferably one after the other).

Preferably the user can logically disable or change the function that pressing various keyboard keys has on the OS and/or on any programs that are running, such as for example the “Windows” key, since if the user is working for example in text mode in a DOS window, pressing for example by mistake the “windows” key causes the display to switch and can be very aggravating. Similarly, if the user buys for example a new keyboard and some keys (such as for example the ESC key or the CTRL key) are not in the place that he is used to, preferably the user can simply redefine these keys, for example by marking the changes on some virtual keyboard that the system displays, so that for example these keys will switch places, and then the user only has to switch physically for example the external plastic caps of the keys that he changed logically (or for example glue new labels on them), and then the change is complete. Another problem is that for example in portable computers some keyboard keys do not exist, such as for example the side keypad, which can be very inconvenient to users that are used to it, and also for example in some text editors the side ‘*’ is the Undo button and for example the side ‘−’ key copies and deletes a line, but the normal ‘* and ‘−’ keys don't have this function. So preferably the user can also redefine for example some keys for example on the right to become for example the keypad keys—but on condition—when another key is pressed or some switch is moved, and/or for example the keyboard in the portable computer is defined like this in advance and preferably the relevant keys have also the additional keypad marks on them. Another possible variation is that the user can for example add to the portable computer (for example when it is used on a desk) for example a mini-keyboard which completes for example the side keypad and/or any other keys—for example using the normal plug that enables adding a keyboard to the portable computer, except that preferably the complementary keyboard for example sends a special code or for example has a somewhat different configuration of the connector, that tells the portable computer not to regard it as a replacement keyboard that disables the portable's built-in keyboard but regard it as adding certain keys to the internal keyboard. This can be more convenient and space-saving than adding a full keyboard that is used INSTEAD of the portable's built-in keyboard.

Preferably the dynamic linking possibilities are improved so that the user can call and use any Windows DLL from a DOS program (preferably in an extended DOS environment) and/or vice versa, so that preferably the two environments are integrated seamlessly in memory, so that Windows modules and DOS modules can preferably transfer data between them without having to use for example intermediary file storage. This way, for example a program that needs to use the TWAIN interface to work with various scanners can for example have one or more modules that run in the Windows environment and can for example connect to the TWAIN DLLs and for example have also one or more modules that run in DOS mode (preferably extended DOS) and can thus have backward compatibility for example with absolute memory addresses or other functions that are available only in DOS mode. This can be done for example by defining appropriate stubs and/or API interfaces that bridge between the two types, including for example any necessary conversions that are needed for compatibility, and/or using for example various sockets and/or client/server connections within the same computer.

Another preferable improvement is that for example when Faxes are received directly into the computer by a fax card, preferably the Fax program and/or the OS is improved so that if for example a fax-transmission has been cut-off because of some error and the sender wants to send again only the remaining pages, preferably the program and/or the OS can automatically identify this (for example by identifying that this is from the same source and within a short time after the previous fax), and then preferably the continuation fax is appended to the end of the previous fax and/or the program at least groups them together and/or notifies the user that two or more faxes appear to be a continuation of the same fax from the same source. Another possible variation is that the receiving fax card can for example automatically return to the user (preferably by improving the communication protocol so that this feedback is received without having to call back the user) a unique return code that preferably includes a time and date stamp and a serial number of the communication (as described also in U.S. patent application Ser. No. 10/756,839 by the present inventor), and preferably the user can add this code on the continuation of the fax, for example preferably digitally (if the fax is sent from another fax card, or for example as an additional code at the end of the dialed phone number if the protocol is improved to enable this), or for example as a printed number at the top of the first continuation page, together with a code that indicates that this is a continuation (in which case preferably OCR is used to identify this). Another possible improvement is that if the user for example sends by mistake in a normal fax or for example a combined fax-scanner-printer a page that is with the printed side facing away from the side that is scanned (unless for example if it is a double-side fax that can read both sides of the page simultaneously), preferably the system automatically warns the user that the page is empty on the scanned side. Another possible improvement is that if the user has for example a combined fax-scanner-printer connected to the computer preferably the OS is able to send faxes also directly through the attached fax-printer by sending it the data and telling it send is as fax instead of printing it. That is preferably done together with an appropriate enhancement in the attached fax-printer (preferably this is done by a simple change in the firmware of the all-in-one scanner/fax/printer and/or by adding the appropriate software to the computer). The pages can be converted to a fax image in this case for example by software in the OS or by the fax-printer itself. This has the advantage of better quality than scanning a printed page, and is useful for example if the computer does not have a modem/fax card installed in it or if the external fax/printer is faster than the fax/modem card. Another possible variation is that the user can for example use the combined fax/printer/scanner and/or for example even a normal scanner to send faxes directly through the Internet, preferably through the computer's Internet connection. This is preferably done, again, by a change in the device's firmware and/or by adding the appropriate software to the computer. This has the important advantage that the user can preferably send faxes directly and instantly the same as he/she would be sending them through a normal phone line, except that preferably the fax is sent through the Internet and is preferably sent to the receiving fax either directly also through the Internet (If the other fax is also connected to the Internet), or for example through a local gateway that converts it to a normal Fax transmission through a local phone-call, or for example it is received directly into a computer on the other side. (Of course, if the file exists for example as a Word document on the user's computer then using the scanner or combined scanned/fax/printer is not needed, however the main reason that people send a Fax instead of an email is typically to send a document that contains a signature or a document which does not exist on their computer). Another possible variation is that the user can for example use a fax card or for example a combined fax-scanner-printer which is connected to the computer in order to send one or more pseudo fax images which are actually digital data (such as for example one or more pdf files or other convenient formats). This can be done for example by a special software that runs on the computer and/or for example by some firmware change for example in the all-in-one fax-scanner-printer, so that the computer can send to the fax-scanner-printer for example the special digital file or files for example alone or together with real images or scanned images (for example if some scanned cover forms are also needed), and when it is transmitted by Fax the sending device preferably uses a special code to tell the receiving device that one or more pseudo page images are actually a digital file, and preferably the receiving fax is either a computer with a fax/modem card or for example a combined fax-scanner-printer which is also connected to a computer and thus can transmit the digital file to the computer as a digital file, and preferably if a normal fax machine that can't handle such files responds then the sending device knows that the transfer of digital files is not possible and preferably issues some error code and aborts. This can be used for example for sending applications or other documents to patent offices by Fax (which can enable for example user identity confirmation by the telephone's caller ID, without having to deal with digital signatures, etc.), while allowing high speed transfer almost at the same speeds of sending email, Even if the file contains for example a 100 pages, whereas a normal fax of such size might take even half an hour or more and involves the risk of for example some lines not being scanned properly without the sender even knowing this, and of course it also saves wasting of time on OCR recognition at the receiving side. Preferably this is accompanied by transferring also one or more CRC codes and/or other integrity data, so that preferably the connected computer on the receiver side (and/or for example the CPU of the receiving device itself) checks if the CRC and/or other integrity data fits the actual file that was received, and, if not, preferably tells the receiving device to return an error code so that the sending device can try to resend it. Another possible variation is that the sending device can for example automatically split the digital file or files to multiple sections if for example the file is too large for the desired size of each pseudo page-image. Another possible variation is that the two devices can automatically recognize each other, preferably already during the handshake, as having more than Fax communication capabilities, and thus for example can automatically (preferably at least when it is more suitable) switch to some other electronic file transfer protocol between them which is preferably more directly oriented to exchanging digital files. Another possible variation is that for example the fax logs automatically indicate near each communication for example also the resolution that was used in the transmission (for example standard, fine, super-fine, photo, etc.) and/or for example if the fax was in B/W or in color. Of course, various combinations of the above and other variations can also be used. Of course, like other features of this invention, these features can be used also independently of any other features of this invention. Another possible variation is that when sending a Fax the sending Fax machine can preferably enter automatically into the sent page (and/or also display to the sender) the local time and date of the receiving Fax (for example by reading it from the receiving fax or for example by reading it automatically from the phone company or for example from the Internet, for example according to the called number). Another preferable improvement is that preferably the receiving fax machine (for example a normal fax or for example all-in one devices that contain a fax) is programmed by default (and/or at least the user can choose this option) to respond with fax sounds only if fax sounds are heard in the incoming phone call. This is very important since when the user needs the same line for fax and voice, if the user does not answer fast enough (for example if the fax is set to answer at the 5^{th} ring and the user did not reach the phone fast enough) the Fax machine on the same line will interfere even in voice calls. Although the normal Fax protocol has been that the calling fax is supposed to wait for fax sounds from the receiver side of the phone call before making its own fax sounds, modern fax machines make these sounds when calling even if there is no fax sound on the receiving side, so, if the user chooses this option or this is the default, the only price is that some old stupid fax machines might not be able to send faxes to the receiving fax when the receiving fax is set in this mode, but it solves the problem of the user's fax interfering with incoming voice phone calls. Another possible variation is that the receiving fax is improved so that it is preferably able to automatically identify voice calls and thus avoids making fax sounds if it identifies for example human voice and/or stops immediately and gets off the line even if it started making fax sounds, as soon as it identifies the human voice. Of course, like other features of this invention, this feature can be used also independently of any other features. Another preferable variation is that preferably the ability of the scanner/copier to overcome wrinkles in papers or for example overcome the black stripe that appears when scanning or photocopying books when the user can't press the book down strongly enough—is improved preferably by adding at least one more light source in the scanner, so that shadows are automatically reduced.

Another problem is that when the user searches for programs in the “Start menu” the installed programs are typically sorted by the order they were installed, and so in order to find a specific program the user might have to scroll over a large list if there are many installed programs. So preferably this is improved, so that the user can for example request the System to automatically sort the list of installed programs in the start menu for example by alphabetic order, or for example to jump automatically to a given program in the list for example by typing the first letters of its name, and/or for example the user can enter a search string and the system looks for example for names that are at least similar to the desired name (in which case preferably all the similar names are displayed, preferably sorted by descending similarity to the search string), etc.

Another preferable improvement is that when the user searches for files on the computer preferably the “find files” window allows him/her to enter also more than one file name at the same time (for example separated by commas or one below the other, etc.), since if the user wants to search for more than one file this is better than having to search consecutively and it is also more efficient since all the files can be searched for during the same disk access.

Another possible variation is that preferably the installation disk (for example CD or DVD or for example through fast network connection) of the OS (for example in the new version of Windows) contains also one or more typical usable disk images, so that the system can be instantly installed from the most appropriate image, and then the system preferably automatically determines the actual computer's configuration and simply corrects and/or adds appropriate device drivers and/or makes other necessary adjustments, as if the system was already installed on that computer and the hardware was later changed. This can save a lot of time on the installation process, so that most of the time will be focused only on correcting the configuration.

Another problem is that, for example in Tablet PC's and/or similar devices and/or other devices that accept direct input by handwriting, when the user enters text in handwriting, it is problematic to use scrolling since the user would have the quite unnatural feeling that for example written text to the left of the current position of the pen is automatically slipping away to the left (or to the right, if the writing is from right to left). This means that if the user for example enters text by handwriting in a search box (for example when searching with the Internet browser in Google) and there is not enough room for the full search string, then there is a problem how to accommodate the additional text. This can be solved for example by letting the user continue his/her writing even beyond the edge of the input box, and then preferably the Operating System and/or for example the browser preferably automatically knows from the continuity of the written text (and/or from the continuity in time) that this is the continuation of the same text, and therefore interprets it correctly as if it is still in the input box even if its spills out for example to the right and/or to the bottom or up, and or even the user for example continues immediate to enter text for example on a second line below the input box (preferably unless there is another input box there). Another possible variation is that if the user runs out of space in the input box, the System and/or the browser and/or other relevant application automatically extends the box for example to the right (or other relevant direction). This can be done for example by automatically extending the box for example to the right in a new layer that partially covers for example whatever is to the right of the input box so that the user has more space (for example this layer is indicated by a shadow effect as if it is a few millimeters above the screen), and/or for example the extended part and/or the handwriting on it become at least partially transparent so that whatever is below it can still be seen, and/or for example what is below the extended part and or below the handwriting becomes temporarily faded (for example gray), and/or for example whatever is to the right of the input box (however, preferably only at the vertical position of the input box) is also automatically shifted to the right (this means that things at the right edges of the screen can automatically scroll away and temporarily disappear at the right of the screen if needed, and/or the system uses this scrolling only if there is sufficient free room in the needed direction and uses one of the other options if there isn't sufficient room for this), and/or for example the area where the user is writing can automatically be zoomed in (however this preferably automatic zoom preferably does not effect the user's hand writing itself, so that the handwriting preferably remains at the same size and position). Another possible variation is that at least the part of the handwriting that spills out of the input box is visible only when the user hovers or positions the pen and/or cursor and/or mouse near it. Similarly, if the user for example is entering text by handwriting in some open text window (for example a word processor or notepad) and his handwriting exceeds the edge of the window, preferably the System automatically recognizes (for example by the continuity of the hand writing and/or of the temporal sequence) that this belongs to the same text and thus the system keeps the focus in the current application even if the user for example spills some letters on another nearby window of another application. Another possible variation that can increase the natural feeling for example when reading large files or digital books in tablet PCs (or for example in devices dedicate to reading digital books) is that the user can for example move the page (for example up or down or sideways) for example by dragging his finger or fingers on it in the desired direction (which means that preferably the screen can identify that this is the user's finger instead of the pen for example by the size of contact or for example by the electronic resistance, and can then respond accordingly), and/or the user can for example cause pages to flip over for example by touching with his finger a corner or edge of the displayed page or for example some relevant icon there. Of course various combinations of the above and other variation can also be used. Another preferable variation is to supply the user with an electronic pen which can preferably write on normal paper and preferably at the same time both writes with visible ink on the paper and transmits the writing sequence to the computer, so that preferably the user can write normally while also obtaining an automatic copy on the computer (which preferably immediately becomes characters through automatic recognition). This can be done for example by using a double tip, so that one part senses the movements and the other actually writes on the paper, or for example use some electronic eye which views the ink sequence as it is created on the paper and transmits that into the computer. This is also more convenient since the user can much more easily write this way when he/she sees normally the output on the paper as if it is normal writing. Another preferable variation for example in tablet PC's and/or for example in digital book readers and/or for example in programs such as for example winamp or other software media players and/or for example in other gadgets for playing songs or films, preferably the software and/or the device is able to measure automatically preferably not only which songs or films or books (or other media) are more or less liked by the user, but preferably also for example which parts or sections in them are for example the best and/or which parts are less good or for example problematic. This can be very useful for helping improve for example those books or films or songs and/or for bring able to write better ones the next time. This can be done for example by automatically noting if there are any sections which the user for example likes to hear or read or view again and again and/or for example the device or software asks the users explicitly which sections they most like and/or for example in digital books noting automatically for example which sections the user marks and/or adds comments to, and then preferably anonymous statistics are sent automatically for example over the internet for example the next time that the user connects to download for example additional songs or films or books. Another possible variation is that for example in such devices and/or software for playing for example songs or films preferably the player can automatically adjust the sound level not to exceed a certain desired limit and/.or not to be too low below a certain limit. This can be done for example by automatically adjusting the level when the limit is reached or exceeded, and/or for example the software or gadget can preferably run ahead quickly in advance over the song or film and determine the maximums and minimums, however that would be much less efficient, and also the local adjustment is even better since preferably a separate optimization is done for each section.

Another problem is that for example in Windows XP when the user opens for example multiple browser or word processor windows, typically they automatically become like an internal division within one window on the taskbar, so that the browser or word processor appears in the taskbar only once and the other open windows of that application are listed within it (although at least alt-tab properlyjumps between the windows as if they were normally marked as multiple instances of the application on the task bar). Since this can be inconvenient or confusing for example for users who are used to all the windows of the same application appearing in the task bar, preferably the OS allows the user to activate a command which can for example automatically toggle between this mode to the mode where each window appears on the task bar. Another possible variation is that preferably the user can activate a command which automatically jumps each time to the next window (for example in the normal task bar on in the internal group of open windows that belong to the same application or for example between open tabs in the same application—for example in the Internet browser), so that preferably each time the user moves to the next window systematically. This is much more convenient than the prior art, where the user has to press alt-tab or control-tab but each time just moves manually to a specific window instead or has to use the mouse manually each time to get to the desired window, instead of being able to systematically traverse the relevant open windows one after the other. On the other hand, for example when opening additional pages in the browser as additional tabs within the same window (for example in Netscape or in Opera) there is a problem that for example closing a page with Alt-F4 closes the entire browser window with all the open pages (tabs) instead of just the current page, and for example the normal Alt-Tab does not switch between the tabs. Although typically CTRL-F4 and CTRL-Tab work on the tabs instead, this is less convenient since many users might prefer the same standard controls, so that tabs don't get a different status from normal open windows, and so that the user does not have to remember for each open page that he/she is viewing if it is for example an internal tab or a normal browser window, and if he/she makes a mistake he/she might close all the open pages that he/she is working with. In addition, in the prior art, if the user has some pages open as tabs and some as another browser windows, this means that switching between the pages requires using both Alt-Tab and CTRL-Tab, which can be very confusing and inconvenient. So preferably this is improved, preferably in the browser itself and/or by the OS, so that preferably for example Alt-F4 (or any other similar accepted convention) closes only the current page (tab) and preferably for example Alt-Tab switches also between the tabs (On the other hand, since some users have gotten used to the CTRL variation, preferably both the Alt and the CTRL variations work the same for the tabs, and/or for example the user can choose what effect the CTRL and the Alt variation will have, and/or at least for example when closing a tab page by Alt-F4 the browser or the OS warns the user or asks if he/she wants to close just that page or the entire browser window with all the open tabs). Another possible variation is that the OS itself automatically enables this, which can be easily done for example if the command of opening internal tabs within a window becomes an automatic service offered by the OS, so that application programmers simply call this service when allowing the creation of tabs within the application Window. Another possible variation is that if the user for example closes a browser window or for example a word processing file window or for example other applications (for example with Alt-F4) he/she can still press some undo button which automatically reopens the last closed file. This is preferably done by the relevant applications and/or the OS creating automatically a temporary backup of the open window or file when the user closes it. Another problem is that for example when trying to delete a directory through a command prompt window in windows XP the OS only asks “are you sure” without even letting the user know that this is a directory. This is very dangerous since the user might this way inadvertently remove even a huge directory tree. So preferably this is improved so that instead the OS tells the user that it is a directory and preferably tells him/her also the number of subdirectories and/or the total number of files in that directory tree and/or the total size. Preferably the OS also lets the user choose as one of the options a controlled deletion so that for example the user will be automatically asked to make the same choice for each sub-directory of the chosen directory and/or for example asked to verify the deletion of each file.

Preferably file sharing programs which download files from multiple other users, such as for example eMule, are preferably improved so that when the same file is available from multiple sources, they preferably download from each available source sections in preferably random order (so that for example from one source the end parts are downloaded, from another source middle parts, from another source parts at the beginning, etc.). This can prevent the phenomenon that, since certain files become no longer available during the process, typically the downloading becomes progressively slower near the end of the file.

Another preferably improvement is that when more than one OS is installed on the same computer the user can preferably easily switch the default OS to whichever option he/she wants and/or for example change the order of the options (where typically the first option becomes the default). This can be done for example by letting the user drag an option line with the mouse to a different position in the screen that asks which system to boot or for example press some key or key combination. This is very important, since in the prior art if the user for example installs Windows XP over a system of Windows 98 (so XP automatically becomes the default) and then prefers to use for example Windows 98, it can be very frustrating to have to change the choice each time when booting, and this is also important especially for example if there is a power failure and the computer reboots automatically. Although XP for example allows changing this by performing a few steps after the XP has finished booting, which most users don't even know how to do, it would be much more intuitive to let the user for example move the option lines with the mouse in the screen that asks which system to boot, as explained above. This means that preferably basic or standard mouse support is preferably activated at least partially already at this stage eventhough no particular system has been activated yet. Another possible variation is that the system automatically remembers the boot option that was last chosen and makes it automatically the default for the next boot until the user changes it. (Another possible variation is that this option also automatically becomes the first choice on the boot menu on the next boot, but that is less preferable since it might confuse the user if he/she is used to a certain order of the boot options and did not choose explicitly to change it).

Another problem is that for example in wireless networks (for example in homes or offices) the only method of protection against stealing data and/or illegal tapping into communications is encryption, which has already proved not reliable enough. Therefore another possible variation is that in order to improve the security of wireless networks preferably the network computers use also for example automatic triangulation of the source of transmissions (preferably by using for example all or some of the known devices in the network to compare the strength of the signal that they receive), so that for example the coordinates of the allowed space are entered into the system and/or for example only specific locations of known devices are white-listed, and so for example any intruder from an outside position cannot pretend to be an authorized user even if he succeeds in finding a vulnerability in the encryption. (Although this still does not prevent passively listening-in, preventing any other form of interaction can be very effective, since for exploiting various vulnerabilities typically at least some interaction as needed, so this together with encryption can be very effective).

Another problem is that for example Microsoft is now trying to market in low-income countries such as for example China and India a considerably cheaper version of Windows XP, however this version has some serious limitations that make it much less attractive to users, and one of the most severe limitations is that for example only a very small number of programs can be run at the same time. This can make the OS much less useful, so very few people will be willing to use it, even at a half price or less, and thus the main purpose (reducing piracy in those countries) can be completely defeated. Therefore, a much better solution is to let users buy the OS at such countries at such a low price preferably with few limitations or no limitations or at least no limitations that result in reduced functionality to the user, and preferably prevent loss of profit in other countries where the OS can be sold in normal prices—by limiting the use of the discounted version in the other countries. This can be done for example by at least one of the following means:

Limiting these cheap versions so that at least part of the interface and/or some important applications work only in languages that are not useful to most people outside the cheap countries (for example only Indian languages or Chinese languages).

Displaying a warning for example whenever the OS is started that it is illegal to use this version of the OS in any either countries than the list of qualifying countries, unless for example the user has a citizenship of one of these countries and/or is resident there, etc.

The OS can Check for example automatically when the user connects to the internet if his/her IP address is in one of the qualified countries and, if not, require for example some certification to be filed (if it hasn't been filed yet) which proves that the user is entitled to use that version of the OS outside of those countries. Preferably in these cases the OS can automatically stop working or start working with only limited functionality after a certain time period (for example one month) if said certification has not been filed.

Another problem is that for example in Windows XP if the system is unable to read a CD then the entire system can get stuck without any explanation to the user, since the OS apparently tries again and again incessantly to read the CD. Preferably this is solved by automatically aborting any attempts to read a problematic CD preferably after a short time and preferably indicating to the user the nature of the problem and letting him/her decide what to do.

Another possible variation is that preferably the user can tell the OS for example not to enter sleep mode until a specific application has finished running, for example by clicking on the application's window or for example on the square that represents it in the task bar and marking the relevant option in a menu. Similarly, another problem is that for example typical firewalls (such as for example Zone Alarm) are programmed to close the connection to the web automatically for example when the screen saver activates, which is usually quite useful, however sometimes the user for example might want the firewall to keep the connection open for example until one or more download operations are completed. For this preferably the user can also similarly preferably indicate for example that the firewall should not close the web and/or for example the screen saver should not be activated until the application has finished performing some operation. Another possible variation is that preferably when the user asks Windows to create a restoration point, the user has a choice of indicating if he/she wants a normal restoration point or also creating a full snapshot of the main system and registry files and/or the user for example can define in general if and/or when snapshot or normal restoration point will be generated when the system automatically creates them (for example every certain periods and/or for example depending on the amount of accumulated changes) and/or for example the system automatically creates the snapshot files whenever it is about to make highly significant changes for example in the system. In addition, preferably rollback info is saved automatically in more than one place, preferably together with a copy of a sufficient reference base-point, so that the system has a much better chance of restoring it even if for example the registry becomes seriously damaged. In addition, preferably the registry entries are made independent of each other so that even if part of the registry is damaged it will not effect anything else, and preferably the system uses transaction sequences in the registry and/or for example other important system files like in a normal database with automatic rollback in case the transaction has not been completed, so that if for example the system gets stuck while trying to update the registry and/or for example other important system files or the for example the FAT, etc., then when discovering this or for example even in the next boot (if the system for example crashed and had to be rebooted), preferably first of all at least some process come into action which automatically finds out transactions that do not have the mark that they were completed and thus preferably activates automatic rollback to the previous state before the unfinished transaction or transactions begun. (And, as explained above, preferably the rollback info is saved in more than one places). In addition, if for example there was still some damage beyond repair and the system needs for example to load a previous snapshot of the registry and/or other critical system files, preferably during boot the user is advised of the situation and can automatically view for example a list of the most recent snapshots and/or otherwise possible restoration points and can simply choose the most preferred ones to attempt and then the system preferably restores it automatically and continues to boot (instead of the prior art where for example in windows XP if the registry is damaged the system sometimes cannot boot at and all the user might have to boot from a special CD and restore manually the snapshot files from their hidden directory—which is quite a cumbersome process to perform manually). Another possible variation is that preferably at least the registry (and preferably also other files that are needed for snapshots) are always automatically kept in at least two copies so that if for example one copy becomes unusable (for example as a result of crashing or reboot in the middle of updating the registry) there is always an immediate backup of the most up to date version (for example in a way similar to the way that there are always two copies of the FAT). Of course automatic rollback info can preferably be saved also for much larger changes including for example any changes to the disk, as explained elsewhere in this application. Another possible variation is that for example during preferably every boot (which is typically a time when the user has to stair at an almost blank screen for at least 20-30 seconds), preferably the system uses this time to display important information to the user, such as for example details about the number of safe restoration points that exist (and preferably also their dates) and/or for example various indicators of the health of the system and/or for example the current automatic back-up policy that exists and/or for example the amount of remaining free space on the disk and/or for example the percent of disk fragmentation, etc. Of course, various combinations of the above and other variations can also be used. Of course, like other features of this invention, these features can be used also independently of any other features of this invention.

Another possible variation is that for example if the user does not find a certain file name, the OS automatically checks for similar names and asks the user for example “did you mean . . . ”—for example in a way similar to the way that Google offers users to correct typing errors in the search keywords, and/or for example the OS shows the user the list of closest file names available, sorted by closeness.

Another preferable improvement is that if there are more than one CD and/or DVD installed on the same computer they can be connected to a common audio connector for example in parallel or with some multiplexor (so that for example the same audio cable can lead from more than one drive to the sound card), or for example cables from more than one drive can lead to a common connector or multiplexor near or at the sound card. Preferably if more than one drive is playing for example a CD or a movie at the same time then either all the sounds are automatically routed to the speakers (this is no problem since normally the user would not play both drives simultaneously) or for example the correct drive can be chosen by software. This is better than the prior art where the user can typically connect only one of the drives to the sound card and thus can for example hear CDs or watch DVDs with sound only through that drive. Another possible variation is that no direct connection to the sound card is needed from any of the drives, and for example each CD or DVD that contains sound is simply played by activating the sound card directly through the software that plays the data, for example in the same way that the sound is played from an avi file on the hard disk.

Another preferable improvement is that preferably the user can for example define for example drives and/or directories to become shared for example only when connected by cross-linked Ethernet cable between two computers so that preferably for example they become automatically not shared when connected by normal cable to the internet. Another preferable improvement is that preferably the user can for example create a copy of the OS on another partition (for example on the same disk and/or even for example on a different physical disk in the same computer) preferably with a single automatic command, and then preferably the system with all the installed programs is automatically copied to the new partition (preferably by using automatically the registry to locate all installed applications and/or drivers and/or other relevant components) and preferably all the drive letter references in the new installation are automatically updated to refer to the new drive letter, and preferably the choice of the new partition is preferably automatically added to a boot selector. In this and/or in other variations preferably the user can also change the name of a boot option and/or add comments to it, for example while booting and/or for example from one or more applications that are available after the boot. This can be very useful if the user for example wants to create a backup of the installed OS on more than one partition, so that for example if the OS becomes corrupted or unstable, the user can in the meantime boot and work normally from the other partition. Preferably the user can do this also for additional partitions, and preferably the user can also use an update or synchronize command, which for example automatically updates any differences between two or more such OS-installed partitions, so that for example the user can update the other partition according to additional changes made in the original partitions, and/or for example the opposite—automatically correct the original partition according to one of the backup partitions, etc. Preferably the user can also request automatic undo of such updates, for example if anything goes wrong. Another possible variation is that even the new partition itself can be automatically created by the special copy command, if needed, for example in a way similar to the way that the Partition Magic software created new partitions, so that the user does not even need to have a new partition ready before requesting the special OS-copy command. Another possible variation is the user can for example mark only one or more specific installed programs and/or drivers and/or other parts to be automatically copied to the other partition, instead of for example automatic full copy of all the installed elements into the other partition. Another possible variation is that the user can preferably automatically backup one or more installed programs to a back-up media, so that preferably automatically the relevant registry entry is copied to the backup media and preferably all the relevant components are automatically copied preferably through the relevant registry information. Another preferable variation is that preferably when activating for example a command like SFC (which checks the integrity of installed system files and/or compares them to their source on the installation CD and restores them when needed), preferably this or similar commands can be used also from another OS or another installation of the OS on another partition and/or for example from the installation CD or DVD itself. This is much better than the prior art, since in the prior art it is possible to run SFC only after booting into the OS whose files need to be checked, whereas OS might be too damaged to boot into, which is like catch 22. Running such commands while booting from another partition should be no problem since the application that performs it preferably merely has to know on which partition and/or basic directory to run the checks, and preferably can use any information from there to know which files to look for and where. Another possible variation is that for example if the OS gets stuck during or after the boot, preferably the system can automatically sense it for example after a short time and preferably for example automatically identify the driver or application that caused it to get stuck (and/or for example any other source of the problem, such as for example bad change in the registry or other critical files) and preferably can automatically roll-back to the state it was in before the problematic driver or application was loaded and/or before the registry change or other relevant change and preferably can automatically continue without the problematic driver or application and/or can for example automatically search for a replacement driver or application and/or automatically instruct the user what to do in order to fix the problem. This is preferably done by at least part of the OS which runs below the normal OS and which preferably contains also a preferably large knowledge base about preferably almost any known problem that can occur, preferably with instructions on how to solve it. In addition, preferably the OS or part of it and/or for example this part below the OS preferably automatically tries to follow those self-repairing instructions whenever possible and preferably involves the user only if for some reason it is unable to perform whatever is necessary (for example because the installation CD is not in the drive)

Another problem which exists for example in windows XP is that for example if the user changes motherboards, the OS, unlike for example windows 98, is many times unable to overcome it and has to be reinstalled. So preferably this is solved by allowing at least part of the kernel and/or part of the OS, which is preferably hardware independent, to always boot properly even if there are a lot of hardware changes, so that preferably any adjustment problems can then be fixed after this initial boot, preferably automatically.

Another problem is that sometimes for example the OS does not allow the user to access a file because it is locked by another process (for example if Word previously crashed while working on a file and the user restarts Word and tries to access the file), but the user cannot do anything except open the file for example only for reading, since the OS does not even tell him/her what the problem is. So preferably when this happens (in such cases and/or in other cases of resource clashing) preferably the OS also lets the user know the identity of the clashing process and preferably the clashed resource and preferably any other needed info and preferably allows the user also options such as for example terminate the clashing process or for example freezing it temporarily for example until the user releases again the problematic resource.

Another preferable improvement is that when there is more than one physical hard disk on the same computer and more than one partition on at least some of these disks, preferably the OS automatically adds some mark to each drive name that indicates to which physical hard disk it belongs (for example an additional letter and/or number and/or icon which indicates the physical disk), since otherwise the automatic letters given to the various partitions can be confusing and the user might loose track of which partition belongs to which physical disk

Another preferable variation is that when using for example a system for predicting the next channel or channels that a user is most likely to jump to next for example in digital TV broadcasts (for example cable or satellite) and/or using multiple tuners to cover a large range of channels (so that for example the last 2 seconds in the predicted or covered channels are kept in at least one buffer) so that the zapping can be instant instead of typically having to wait for up to 2 seconds for the next base frame, as covered for example in U.S. application Ser. No. 10/905,038 of Dec. 13, 2005 by the present inventor, preferably additional improvements are added to solve the problems of the decryption time and of channel mixing. The channel mixing problem is that because some channels can be statistically much more bandwidth consuming than other channels (for example action movie channels, where there are significant changes between the frames, vs. for example an interviews channel, where people sit in front of the camera with typically little change from frame to frame), typically the cable or satellite providers try to optimize statistically the allocation of digital channels on each data-stream (frequency), so that for example there are 10 frequencies with 15 digital channels carried on each frequency, but consecutive channels are many times scattered between different frequencies because of statistical considerations. Therefore, since typically the most common zapping is consecutive going up or down in the channel number, preferably the solution is avoiding the scattering, so that the channels are grouped together consecutively in the frequencies, and solving the statistical bandwidth problem by changing the number of digital channels in each frequency as needed, so that for example if the first channels contain typically movie channels, which are by nature more bandwidth consuming, then preferably the first frequency contains less channels, as needed (for example only 7 channels instead of the normal 15), and other frequencies contain a smaller or bigger number of channels depending on the overall fatness or thin-ness of the channels that are grouped into them (in terms of the average bandwidth needed by them). This may be a little less efficient than optimization by scattering (since for example putting 7 fat men in one elevator can waste a little more space than putting people of different weights in the same elevator, since with the fat people there is less flexibility for example in the last gap if you avoid bringing in a thinner channel for the last gap if it is not the next consecutive channel), but keeping the consecutive order is much more efficient for the instant zapping. (Another possible variation is for example to keep the order as explained above but use flexibly for the last gap even 1 or more non-consecutive channels, but that is less preferable). The encryption time problem is that since it takes some time to decrypt each channel from the base-frame, in order to decrypt in advance the predicted and/or covered channels which the user can next zap into (preferably into the at least one buffer), the system has to either use some table which knows in advance which channels the user is allowed to view (in most systems the user typically has only a basic subscription and pays in advance for a set of additional non-basic channels), or the system checks if the user is allowed to view a given channel only after the user has already jumped into it. The problem is that if such a table is used (which means that the set-top box finds in advance which cannels the user is allowed to view and puts this information into some table in memory), then such a table in memory makes it much more easy to hack into the system and for example change this table or bypass it. On the other hand, if the set-top box is designed to check if the user is allowed to view the channel only after the user has jumped to it (thus avoiding the security risk of such a table), then enabling the instant zapping means that the system might have to allow the user to view the first 2 seconds even before checking if the user is allowed to view this channel. One possible solution is to indeed allow the user to view for example the first two seconds (or other relevant time slice) before checking his/her permission to view the channel and then blocking the channel if needed. This is still OK since the user would normally not gain much by constantly zapping for example between two channels that he/she hasn't paid for and seeing each time for example only 2 seconds (except if someone for example connects 2 such set-top boxes with an automatic channel switching and automatic multiplexing into the same TV). Another possible solution is that for example in the covered and/or predicted channels the system automatically detects for each such channel if it is allowed or not even before the user jumps into it, and preferably does not save this info anywhere else. Another possible variation is that for example the set-top box does determine in advance which channels are allowed for the user but preferably this is not saved in a normal table but preferably for example in some scattered and encrypted manner in memory, so that preferably even the location in memory of the different cells of this table preferably changes all the time.

Another preferable improvement is that computer cases are improved so that the same case can be used either in desktop position (lying in a horizontal orientation) or as normal tower (vertical orientation), thus giving the user much more flexibility in choosing the most convenient orientation without having to buy different cases. This is preferably done by making the case strong enough to support even large screen on top of it when used in the desktop orientation, and preferably at least the area that supports the external CD and/or DVD drives, is preferably rotate-able between two positions, preferably in 90 degrees (preferably only back and forth between the two position—to avoid excess bending of the cables), so that preferably the user can easily choose one of these two position, at least by screwing the part when the case is open, but even more preferably the user can for example press one or more levers or buttons and then rotate the part even when the case is closed. An example of the case with the rotating element is shown in FIG. 7.

Another problem is that due to standard debug features in motherboard bridges, actually any computers that are connected to the internet, for example through a modem card or through an Ethernet card or USB, can be compromised by a hardware-based attack even below the OS, so that for example the Ethernet card can tell the north bridge and/or the south bridge to report to it any data that passes from the hard disk and/or even send directly commands to the hard disk through the bridge. Such activities can therefore bypass any software-based security system. In order to prevent this preferably at least one of the following is done:

Preferably the motherboard chipset is changed so that such debug features and/or for example direct communications for example between hardware cards and the hard disk are preferably enabled only if some hardware element allows it, such as for example a jumper or a switch which has to be manually enabled by the user, and preferably the default mode is the disabled state.

Another possible variation is that the user can for example add a card to one of the PCI slots and/or for example add another external device (such as for example a USB device, a PCI express device, and/or other type of connection device) which preferably keeps sending commands to the bridges which can preferably for example over-ride any attempt by other devices to tell the bridge to sniff on data or to communicate directly with the hard drive and/or for example the communication channels (for example the Ethernet card and/or USB devices and/or wireless devices).

Another possible variation is that preferably the OS and/or a software Security System is preferably able, preferably through the OS kernel or even below it, to take complete control of the bridge and give it instructions that override any undesired attempts by hardware elements to sniff data and/or access directly for example the hard disk and/or for example the communication channels (for example the Ethernet card and/or USB devices and/or wireless devices).

If for example some devices need to be able to exchange data with the hard disk directly, preferably at least any command sent from the device to the hard disk can preferably be monitored and filtered for example by the OS and/or by a security system installed on the OS, so that for example the data transfer itself is not slowed down, but for example the OS and/or the security system can control preferably what files and/or directories can be accessed directly from the device and preferably what commands can be transmitted to the hard disk.

Of course, various combinations of the above variations can also be used.

Other improvements can be done for example in statistical packages, such as for example SPSS, so that for example when correlations (or other types of output) are displayed (for example on the screen and/or in printed form) for a large number of variables, preferably the user can for example instruct the system to automatically mark for him/her the most significant correlations, for example by automatically encircling them and/or for example using some special icons and/or fonts and/or colors and/or other marks (preferably they are surrounded for example by a background with the color, so that the are clearly visible also on monochrome laser printers, for example with a gray square), and/or putting them for example in a different section. The criteria for which correlations are sufficiently significant can be for example some default criteria defined by the user and/or automatically by the system, such as for example only correlations above 0.2 (or other significant cutting point or points defined for example by the user and/or by the system), and/or for example only correlations where the significance is 0.005 or less (or other reasonable cutting points defined for example by the user and/or by the system), etc., or for example the cutting points automatically and/or by user definition can preferably change dynamically according to the results, so that for example they can be automatically determined according to the number of correlations (for example if there are much more correlations in the results than preferably the cutting points become more demanding), or for example the cutting point is in addition or instead based on relative percent, so that for example the top 5% best correlations (or any other desired percentage, definable for example by the user and/or automatically by the system) are automatically marked, and/or for example some combination is used, so that for example only the top x% correlations that are also beyond a certain absolute cutting point (for example of correlation values and/or of significance) are automatically marked. In addition, since some correlations can be much less meaningful than others—for example various Pearson Corr or other correlation commands can create automatically also correlations of variables with themselves, preferably these are marked differently and/or ignored, and/or taken into account differently so that they do not distort the statistics. Another possible variation is that the user can mark for example one or more sections of the correlations results (for example with the mouse) so that these automatic marking or statistics will be run only on parts of the results (since for example some of the correlations might be known by the user to be more or less meaningful than others). Preferably, apart from marking the most important and/or meaningful correlations, the system can, in addition or instead, also report various meta-statistics, such as for example what percent of the correlations are beyond certain cutpoints (for example according to the correlation value and/or the significance), and preferably this can be for example reported for example as a combination of such cut points and/or for example for each cut point or criterion separately, and the system can preferably also report for example what is the significance of these meta-results, i.e. for example what is the chance that for example in these specific results 12.7% of the correlations have significance for example below 0.01 (or any other value), preferably while taking into consideration issues such as for example the total number of correlations, the number of cases upon which they are based, and preferably automatically ignoring all the correlations of variables with themselves and preferably also for example any other correlations that the user marked as less meaningful and/or that the system can for example automatically determine as being less meaningful. (For example variables that are defined in an overlapping way, for example because they are based on computation involving other variables, will create correlations that may be interesting but should preferably not be confused with other statistics since part of their correlation is artificial, and there should be no problem for the system to automatically identify the problematic correlations for example according to the “compute” commands that were used). Preferably these statistics can of course relate also for example directly to the marked results, so that for example the system can report what number of results was marked out of what total, what percent it is, and/or what is the chance of having such a meta-results by chance, however these meta-statistics preferably show also additional values. Another possible variation is that the system can automatically and/or by user request generate also various graphs for visually displaying these meta-statistics. (Although it is possible in the prior art to run for example a cluster analysis or an Addtree or Extree analysis on a set of output correlations, this is a very specific analysis that takes as its input a matrix of correlations and uses them as distance data to derive an analysis of the way these variables are clustered as a group. In contrast, the above suggested meta-statistics can be much more general and much for flexible, and thus can deal for example also with correlations that are not in the form of a matrix of correlations of N×N variables, and preferably can analyze for example the value of the correlations themselves, as explained in the above examples, whereas for example cluster analysis or Addtree or Extree take the correlations as input without analyzing the value or significance or meaningfulness of the correlations themselves. In addition, for example analysis such as Cluster analysis, Addtree or Extree are not a substitute for looking also at the correlations themselves, and the above described markings and/or meta-statistics can help the user analyze or evaluate also the correlations themselves). Another possible variation is that the system can for example use more than one type of mark, so that for example 2 or more levels of significance are marked differently, for example more conspicuously and/or with different colors. Another possible variation is that the system can for example automatically sort the results for example according to their value and/or importance and/or significance, so that for example in the case of correlations, for example the highest correlations and/or the correlations with the highest significance values and/or some combination of the above are displayed first. (Preferably the user can request for example if to display the correlations normally or in a sorted way, and if so, sorted by which criteria or combinations of criteria, and/or the user can for example also request some combination, so that for example the results are displayed according to certain structures and the sorting is for example only within the structures). Another possible variation is that for example instead of marking correlations, for example only the relevant correlations (or other results) that fit the criteria (and/or would have been marked) are printed, thus saving paper and time. However in that case of course preferably this is accompanied by meta-statistics that refer also to the non-printed results. These automatic markings and/or meta-statistics can be applied for example for each statistical procedure or command separately or for example to the entire set of procedures or commands, for example on the same Run. Another possible variation is that the system can for example automatically correct the significance scores of the correlations, for example according to the Bonferroni correction formula, so that the significances themselves are already displayed corrected, however that is less desirable, since it means that the significance can change all the time depending on the number of tests in the same run (or set of runs), thus making it confusing and not consistent when someone wants to compare various results. Another problem for example with Pearson correlations is that 1 or more extreme values away from a main cluster of values can sometimes distort the correlation. This is preferably solved for example by allowing the user to request automatically running the tests also on preferably automatic randomly divided sub-samples, and preferably the number and/or size of the sub-samples is determined automatically by the user and/or by the system (for example according to the number of cases and/or according to the variance and/or according to other parameters). Another possible variation is that this test is run automatically by default (for example unless the user explicitly requests to suppress it) and preferably the correlations (or other statistics results) can also be for example marked differently and/or displayed in a different section if they are more stable across these sub-sample tests, and/or the results of these stability or strength tests can be for example displayed each near the corresponding correlation (for example as a number indicating the stability value). Although for example SPSS has recently added to their most recent version (Ver. 12) the ability to request tests on sub-samples (a new feature called Complex Samples which uses CSPLAN to define the sampling parameters), the CSPLAN design specification is used only by specific procedures that are defined within the Complex Samples Option, whereas according to the above suggested solution automatic analysis by random sampling is preferably automatically available and automatically activated for any statistical procedure, and as explained above, the results of this analysis can preferably be used automatically for example to mark the most important results. So preferably either the sub-sampling is done randomly and automatically by the system by using preferably automatic defaults and/or automatic rules that are preferably used to decide the most desirable sampling strategies according to various parameters of the actual data, and/or for example the user can define in addition or instead more specific parameters, for example by the above CSPLAN procedure, but preferably these definitions can then be applied automatically for example to any of the normal statistical procedures that are used for that run, and this is preferably used also for marking the best results, as explained above (and/or is taken into account for example for the sorting, so that for example correlations are sorted both by their size and/or significance and by their stability and/or for example within a certain level of strength the results are internally sorted by stability). The automatic rules defined by the system can for example take into account the original sample size, and for example determine the size of sub-samples by the minimum desired absolute size of the sub-sample and/or by the minimum desired size in percentages, and/or for example by the number of correlations that are tested, etc. For example the best automatic choice might simply be to create just a division of 2, but for example create this multiple times (for example 10 times or any other desired number) with a different random cut and compare the results for stability across all random attempts. Preferably there is for example one most preferred default, and if the user is not satisfied with this he can for example choose from a few other suggested defaults or sets of rules, and if the user still does not like any of them he can add his own rules in addition or instead. Of course, a list of correlation results is just an example, and similar principles can be applied for example to other types of statistical results where multiples results are presented together. This is much more convenient than the prior art, where the user typically had to print the results and mark manually the most significant ones. Another possible variation is that the user can for example request to run various procedures (such as for example FREQUENCIES or PEARSON) also on lists of variables defined by exclusion (such as for example “ALL EXCEPT AGE”). Of course, various combinations of the above and other variations can also be used. Of course, like other features of this invention, these features can be used also independently of any other features of this invention.

In addition, preferably various statistical programs that allow backwards checking, such as for example the search engine of http://search.wallstreetcity.com/wsc2/prosearch.html are preferably improved to allow the user much more flexibility in defining the backwards checks. For example, the Wallstreetcity.com search engine allows the user to test various investment strategies retroactively up to one year, in order to see which performed best. However, the user is thus limited to only a very small test period, which can be very unreliable, since if for example during 2003 the market came up from a multi-year low, strategies that work best at such periods might for example work very differently in other periods. So instead of this, preferably the user is allowed to use the retroactive test on much longer periods (such as for example up to 10 years backwards), and in addition, preferably the user can for example divide it to one or more sub-periods and see the performance for example on each sub-period, and the user can preferably define for example the exact starting point and/or ending point of each period or sub-period. In addition, in the prior art search engine the user has no control on the way the tested strategy is applied retroactively—for example are the N stocks that most fit the test criteria simply bought at the beginning of the retroactive test period (for example 12 months ago) and just held for the entire period, or for example every month the stocks are replaced if there are other stocks that now fit the criteria better, etc. So this is preferably improved so that the user can define for example exactly on which times or after every what period the stocks are again updated according to the strategy (for example every week or every month or other convenient period) and/or for example the stocks can be updated automatically (for example even once a day or even any time) when there are one or more stocks that become better according to the criteria beyond a certain minimal margin of difference. For example if there are 8 stocks that were chosen according to the strategy, anytime that one or more new stocks become for example 5% or 10% more (or any other convenient margin) better than at least one of the for example 10 or 20 original stocks (according to the chosen criteria), then the appropriate stock or stocks can be automatically switched for example anytime during the retroactive test simulation. Preferably all of these stock swappings take into account also at least minimal required commissions, so that the end result of the simulation preferably reflects correctly the performance that would have been made after having also paid the necessary commissions in order to apply the strategy (in addition, preferably the user can specify the commission level that most correctly reflects what he would have to pay in reality if he did these swappings). Another problem is that this prior art search engine allows the user to define the past performance of the stock (which is one of the possible criteria) only in terms of performance over a defined period (for example the last 3 years or the last 5 years), which thus unnecessarily limits the user. So this is preferably improved to allow the user to define in addition or instead for example criteria such as for example choose the 10 or 20 (or any other convenient number of) stocks that performed in a certain way from the last peak (and the peak itself can be for example specified specifically by the user as for example as an exact date or for example automatically found by the system). This is important, since if for example a NASDAQ stock was at its peak in April 2000, and was for example much lower in January 1999 and in January 2001, it might be much more informative to take as a criterion for choosing stock their performance since the last sufficiently large peak, or for example since the highest peak that existed over the chosen period (where the peak is automatically found for example in the last 3 years or 5 years or any other desired period) instead of taking as the criterion automatically the performance since the beginning of the specified period. Of course, various combinations of the above and other variations can also be used. Of course, like other features of this invention, these features can be used also independently of any other features of this invention.

Other improvements can be done for example with Internet browsers and/or other programs that access the Internet, so that for example preferably the browser can request from the server also just a part of an Internet page, such as for example a certain line or for example the value near certain words or areas or fields in the page, etc. This can save a lot of time and traffic, since for example programs that want to update data from various pages and/or run for example various statistics with data from a large number of pages might need just a small part of the data in each page, and thus this can be much more efficient than having to request the whole page and then look for the desired data in it. Although there exists already a format called RSS, which allows getting only a specific area from a web page, this is an XML format that requires specific definitions in advance in the desired web page in order to enable this. On the other hand, according the above improvement, specific requests can preferably referred to web servers regarding any pages, so that for example the browser (and/or for example other programs that accesses the Internet) can request from the server for example just a certain line or lines or words or words in the page, for example defined by position (such as for example lines 20-22), and/or for example defined by content (such as for example, Bring me only lines that contain a certain search string), etc. This is very important since most web pages today are much less structured than XML pages. The server can provide this information for example by simple string search on the web page, and then sending to the browser just the relevant data instead of the desired page. This can be done for example by the server itself or for example by additional software that runs preferably together with the server, preferably on the same computer or at least on the same site or location. Another important improvement is that when uploading a file—for example when submitting a form or in any other way, preferably the browser specifically warns the user about the file name that is about to be uploaded and preferably also its path and/or its size, so that the user can know exactly what is going on, instead of the prior art in which for example when submitting a form Netscape just warns the user that data is about to be submitted, since the prior art warning is activated any time the user presses the submit button in a form and thus the user does not pay any attention to it if he/she indeed is submitting a form, and so the user can be easily fooled for example by malicious web pages if the form looks OK but a file is downloaded from the user's computer for example as a hidden variable or in any other way that the user does not notice that it is included in the form (for example invisible font color and/or size, etc.). In other words, the warning is preferably more specific about such files, instead of or in addition to the normal warning about submitting any form. (Preferably the general warning about submitting forms is not needed and the browser automatically avoids submitting anything unless the user really pressed a submit button. However this preferably includes a lexical and/or grammatical and/or semantic analysis of what is written in submit buttons, for example in normal form buttons and/or in Javascript buttons, and/or for example the browser automatically indicates to the user near each button what action pressing the button will lead to, preferably at least when the mouse is near it, before the user even presses it, or even all the time, for example near the button or superimposed on it, for example by showing the button at least partially transparent, in order to reduce the chance of the user being fooled by a misleading button). Another possible improvement (which is similar to some of the variations of the solutions to the focus grabbing problem discussed elsewhere in this application) in browsers is that preferably when the user types text for entering for example in some field in a form, preferably the browser and/or the OS can keep it automatically in some buffer, so that if the user starts to type before the actual form field is reached—for example in pages where on loading the page the focus goes automatically to a search line even if the user does not click on it, such as for example in various search engines, for example if the user starts typing before the page completes loading, the typing is not lost but is preferably added automatically for example by the browser or by the OS to the beginning of the input line. Another preferable improvement for example in other email sending programs (such as for example Pegasus) is that when the user tries to send for example multiple emails and some of them get for example a TCP/IP error or some other kind error when trying to connect to the mail server, preferably the email sending program automatically saves these messages separately and can preferably automatically try to resend them for example after some time or by user request (preferably only if they are non-permanent errors) or for example can automatically display them one after the other so that the user can try to correct whatever is wrong when possible, and then for example pressing some key automatically tries to resend the same message. Another preferable improvement is that for example if the user changes the language from English to Hebrew while filling a form in a browser, preferably the user can also indicate if the change is intended only for that specific browser window, or for example the change is be default automatically only for the specific site involved until the user changes it again (which means that preferably this information is saved for example in a cookie file), or for example the change is automatically only for similar types of forms, etc. Another possible variation is that the browser automatically takes into account the language of the text near each form field and automatically accepts by default the input in the appropriate language.

Another improvement in Internet browsers is that preferably the user can for example mark a group of links (for example in the history list and/or in the bookmarks list of the browser, and/or for example in any web page displayed by the browser that contains links) (for example in a way similar to marking more than one object in a scroll list and/or by simply marking the area where the desired links are), so that after the user for example marks the desired group or groups of links, preferably pressing for example some button causes the browser to automatically open multiple windows so that preferably each window accesses automatically one of the marked links. This means of course that preferably similarly choosing for example “save as” after marking the links causes the browser to automatically save the targets of all the marked links (for example other web pages and/or files, etc.). In this case preferably they are saved by default with their original names, or for example the user can define a group name which is preferably incremented automatically to differentiate between the files in the group, and/or for example the system can automatically read the title in each of the files or web pages and use that as the name. Similarly, preferably the user can also for example perform other commands on the group of marked links, such as for example automatically print the group, etc. Another possible variation is that the user can for example perform commands that affect a group of open windows (preferably of the same application—for example browser windows)—so that the user can for example enter a command that prints all of them or that saves all of them or that bookmarks all of them—for example by entering the global command in one of the open windows of the same application, or for example by marking multiple boxes in the task bar (for example by clicking with the mouse while the shift or control keys are pressed) and then entering the command, such as for example AS for saving all of the marked windows (and/or tabs), AD for bookmarking them, and AP for printing them. Another possible variation is that in this mode the user can for example choose automatic carrying out of the global command or for example to be prompted for each of the windows for example with the option to choose yes or no in each case. Similarly, for example when the user wants to print an original patent image file in the EPO and/or for example print the drawings of a patent in the USPTO, in the prior art he/she usually has to request and print each page separately, which can be quite cumbersome and lengthy. So preferably these databases are of course improved so that the user can for example press an icon which allows printing for example the entire image file or for example a range of pages. Another possible variation is that even without improving the available options in the site itself, preferably the browser itself can allow the user to define a set of steps to be performed automatically, such as for example pressing the icon or link that leads to the next page and then printing it, so that for example after pressing for example once or twice the “next page” link print it, preferably the user can activate a command that tells the browser for example to repeat the last N actions for example an additional M times and/or for example until it is no longer possible (for example after reaching the last page the next page icon is no longer active). Another possible variation is that preferably when pressing for example a Javascript button which designates a link with the right mouse key, preferably the same options are available as when pressing for example the right mouse button over normal links, such as for example Open in a new Window instead of in the current window, or Save the link target instead of opening it, etc. (in the prior art buttons that designate links can only be opened normally by clicking on the left mouse button). Similarly, preferably the browser shows the action defined by the button at least when the user's mouse is near the button or above it (or even all the time), for example by showing the button with a semi-transparent color that lets the user to see text under it, so that the user can know in advance what to expect, and if for example pressing the button activates some Javascript function then preferably at least the function name is shown. Another possible variation is that when typing for example one or more words or part of a url address in the location window of the browser, preferably the browser does not attempt to go automatically to the “.com” address, but can for example check also, preferably simultaneously, if the address can be resolved also to other TLDs (Top Level Domains) or other domain extensions, such as for example “.net”, “.org”, “.info”, “.co.uk”, etc., and then preferably the browser opens for example a scroll Window of the existing addresses and lets the user choose the desired one. Another possible variation is that in such cases the browser can also for example check automatically in the background, for example on a search engine like Google, which of these possibilities shows up higher (i.e. for example has more links pointing to it) and then preferably sort the options by popularity or even for example choose automatically the most popular option, so that if for example aol.net has a higher score than aol.com then for example typing in the location window the word aol will automatically lead to aol.net instead of aol.com. In addition, preferably the user can tell for example the OS and/or the browser and/or for example the service that the user acquired domain names from, to automatically perform all the actions necessary to renew one or more specific domains on time even if the user forgets to do it (for example the browser can automatically login to the site and perform the necessary actions for renewal, or for example the service is instructed to renew it automatically like a subscription if the user does not cancel the automatic renewal until the automatic renewal time, etc.). (This is very important since even huge companies sometimes forget to renew on time important domain names eventhough they get automatic reminders from the domain name service). Another possible variation is that for example the OS and/or the browser can automatically sense the width or size of the screen and/or the resolution and/or number of fonts available, so that for example if a table does not fit in the page and necessitates creating automatically for example a horizontal scroll bar, preferably the browser and/or the OS can for example decide automatically to reduce the font size accordingly so that the scroll bar is not needed (this is preferably done for example only if the automatic reduction is of a limited size, for example up to 20% or any other reasonable ratio). Another possible variation is that the browser can similarly also decide automatically for example to reduce only the width of the fonts, so that the fonts become thinner, which can be easier and more convenient to read than a font that is also smaller in height. This can save a lot of time and increase surfing efficiency. Of course, various combinations of the above and other variations can also be used. Of course, like other features of this invention, these features can be used also independently of any other features of this invention.

Another preferable improvement is that preferably the user is warned automatically for example by the browser and/or by the email client if an http link (for example in a web site or in an email message) is trying to deceive him. For example there are email messages that pretend to come from PayPal or Ebay or various banks and tell the user that someone unauthorized has accessed his data and invite him/her to click on a link in order to check or update his/her data, and the visible link says for example https://www.paypal.com but the real link within the href is somewhere else, so that the user is lured onto a phony site and into revealing secret information, such as for example his/her credit card number, account number, passwords, etc. (This kind of fraud attempts has increased dramatically in the last year and is commonly called phishing, and a large number of users are indeed fooled by it into revealing their data). So in such cases preferably for example the browser or the email client automatically indicates to the user preferably in a conspicuous manner (for example by flashing the real link within the href) that the real href is different, or for example warns the user about this when he/she clicks on the link and gives him/her a chance to cancel before actually going to the linked site. Of course, in such clear cases of misleading hrefs (for example Email messages that contain clearly misleading hrefs where the visible link does not fit the real link) can also for example be automatically blocked for example by spam filters, thus not reaching the user at all. (Preferably normal spam filters are also improved to identify automatically for example typical patterns of mixing digits with letters in a way that tries to bypass word filters) However, the visible link might just say in this example for example “Paypal” without the full url, in which case it is more difficult to be sure of the attempt to mislead the user, so another possible variation is that preferably for example the browser or email client automatically indicates to the user also the real url that is within the href (preferably in the normal display of the page—for example next to the link or superimposed on it, preferably even when the mouse is not near it, and not just in a line at the bottom of the window when the mouse is standing on the link, as is done in the prior art, since many times the user clicks quickly without even noticing it). This is important because eventhough the user might discover the deception after clicking on the link, this is still dangerous, because the link might for example point to a site that contains hostile a code that takes advantage of some vulnerability for example in the browser or in some pluggin and thus can compromise the user's computer and for example steal or destroy information or plant a Trojan horse on the user's computer. Of course, a generic security system such as for example described in PCT application WO0192981 and U.S. application Ser. Nos. 10/301,575 and 10/644,841 by the present inventor provides ample protection against any such threats, however it is still a wise policy to warn the user in advance about such attempts to mislead him. Also, there have been attempts for example to use unreadable characters in the url that appears in the location window (for example http://www.microsoft.com[special character].hackersdomain.com), so that for example Internet Explorer will display the url only up to that character, and thus the user might not discover the deception even after clicking on the link. Although Microsoft has fixed this specific bug, other ways to display a phony url in the location window might be discovered later. So, in addition, preferably the browser automatically makes sure that the url in the location window is indeed displayed exactly like the actual url that it connects to, and if there are for example unprintable characters then preferably they are marked with some sign and do not effect the printing of the rest of the url, and if there is for example any attempt by javasrcipt or for example Active-X or for example some other portable code (or for example by any other program on the user's computer), to put for example other data on top of the location Window (for example by fitting another small window that appears exactly on top of the location Window), then this is preferably automatically prevented for example by the browser and/or the OS and/or the computer's Security System, for example by automatically preventing other programs from putting any windows in front of the browser window unless the user explicitly transfers the focus to them, and/or for example by automatically intercepting windows that have a suspect size and/or shape and/or location or that otherwise have suspicious or unusual qualities. Another possible variation is that such sites that allow the user to make monetary transactions preferably have additional precautions that prevent the thieves from doing real damage even when they succeed in luring users to divulge their secret data. These additional precautions can be for example that for any transaction or for example for transactions above some minimum amount, or for example at least during login in those sites, the user gets an automatic message directed to his/her known address (for example email or Instant Message, with a special code) which preferably contains a unique one-time use generated code, and the user has to respond to it before he/she can go on with the login or the transaction, and/or for example the user has to login from certain known IP addresses or range of addresses or address parts and cannot login at all from other places (and/or the login must be from a certain geographical positions, for example a certain range of GPS coordinates, for example when geographic IP addresses are used), or for example the challenge email is sent only if the login is from another location and/or not form the allowed IP addresses, and/or for example the user's identity is verified by a biometric method and/or by a physical identification hardware that only the user has, and/or these same methods are used for verifying attempts to use the credit card, etc. Of course, the system preferably prevents forgery of IP addresses, for example by any of the methods described for example in my Canadian application 10/756,839 of Jan. 11, 2004 and 60/561,160 of Apr. 9, 2004. This way even stealing for example the users' account numbers and/or passwords and/or credit card numbers, still severely limits the thieves' ability to use them. Another possible variation is that when the browser enters a site it automatically checks also a relevant WHOIS database and displays to the user automatically also the name under which that domain is registered and/or for example the country and/or other details that can easily indicate to the user if a site is phony. Of course various combinations of the above and other variations can also be used.

Another problem is that many times when filling various forms or questionnaires, the user might have to check or uncheck multiple checkboxes, as shown for example in FIG. 6. So preferably the browser is improved so that the user can for example darken with the mouse a group of checkboxes (for example by clicking the right button and dragging the mouse over the area while it is clicked) and then with one command for example mark or unmark the entire group, and/or for example dragging the mouse over a group of checkboxes with the left button pressed immediately marks each box on the way and dragging it with the other button pressed unmarks each checkbox on the way, or for example vice versa, etc. Another possible variation is that the user can for example also unmark a radio button (for example by clicking on it again or for example using another mouse key) since in the prior art once a radio button is marked it can not be unmarked except by marking another radio button which belongs to the same set.

Another possible variation is that for example when a computer becomes compromised by a Trojan and becomes for example a spam-relay station, preferably there are special sites or for example routers which identify the attacking computers and can preferably send the users who's compromised computers have participated in the attack (for example by identifying identical or sufficiently similar multiple messages from these multiple origins) for example automatic warning messages, for example directly to their IP address or to their email (However, using the email is much more preferable since on many such computers there is no normal way of sending messages to this IP address which the user will see). Preferably this can be accomplished automatically, even if the Trojan for example uses forged email addresses and/or forged IP addresses, for example by any of the methods described in the present inventor's U.S. application Ser. No. 10/756,839 of Jan. 11, 2004 and Provisional application 561,160 of Apr. 8, 2004. For translating the user's real IP into his/her email, preferably the system works in cooperation with the immediate ISP of the inflicted computer. Another possible variation is to identify for example when the user's normal Internet Browser accesses web pages from the real IP address of the inflicted IP and then for example various routers on the way or relay stations or special sites can Send the warning to the user for example when the browser tries to access a normal web page. Another possible variation is that for example the IP addresses of inflicted computers are automatically updated in one or more special URLs in real time and for example the OS and/or the browser automatically checks regularly in one of these official sources and sees if the IP address fits the real current IP address of the current user's computer and then warns the user. However, in this variation, preferably IP addresses are removed automatically when there is an indication for example automatically from the ISP that a different computer or phone number is now using that IP address, for example by the nearest ISP node automatically identifying the user's phone number, for example when a normal model or ADSL modem is used and/or some other hardware fingerprint of the computer, since otherwise the wrong user will be warned. However, this is preferably needed only if the user has an insufficiently protected firewall or for example if the user inadvertently gave the Trojan horse permission to access the web. For example the generic security system such as for example described in PCT application WO0192981 and U.S. application Ser. Nos. 10/301,575 and 10/644,841 by the present inventor describes among other things firewalls that even prevent Trojan horses from bypassing the firewall (for example by installing a driver that accesses directly the communications card or its driver), while normal firewalls can become completely ineffective when this happens. Another possible variation is that for example when the user is asked to authorize Macro commands to run for example in Word, preferably he/she also has a choice of for example allowing only macros which do not access files beyond the present document, or for example the user allows the macro to run but is automatically warned and asked for authorization whenever the Macro tries to access external files.

In addition, preferably when searching for example for MIDI files on the Internet preferably the search engines are improved to enable for example automatically choosing the best MIDI files, for example by displaying first the most popular files. For example, in the current prior art the MIDI search engine http://www.musicrobot.com/ (which is perhaps the best MIDI search engine) Enables users to find MIDI files according to song names and shows first a list of all the song names that contain the search string, so that if for example the user searches for the song “yesterday once more” but uses as search string the words “yesterday once”, the results are displayed for example as shown in FIG. 4 below. As can be seen, the results are ordered not by the most popular entry (i.e. the file name that appears on most sites) but by being closest to the search string. In this prior art search engine, if the user then chooses to click for example on the most popular file (entry 4), he/she then gets a second division—according to the file length of the files with the same name (in increasing order), so that for example the list od results shows that a file named yesterdayoncemore.mid (with the length of 8,430 bytes) is available from 4 URLs (for which the user is given the links), a file with the same name and length of 24,601 bytes is available from 7 URLs (for which the user is given the links), etc. However, in reality, the file that appears in most URLs is usually the best MIDI version of the desired song, so this means that the user has to manually look for the file size that is available from the largest number of links, and sometime there are a large number of results (especially for more popular songs) so this is cumbersome. So in order to improve this, preferably in the first stage, after choosing the set of results that are sufficiently close to the search string, preferably the search engine automatically sorts the song names by the most popular in descending order (and/or for example the similarity to the search string is also taken into account, however if the original set was chosen properly this should not be necessary since at least most of the results in the set should be relevant, and the most popular names will probably include the song that the user is actually looking for). Secondly, after choosing the desired file name, preferably the 2^{nd} stage is also sorted by the number of links available for each file size (instead of the sorting by the file size in the prior art engine), and so the user can preferably typically with just 2 clicks of the mouse reach immediately the desired MIDI file that has the best chance of being a good version of the desired song. Preferably similar principles are used also for example when searching for recorded songs on the internet—for example in legal shops which sell online songs (for example in mp3 format), so that for example the user can use a meta-search over a number of such stores and can preferably use the same stages described above like in the midi file search. (This is another improvement in Internet search technology as defined for example in the present inventor's Canadian patent applications 2,443,036 of Sep. 14, 2003 and 2,444,774 of Sep. 29, 2003). Such a search or meta-search engine can for example work on a server on the Internet and/or can for example be at least partially implemented on the user's computer, for example as part of the OS (so that for example at least some of the processing of the results is done on the user's computer). Of course, MIDI files are just an example and similar principles can be used also for other types of searches, such as for example in Shopping metasearch engines, so that for example if the user is looking for example for a combined Fax-Scanner-Printer, the system preferably helps him/her choose the specific manufacturer and model for example by sorting the models by descending order of popularity. Another preferable improvement for example in such shopping metasearch is that preferably the metasearch engine can show not only a current price range but also for example a table or graph of previous prices (for example during the last few months or weeks) for example for changes in the price range and/or for example for any specific shop which has the item, which later shows up in the detailed results (so that not only the current price for that item in that shop is shown but also a graph of recent price history for that item in that shop). Another possible variation is to take into account for example also some ranking factor of the sources, so that for example Online stores that are much bigger or more important can be given higher weight. Another improvement is such meta search features is that for example when displaying automatically generated news the user can preferably define the desired time span to cover (for example only the last N hours or N days, etc.), and/or for example the user can mark certain news items or clusters or sub-clusters as no longer interesting. This is very important since otherwise for example automatically generated news items such as for example in the Sci/Tech section in the Google News, can remain almost the same for many hours or even a few days, and thus the user misses other items (of course, as explained in the above applications, preferably the user can continue to browse for additional automatically generated news clusters, preferably until the clusters become too small, but still this can save unnecessary distractions by skipping clusters which the user has already seen and is not interested to continue seeing new items about them). Another possible variation is that the user is notified automatically (for example by email or instant message or SMS, etc.) when a sufficient number of new clusters has become available and/or when a sufficient number of new items has become available in existing clusters which the user has not requested to remove, etc. Another possible variation is that for example when sorting automatically generated news clusters the number of items in each cluster is normalized by the time factor, since clusters that have exited for a longer time (for example a few days) would normally have more items than a newer cluster (which has exited for example for 1 hour), even if the new cluster is more important, etc. Another possible variation is that preferably the user can also, preferably easily, review also historically the automatically generated items that were on the automatic newspaper (for example in the Science/Tech section or any other section) for example a few hours ago, a few days ago, a few weeks ago, or more. Preferably the user can specify for example the time in hours and/or days to jump back (or for example once the jump size has been defined each next jump is automatically of the same size), or the user specifies for example a specific date and/or time which he/she wishes to view, and/or for example the user can press some link which automatically takes him back at each step for example automatically for a variable time period—determined for example automatically according the amount of change (for example the amount of change in clusters and/or within them). For this preferably the MetaNews service preferably automatically keeps a history of the links for example with certain time jumps (such as for example every hour, or any other reasonable time gap) and/or for example every time a sufficient number of items have changed within clusters and/or clusters have changed, etc. Another possible variation is that, for example when displaying the automatically generated newspaper or the results of a new search, the results can preferably be displayed also for example by a combined sort that combines for example relevance or importance with time, so that for example the clusters and/or sub-clusters and/or items are sorted by a score which is based on a formula that is affected both by time and by relevance and/or importance. Another possible variation is that for example in normal web searches and/or for example in searching the dictionary and/or the thesaurus for example in the word processor the user can search for example for synonyms of words with a specific pattern or length, or for the word itself when partial data exists (which can be very useful for example for solving cross-word-puzzles), so that for example the user can use for example question marks (or any other convenient designation) to designate unknown characters. So for example if the user is looking for a Greek island which is 6 letters long and starts with “ba”, he/she can for example search for ‘ba???? Greek island’, or for example if the user searches for example for a synonym of the word satisfaction with 11 letters he/she can for example type ‘synonym(satisfaction)???????????’ or for example ‘synonym(satisfaction,11)’, etc. Another possible variation is that the user can for example use wild cards in domain names, for example in the location window of the browser or in the search engine's search line, so that for example the user can type in the search line ‘http://coca*annual sales’ in order to get results only from world-wide sites that belong to coca-cola, or for example ‘population growth statistics http://*.gov’ to get results only from official government sites, etc. Another possible variation is that the user can for example use various pattern marks when looking for general information, so that the user can for example type in the search engine, “distance from [1] earth to [1] moon is %N% Kilometers”, which means that for example up to 1 word can be between the words “from” and “earth” and between the words “to” and “moon” and a number is expected before the word kilometers, etc. (Of course this is just an example an many other notations for the number of allowed words in between). (Although Altavista for example allows using the NEAR qualifier, it is more preferable to allow the user to limit the exact number of in-between words allowed). (Although for example Google already allows the user to achieve a similar effect by including a range of numbers, for example 2 . . . 40, in the search line, preferably the user can also enter a general number indicator without having to waste time thinking of an appropriate range). Another possible variation is that the user can add for example a tag that causes the results to be sorted according to this number (or numbers, if more than one number pattern is specified) (so for example the search string can be: DVD “Koi Mil Gaya” $%N%<lowest>cart) (or for example indicate this by any other way), so that for example all the sites that contain the desired keywords and the number are automatically sorted is the search results by this number in descending or descending order, as determined by the user, or for example the sorting is only among sites which are sufficiently highly ranking according to other criteria (preferably this is also determined by the user, but sorting on the entire set of appropriate results is more preferable since it can give better answers). This is somewhat similar to using shopping metasearch, except that this gives the user much more flexibility in using such sorting for almost anything, so it can cover much more possibilities than normal shopping metasreach. Another possible variation is that the user can for example tell the search engine to search for words that belong to the same item instead of just appearing together on the same page, so that for example when the users types ‘<group>all in one color laser printer fax scanner’ (or with any other suitable code) the search engine preferably returns only pages where these words appear near a single item (for example identified by paragraph or by smart heuristics that identify items or for example simply by being within the same sentence or for example group of 1-4 sentences, etc.). In a way this is similar to the use of the ‘NEAR’ code word, except that it applies to a group of words and preferably smarter heuristics are used as explained above and not just distance in words. Another possible variation is that instead of using ‘or’ and brackets the user can for example use ‘/’ do designate ‘or’ for a single word, which is much faster and more intuitive, so that the user can for example type at the end of the above query Kilometers/miles. This can work even better for example if synonyms are also automatically activated or offered (for example in the form ‘did you mean “Morning after pill”?’ if the user searched for “day after pill”, or by automatically including also the results with at least the close synonyms), as explained for example in other applications by the present inventor. Preferably the search engine can know synonyms for example at least from various thesauruses and preferably also through automatic learning, for example based on various patterns and/or statistics (such as for example similar patterns or word combinations that appear in pages that are close on the recursive clustering analysis, wherein the clustering is based for example on keyword analysis and/or at least partial semantic analysis and/or incoming and/or outgoing links analysis. For example there are 1940 pages with the words “day after pill” and 128,000 pages with the words “morning after pill” and even 1150 pages which contain both phrases, so even without the 1150 pages the search engine can preferably understand that these two phrases are used very similarly on pages which are close on the recursive clustering and therefore are probably synonym phrases, eventhough “day” and “morning” are not normally defined as synonyms) and/or semantic understanding of pages where relevant definitions or connections are used (for example at least in some of the 1150 pages where both phrases are used it is clearly indicated that these two phrases designate the same thing). (For example when searching for various devices or components in electronics even professional users many times have trouble finding the desired items because they are referred to by different names or different terms in different places, so preferably the search engine can for example automatically deduce the connection between the different names while spidering the web, for example based on various patterns or statistics or for example by semantically understanding references or definitions that directly link two or more names at some of the pages, etc.). Another possible variation is that for example when requesting News alerts, instead of being able to request only by specific keywords (as it is for example in prior art Google News), preferably the user can for example mark a cluster or a specific sub-cluster, so that he/she is notified automatically on any new items that belong to that cluster (as explained above), or for example the user can use semantic qualifiers or for example mark words in brackets, so that for example he/she will be notified also about items that contain synonyms of these words, etc. Another possible variation is that when the search engine for example displays advertisements in addition to search results, based on the keywords which the user used, preferably the choice of appropriate advertisements takes into account not just the keywords themselves but also semantic and/or context related information. This can be done for example by taking into account the order of the keywords which the user used on the search and looking for example for qualifiers, such as for example “all”, “not”, “most”, etc. However such words are rarely used in keyword searches so this would be hardly useful. A better variation is to determine the semantic meaning and/or the context based on the search results which the user clicks on (which is especially useful if the results themselves are automatically displayed in the form of recursive clustering), so that for example the advertisements are updated accordingly when the user requests the next page of results or repeats the search with similar keywords. Another possible variation is that the advertisements can be dynamically updated also on the same results page which the user already has, so that for example while the user opens new windows for some of the links and explores them, the original page is already updated based on the links which the user clicked on, for example by setting automatic refresh to every 30 seconds (or any other convenient time). Another possible variation is that in order to save bandwidth for example the html protocol is changed so that it is possible to define for example “refresh on a need basis”, which means that the refresh command is initiated automatically by the site when there is any change in the preferably dynamic page (so that the browser can get a refresh even if it didn't ask for it), or for example the browser asks for refresh more often (for example every 20 seconds or even less), but if nothing has changed then the browser gets just for example a code that tells it to keep the current page or window as is. The first of these two variations is more preferable since it saves also the waste of bandwidth by unnecessary refresh requests by the browsers. In addition, when the refresh is sent, preferably it can be a smart refresh, which tells the browser preferably only what to change on the page instead of having to send the entire page again. Another possible variation is to implement this “refresh on need” for example by active X and/or Java and/or Javascript and/or some plug-in or other dynamic code that is updated only when there is a need for it. Another possible variation is for example to keep the page or part of it open like a streaming audio or video so that the browser always waits for new input but preferably knows how to use the new input for updating the page without having to get the whole page again and preferably doesn't have to do anything until the new input arrives. Of course, various combinations of the above and other variations can also be used. Of course, like other features of this invention, these features can be used also independently of any other features of this invention.

Another possible variation is that preferably the search engine can also use preferably various heuristics for determining the information value of the search results, which can be used for example for improving the raking of web pages according to their information value and/or for example indicating near each link its information value (for example as a single score and/or as a list of scores and/or sub-scores). The information value scores can be defined for example according to authoritativeness (for example a scientific journal article versus a blog page), truthfulness, objectivity, accuracy, etc. Preferably the search engine can determine for example if a web page is probably more scientific for example according to for example diagnosing automatically whether it contains references and/or how many references and/or how scientific are the sources that are included there, and/or for example lexical and/or semantic analysis of the details about the author if such details exist, such as for example if he/she has a PhD. title and/or has a background relevant to the field that the article deals with (for example the writer has a degree in nutrition in an article about the dangers of eating Soy products), and/or for example link structure (incoming and/or outgoing) that indicate that the page (and/or the site in general, i.e. for example the entire domain or for example subdirectories in it) has links to and/or from other pages (and/or sites or for example subdirectories in it) which are considered more scientific by the system (for example in terms of percent of scientific incoming and/or outgoing links and/or in terms of absolute incoming and/or outgoing links). This can be done for example preferably in a way similar to the way that Google uses recursively the number of incoming and outgoing links to determine the authoritativeness of pages and/or sites (where authoritativeness is actually defined by popularity), except that in this case preferably the recursion uses as criteria also for example various indications about the scientific value of the pages and/or sites and/or sub-areas in the sites, etc. Determining the initial indications can be for example according to various heuristics based on the content of the pages (for example as in the above examples), and/or for example additional indicators, such as for example starting out with known scientifically accredited sources, etc. (However, these indicators are preferably reassessed automatically again for each page and/or domain and/or directory tree or sub-tree, in order to avoid degradation of the information value score or scores as the recursion continues). Preferably the taking into account of the information value can be for example applied automatically as an improvement of the results ranking algorithm and/or for example the user can indicate that he/she prefers to take this into account, for example by marking default preferences (which are preferably saved the next time he/she uses the search engine) and/or for example by adding some special keyword or mark to the search string, and/or for example the search engine has a few search windows, so that one or more are defined in advance for searches for more official and/or authoritative information, etc., and/or for example the search engine can preferably decide automatically how much weight to give to the information value of the results according to the search string itself, so that for example if the user enters a search string such as ‘blond huge boobs’ then he/she is probably not looking for scientific articles in this search. However, since it is obviously difficult to know if the user is for example searching for articles about cars or sites that sell cars (for example with a search string like ‘best price performance cars’), the above described solutions of using semantic qualifiers, such as for example ‘best price performance cars (shops that sell)’ when looking for shops and for example ‘best price performance cars (articles/reviews)’ is more preferable, and preferably the search engine can use any of the above methods for responding to such a query (such as for example synonyms, semantic trees and/or taxonomies, semantic tags, etc.). Of course, various combinations of the above and other variations can also be used. Of course, like other features of this invention, these features can be used also independently of any other features of this invention.

Another preferable variation is that for example the system includes a firewall which allows giving specific applications differently rights for downloading and/or uploading information for example to or from the Internet (and/or for example through all available communication channels or through specific communication channels, such as for example network cards, USB, wireless, modem, etc), in contrast to prior art firewalls which only allow users for example to let applications access the Internet, but the user has no knowledge for example if an application that has been allowed to access the Internet is uploading or downloading information, etc. This is very important since for example the user might want to allow a program such as Winamp to access the internet for example in order to play streaming data but does not want Winamp to be able for example to upload information, or for example the user might want Word or for example some other word processor to be able to access web pages but does not want the word processor to be able to upload document files (for example even if they are in its own directory and/or even if it is the current file which the user is working on), so that for example if an application is actually a Trojan horse that tries to steal data or for example the application is compromised for example by some buffer overflow, it will not be allowed to do that. This can be done for example by automatically showing the user the statistics of sending/receiving information near each application that has been allowed to access the Internet (for example is some table) and/or for example defining a maximum ratio between upstream and downstream for each application (which is then preferably enforced automatically for example by automatically blocking excess uploading and/or warning the user and/or asking for his/her authorization) and/or for example defining a maximum absolute amount of information that can be sent out per time (which can be for example enforced similarly). However, such definitions are limited in effectiveness, since a sophisticated hostile application can for example slowly steal important data over time even within the limitation and/or for example various applications might cease to function properly because of these limitation. For example, enforcing such separation between uploading and downloading is not easy since even programs that download data typically have to also send some information in order to establish the communication, however allowing for example automatically a reasonable required ratio between the two directions can solve this problem and this can be quite effective for detecting theft of data, since if a program for example is allowed to upload only for example ¼ or 1/10 or less of what it downloads then trying to steal for example a large file will also require the application to download even more data and the user can easily see for example that the application had no reason for downloading it (and this is only if the Trojan knows for example about the limitation and tries to cheat its way out of it by downloading extra data, otherwise it will simply be blocked because it would try to send much more data than it receives). Another possible variation is for example monitoring the data in the incoming and/or outgoing packets, but even this can be limited in value since for example a hostile application might encrypt the data and/or for example disguise one protocol within a seemingly different protocol, etc. Another possible variation is that for example programs that the user wants to allow only to download data but not upload data are automatically prevented from any real access to the web and for example the OS and/or the firewall and/or the security system intercept any attempt that these application make to contact the web and send the requests instead, and so for example only valid normal protocol requests for example for accessing web pages and/or for downloading data, etc., which are recognized by the firewall or other intermediate agent are allowed to go through (and this means of course that the firewall or other agent preferably has in this case to monitor the entire incoming and outgoing protocol of that application in order to be able to understand fully what is oing on and interfere when needed. Preferably the firewall or other agent for example cal also notice other suspect behaviors, such as for example requesting a web page with an unreasonable large parameters line for example after a “?” in a url (for example ‘http://abc.com/test?asdo+32892323+8238023803+wqwqdpq?ideeww . . . ’), since such addresses can also be used for example for connecting to a hacker's site (phoning ‘home’) and stealing the data in disguise of the url's parameters, or for example frequent repeated similar connections for example with shorter parameter lines that keep changing (in case the data theft is in smaller stages, etc.). In addition, preferably the firewall (and/or the Security system and/or the OS) for example can also indicate to the user automatically when some application (for example that has been allowed to access the web) is trying to download a file (so that for example the user can be alerted if such activity is happening without his requesting it—preferably together with indication of the full path and the file name that is being downloaded), or for example the user is warned for example only if an apparently executable file is being downloaded. Preferably the firewall (or other agent) can determine if it is an executable for example not only by its extension but also by automatic inspection of its contents, since a hostile application might for example use a seemingly innocent extension and then for example rename it, etc. This can be very useful for example in cases of various browser exploits which cause the browser to download hostile executable code without the knowledge of the user. Another preferable improvement is that for example the firewall allows the user to change the permissions of multiple applications at the same time for example in the firewall's table, for example by marking entire columns or other areas and then changing automatically for example all the permissions in the marked areas, such as for example to allow/deny or ask, etc. Of course, various combinations of the above and other variations can also be used. Of course, like other features of this invention, these features can be used also independently of any other features of this invention.

Another preferable improvement is that the user can have for example two or more Operating systems running at the same time (for example Windows Me and windows XP or XP and Longhorn), so that the user can for example jump between them preferably instantly or almost instantly, for example by pressing some key or key combination or clicking ion some icon, instead of having to shut down Windows and reboot. This is preferably done for example by keeping a mirror image of the loaded and running OS (for example like in sleep mode, which means that while the user is in one OS the other OS is dormant or simply the user can switch between the OS's after entering sleep mode), or for example by having preferably separate swap files so that both Operating systems can be actually running at the same time—which means that preferably one or more additional OS elements are operating below the two (or more) Operating Systems and are in charge of the resource sharing between them. However preferably in this mode for example certain functions are automatically disabled or are available to only one OS (for example by choice of the user and/or by automatic choices), for example when there are problems of allowing two or more separate processes to access the same hardware at the same time. Although there are for example systems that allow the user to run a window of another OS by emulation, this is much more efficient.

Another possible variation is to add to the computer various sensors that can automatically monitor the condition of the user, for example by various biometrics, such as for example sensing the user's heartbeat and/or respiration (for example by a special remote microphone), skin temperature (for example through sensors in the keyboard and/or mouse) etc., so that for example if the system senses a serious problem preferably the OS or a special application can for example warn the user and/or for example call directly one or more emergency number and request assistance for the user, for example through synthesized speech or SMS or for example use Instant Messaging. Another possible variation is that this sensing is not limited to when the user is sitting near the computer, so that for example there are various additional sensors for example in the room or in the house or for example some sensors which are worn by the user (for example if the user is at known risk) and preferably connect automatically to the computer for example by UWB or Bluetooth or other short range wireless connection. Similar system can be very useful for example with various special sensors for example in trains or in cars, since for example if the train's driver has a heart attack and does not press the breaks before collapsing it can cause a dangerous accident. So preferably the driver's cabinet contains various biometric sensors which can work for example as described above, and/or for example additional sensors such as for example sensors in the seat or on various elements which the driver is supposed to interact with, and preferably he train's computer has also sensors (such as for example radar and/or ultrasound and/or video cameras) which can sense when for example if the train is moving too fast toward a too near obstacle and then for example can preferably apply the brakes automatically and/or sound a warning. Although there are for example some trains which contain a ‘deadman switch’ which means that for example every 30-60 seconds the system indicates a sound and/or light and the driver has to press some switch to show that he/she is still alive and if he fails to press it a stronger warning is indicated and if he still fails to press it the train automatically stops, an automatic sensing system as described above is better since it can be much more convenient to the driver at it can preferably sense problems immediately without having to wait for the next activation. Another possible variation is that the system includes for example also one or more video cameras that constantly monitor the driver's cart and for example the computer's system can automatically analyze for example un-normal positions of the driver and/or for example the image is broadcast automatically for example every few seconds to various ground stations. Similar sensors can be used for example in cars, so that for example if the computerized system senses that something is wrong with the driver (for example the driver has fallen asleep or is not feeling well, which in the case of a car can also be based for example on sensing erratic behavior of controlling the car—for example erratic movements which seem to ignore the track) it can for example try to alert the driver by sound and/or for example jolting or rocking the driver's seat, and/or for example can apply an automatic system which can preferably sense the contours of the road and/or the white lines and/or the position on the road and/or the surrounding vehicles and/or other objects and can preferably automatically slow down and move the car sideways and come to a safe automatic stop on the margins of the road and/or for example issue an automatic call to emergency services. Similarly, preferably the car alarm is improved so that if the car is being stolen, preferably the alarm system automatically broadcasts a distress signal (preferably secretly), preferably through a hidden cellular device, and preferably indicates the position of the car for example according to GPS and/or for example according to the nearest cell positions in the cellular system. Another possible variation is that for example the car's system can automatically broadcast for example to parents of their son or daughter drive carelessly (for example too fast, or with too sharp turns and/or other indicators of dangerous driving which can preferably be automatically measured by the car itself)(Although there are systems today where other drivers are asked to report this to the parents, it is much more preferable that the car's computerized system can report it directly by itself, preferably through the same cellular system that can be used also by the automatic alarm for example if the car is being stolen. In airplanes for example a similar system can preferably also sense for example if the plane has been hijacked, for example by sensing that the biometrics of the pilot indicate a different pilot (for example by automatic fingerprint readers in at least some of the controls which the pilot has to touch and/or for example automatic iris readers in the pilot's helmet) and/or sensing that unauthorized persons are in the cockpit (for example by sensing one or more people standing or sitting in a suspicious position for example for more than a limited period) and then for example the system can automatically send a wireless warning to various ground stations (and preferably also for example automatically open one or more microphones and/or video cameras which automatically broadcast what is going on in the cockpit and/or for example the microphones and/or video cameras normally broadcast the situation automatically every once in a while to one or more ground stations even when no special event is detected) and/or for example to security persons on the plane itself and/or for example the system can ask the pilot (preferably by a hidden method of for example displaying some digits which have a special meaning or for example flushing them. ,etc.) for identifying himself with a special code which only the legitimate pilot would know, and so for example if the hijacker is sitting in the seat instead of the pilot he would not know the correct response or even that he was asked to respond and if the pilot is still in the seat and the hijacker is standing next to him the hijacker preferably would not be able to see the signal (for example by using viewing angle which only the sitting pilot can see) or would not understand it and then the pilot can for example ignore it or enter a special code instead of his/her normal code that indicates that the plane has been hijacked and/or can convey other messages) and/or for example one or more controls in the cockpit can be used by the pilot to indicate various problems (which can preferably automatically activate for example automatic wireless warnings), for example by moving a lever into a special position which has no real mechanical function but is used in that position to activate automatic warnings, etc. In addition, in cockpits preferably the computerized system preferably has also means for automatically disabling hijackers, such as for example shooting tranquilizer arrows or needles (or for example electric shocker needles) at anyone who is standing certain height and/or who is standing next to the pilot for more than a certain time limit and/or who is standing at an unauthorized position (for example automatically or for example upon a hidden command from the pilot or for example upon hidden wireless command by ground control, preferably with high encryption that makes sure that only authorized commands will go through) and/or for example at the person in the pilot's seat (for example if the system has determined that the pilot is not legitimate) (and/or for example automatically electrically shocking the illegitimate person and the pilot's seat) and/or for example releasing a preferably odorless gas, preferably together with automatically activating an automatic pilot and/or for example activating a special mode which takes navigation commands from the secure wireless channel. In addition, preferably the cockpit is protected by a system of at least two preferably fortified preferably closed automatic doors, so that any person entering or leaving must first pass one door, then close it and then pass the other door, since in the prior art cockpits are either not protected by a fortified door or are protected by only a single fortified door, which is still not safe enough because a hijacker can for example run in when the door opens for the pilot to go to the toilet for example. If the passage near the cockpit is too small for adding normally the second fortified door then preferably one of the doors can be for example based on a rotating part-circle, or for example the two doors are connected with s foldable sleeve (for example like an accordion) which is pulled out only when someone has to pass through the two-door system.

Another problem is that for example in laptops typically the hard disk is significantly slower than in non-mobile computers, in order to save power and extend the number of hours until the batteries run out of power, which causes many programs to load considerably more slowly and to work slower when saving or reading files. However this creates the absurd situation that even though the laptop might be used most of the time on a desk, connected to the wall electricity outlet, than on the road, the disk still works at the low speed all the time. So this is preferably solved by using a variable-speed hard disk which can automatically work significantly faster when the laptop is connected to the network electricity. So preferably the computer and/or the OS and/or the disk itself can automatically increase or decrease the speed of the hard disk according to sensing if the computer is currently connected to the network electricity or is currently running on the batteries. In addition, preferably the user can also for example press some button or request the OS to increase temporarily the disk's speed to the fast mode even when not connected to the external electricity (for example if the user needs something done fast, and then preferably the disk for example automatically reverts back to the slow speed for example after 5 or 10 minutes or any other convenient time, and/or for example according to the amount of power left and/or the current processes running). Similarly, preferably when the portable computer is connected to the wall preferably the hardware and/or the OS can also for example automatically increase the speed of the CPU so that it consumes more power and works faster (and/or the user can for example request it explicitly for example for a short time even when the portable is not connected to the electrical outlet) and/or for example automatically (and/or by temporary user request) increase the brightness of the screen, and/or for example increase the speed and/or power consumption of other elements. In case the user requests the increase in disk speed and/or the other increases in power consumption explicitly while the computer is working on batteries, preferably the system resorts automatically to normal power consumption for example after a specific task is completed and/or for example after a certain time period (which can be for example set automatically or by the user). However, there is a problem that if the disk's engine is optimized to work efficiently when the power is on, it might work considerably inefficiently when running on the batteries, and if it optimized to run at high efficiency when running on the batteries it will not run efficiently when running for example in double speed when connected to the wall, thus increasing even further the heat dispersion problem in the laptop. In order to solve this, preferably the disk has at least two sets of engines or at least two sets of coils, which are used for example at different combinations in order to work in the low speed or in the fast speed (or other speeds if more than two speeds are available). In addition, preferably the disk's DSP automatically starts working for example at higher MHz when the wall power is sensed and/or for example more than one DSP can be used in order to speed up the processing. Another possible variation is using for example a disk with more heads on the same arm (which is typically moved in rotational movement part of a circle from the side, in a way similar to a phonograph's needle, typically by a voice coil), so that for example less movement is sufficient to cover the entire range. Although this means also having to move more mass, the arm is typically much more massive then its tip with the head, so adding one or more additional heads that point for example sideways, as shown in FIG. 5a below, will not change much. Another possible variation is adding also for example additional heads, so that for example there are more heads at the length of the arm, however that could create a linearity problem. Other possible improvements that should enable faster disks with very little energy increase or even a reduction in energy consumption are shown in FIGS. 5b-c. Another possible variation is to use for example instead of moving heads some elongated multi-head structure which does not have to move at all, so that preferably the point of reading is chosen electronically, for example by varying the position of some crossing point electronically. (Such a solution of course could make also normal hard disks work considerably faster). Another possible variation is to use even more than two speeds or modes. Another possible variation is that for example the user can choose in advance when buying the laptop if he prefers to get the laptop with a faster speed hard disk (for example a double-speed hard disk that will cause the battery power to run out for example after 2 hours), or a slow speed typical laptop hard disk which is for example twice slower but allows the battery with average usage to last for example for 3 hours). The heat dissipation problem with the faster disk is preferably solved for example by activating automatically for example an additional fan when the disk works at the higher speed, and/or adding for example additional heat conductors between the internals of the laptop to its outer shell. Of course, various combinations of the above and other variations can also be used. Of course, like other features of this invention, these features can be used also independently of any other features of this invention.

Another issue that has to do with the reliability issue is the fact that when people use Windows for example from an Internet Cafe, many times they forget to close down open connections and/or at least they leave behind traces such as for example various cookie files, temporary files, history logs, etc. There have already been cases that users who subsequently used the same computer misused this for example to send a false suicide note or to send a false kidnapping message, etc. Although some web based email sites, such as for example Hotmail and Yahoo, allow the user to mark when he/she is using a public computer, this relies on the user marking it and is anyway just a limited solution. Therefore, preferably the OS itself, preferably during installation, enables the administrator to specify that this is a public-use computer, and preferably this setting can be changed only for example with the original installation disk and/or with a password. Preferably when defined as a public computer, the OS itself indicates this in outgoing electronic communications such as for example emails, for example by adding this info at the socket layer, and preferably any session-related traces are automatically removed by the system for example after a short time of inactivity and/or if the user does not re-enter a password chosen by the original person that started the session, or for example such traces are not saved at all. Another possible variation is that in addition, for example the OS allows the user to send additional email messages from the same session only if he know the password entered or chosen by the user when he started the session, etc.

### BRIEF DESCRIPTION OF THE DRAWINGS

FIG. 1 is a flow chart of a preferable way the Instant Reset and Instant boot are implemented.

FIG. 2 is an illustration of a preferable example of using a separate area with separate heads on the disk or other non-volatile memory for running a hardware supported rollback feature.

FIG. 3 is an illustration of a preferable example of using a separate area with separate heads on the disk or other non-volatile memory for running one or more hardware supported FAT areas.

FIG. 4 is an example of one of the best MIDI search engine's results (prior art).

FIGS. 5a-c are illustrations of a few preferable configurations that can considerably increase the speed of the hard disk, and preferably also reduce its power consumption.

FIG. 6 is an example of multiple checkboxes that can be marked or unmarked by the user.

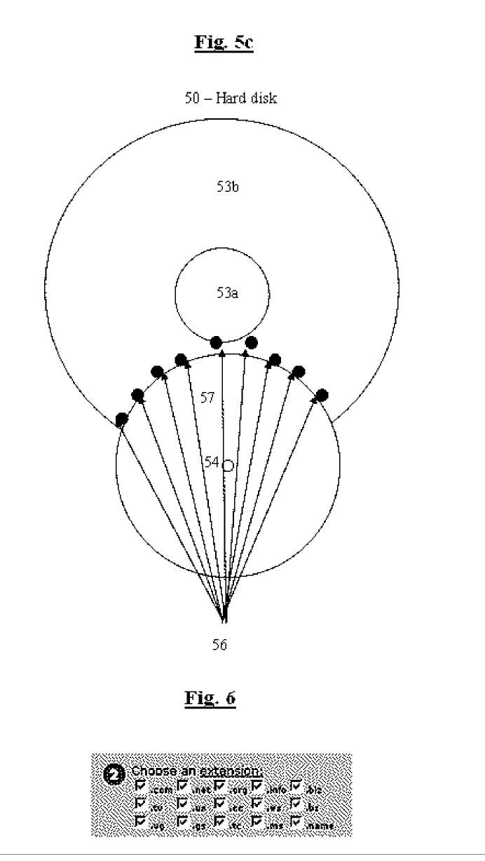

FIG. 7 is an illustration of an improved computer case in which at least the area that supports the external CD and/or DVD drives is preferably rotate-able between two positions, so that the same case can be used either as a desktop case or as a tower case.

### IMPORTANT CLARIFICATION AND GLOSSARY

All these drawings are just or exemplary drawings. They should not be interpreted as literal positioning, shapes, angles, or sizes of the various elements. Throughout the patent whenever variations or various solutions or improvements are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. Eventhough the preferred embodiments use mainly the terminology of Microsoft Windows, which is the most common and familiar operating system, the current invention can be used also in other operating systems, such as for example Linux, Macintosh, or other operating systems, even if they use different terminologies or different implementations of various features. “OS” as used throughout the patent, including the claims, means Operating System. FAT is short for File Allocation Table. However, as used throughout the patent, including the claims, FAT can mean also any other central data structure related to file allocation or management. “Scandisk” is the typical software used in Microsoft Windows to scan the disk. On normal runs it is used mainly to find inconsistencies between actual file sizes and the sizes reported in the FAT, but it can be used also for example for thorough scan to check for bad sectors, etc. As used throughout the patent, including the claims, “Scandisk” means either Scandisk, or any other similar software for checking the Integrity of the file or directory structures. “Image”, as used throughout the patent, including the claims, means a non-volatile memory Image of the OS state and preferably also loaded programs, loaded drivers, memory status, status of peripheral devices, and/or any other data that is needed for creating a sufficient snapshot of the computer's condition, so that the computer can be instantly restored to that state and operate properly by restoring or using the data from said Image. Throughout the patent, including the claims, whenever “disk” or “disks” is mentioned, it can be either a hard disk or hard disks, or any other type of fast access not-volatile memory, such as for example MRAM (Magnetic RAM), 3d Nano-memory chips, etc., and whenever heads are mentioned, it can be either read/write heads of disks, or any access mechanism for areas in other types of non-volatile memory, including when such access means do not require actual physical movement by a mechanical element.

### DETAILED DESCRIPTION OF THE PREFERRED EMBODIMENTS

All of descriptions in this and other sections are intended to be illustrative examples and not limiting.

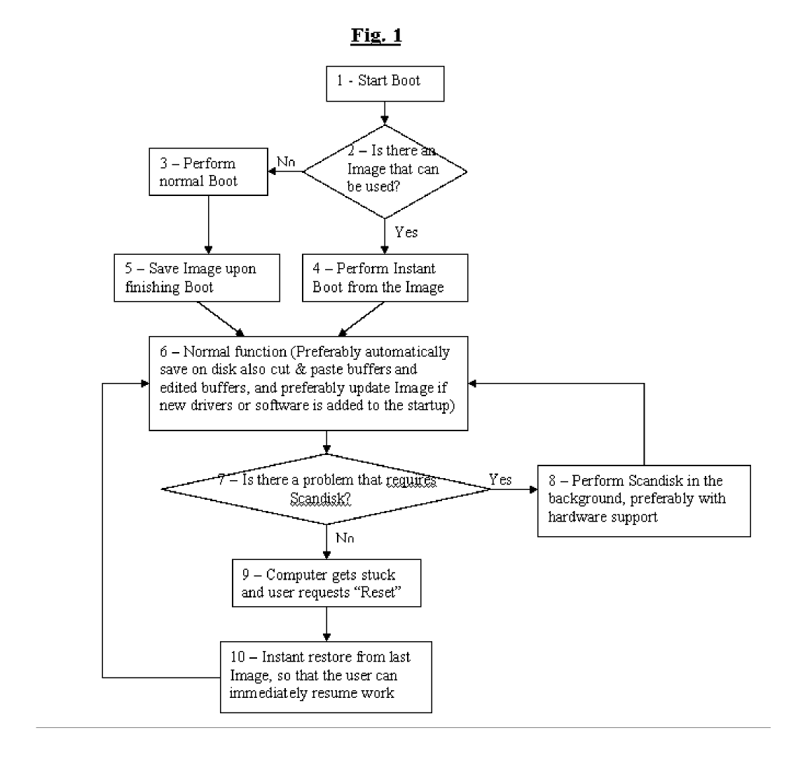

Referring to FIG. 1, I show a flow chart of a preferable way the Instant Reset and Instant boot are implemented. When a boot sequence starts (1), preferably the system checks if there is an Image that can be used for instant boot (2), and, if so, performs instant boot by loading the Image into memory (4), otherwise it performs normal boot (3) and preferably saves the OS Image upon finishing the boot. The OS Image preferably contains also all needed info about loaded drivers and/or other loaded software and preferably also for example about the state of peripheral devices, and/or any other data that is needed for creating a sufficient snapshot of the computer's condition, so that the computer can be instantly restored to that state and operate properly by restoring or using the data from said Image.

Regarding the state of the peripheral devices and resetting them, it can be handled for example in at least one of the following ways:

Preferably peripheral devices can be preferably instantly reset to their original status as it would exist after a normal boot, preferably for example by improving the standard protocol of drivers so that preferably each driver and device has a function for instant reset. Another possible variation is that preferably each device driver can preferably instantly query the device to see if it is in a proper state or needs to be reset.

Preferably the system constantly updates some area in non-volatile memory or for example some buffer or stack with the current state of the devices, so that it can be preferably instantly determined if any of the devices was involved for example in a crash or needs reset.

Preferably at least one or more of the devices can be kept in its current state if the user so desires instead of resetting, so that for example if the user was in the middle of an Internet connection, the user can for example remain connected without having to reset the modem or Ethernet card and reconnect. Preferably during or after the reset the system asks the user if he wants various devices to remain in their previous states or for example it is defined as default before any reset is needed and the user can change it, and during the reset the system decides what do to with such devices according to the last given instructions. As in clause 2 above, preferably this is done by automatically saving the current state of the devices in a buffer or stack.

If any tests or resets are still needed in one or more devices which cannot be done instantly, preferably the system can automatically decide which devices are not critical and can therefore be dealt with in the background after the user can already start working, in a way similar to postponing the disks scan, so that for example if it takes some time to check a CD device, preferably this is done after the user can already start working, since the user typically will not need to access the CD immediately. This option can be preferably used also in normal boots or instant boots or when restoring from hibernate.

Preferably when a Reset or an instant boot is performed, the image is first reloaded into memory including all the drivers as if they have already checked and/or reset the relevant devices, and THEN the drivers are instructed to activate the instant actual reset on the actual devices, so that the state of the device conforms to the state that the driver is supposed to represent.

Preferably the data on the status of any peripheral devices that can be saved in the image includes also any plug and play data for such devices and/or for any other card or relevant elements in the computer, so that preferably no plug and play automatic tests are normally needed during booting. Preferably at least during any boot or reset that is not based on turning off and turning on again the computer (cold boot) there is no need for any plug and play check for example at least of installed cards since the devices and cards that are coupled to the mainboard do not change, so preferably the system can automatically identify if it is being reset or rebooted without a cold boot, and if so, it preferably simply uses automatically the plug-and-play solution or configuration that was used last time as saved in the image. However the user might for example remove the keyboard or the mouse or a printer cable even without turning off the computer, so preferably the system checks if such devices have changed. Another possible variation is that even if a cold-boot is done, preferably the system can check instantly if the configuration of devices and/or cards and/or other relevant elements has changed or is the same as the last image, and thus avoid for example any unnecessary plug-and-play checks and instantly choose the configuration used last time, preferably as saved in the image, if the configuration has not changed.

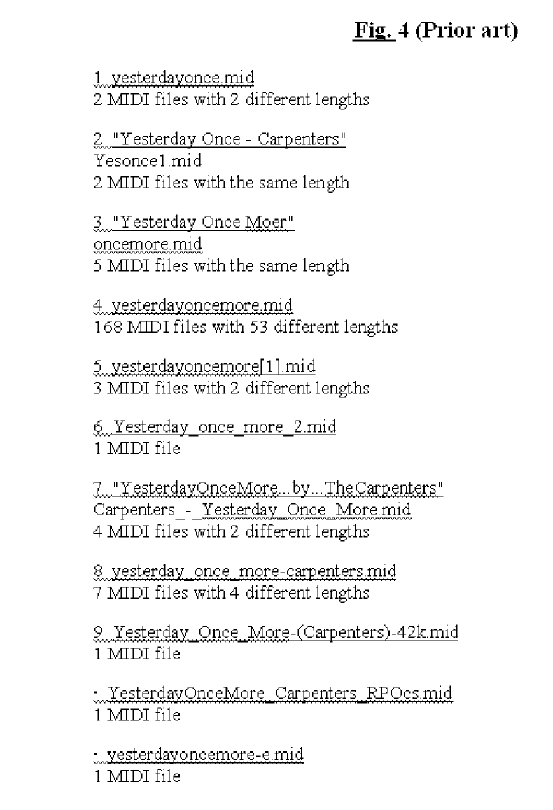

The Image is preferably saved on the disk or other non-volatile memory with at least some preferably fast compression that allows faster transfer of the data to and from the disk. The system then preferably allows the user to start working immediately (6), and preferably immediately afterwards checks if there is a problem that requires Scandisk (7). If there is such a problem, then preferably Scandisk is performed at the background without interrupting the user's work (8), preferably with hardware support that enables it to finish even much faster, as explained in the reference to FIG. 3. Preferably the system allows a “Reset” function, which means that whenever the system gets stuck (9), preferably the user is able to press some special button or some key or keys on the keyboard in a way that causes the computer's memory to instantly Reset from the saved Image, without a need to go through a boot sequence at all (10). The special button or key is preferably sensed either by hardware or by some process which preferably runs below the Operating system and thus in not affected even when the system becomes stuck. After activating the Reset (10), preferably the system again checks if there is a problem that requires Scandisk (7), and, if so, preferably performs it again in the background as explained above (8). In addition, during normal operation, preferably any cut & paste buffers are automatically saved also on the disk or other non-volatile memory, so that they can be immediately available on the next boot or after the next Reset. Similarly, preferably any currently edited files or windows are preferably automatically saved on the disk or other non-volatile memory preferably after sufficient minimal changes have accumulated (such as for example after at least 10 new characters have been added or changed) or every short while (for example every 30 seconds), so that they can be immediately available on the next boot or after the next Reset. Although something like this exists for example in Word, it is not available in many other programs, so preferably this is ensured by the OS itself. Preferably the System allows also “undo” in case the “Reset” button or command was pressed by accident, for example by saving an additional Image of the OS and of open windows/applications before restoring the boot Image. Of course, preferably any of the above principles or variations can be used also during recovery from hibernate and/or during any boot or instant boot, such as for example the instant boot described by IBM, since in these processes too reducing any waste of time on dealing with the peripheral devices and/or any waste of time for scandisk, can allow the user to be able to start working much sooner. However, there is of course a difference between instant boot or reset and restoring from hibernate, since in the instant boot or reset the drivers have to typically be reset to the initial state after boot, whereas when restoring from hibernate they have to typically be restored to their exact state at the time of requesting the hibernate. Another possible variation is that for example when restoring from hibernate or from Reset, the system can also automatically for example continue printing from the point it stopped, for example by saving the relevant information about the process of printing and preferably being able to query the printer exactly where it stopped for example in terms of character and/or in terms of printed pages. Another possible variation is that the user can define or save for example the normal task bar itself or parts of it, so that for example upon any boot by default some Dos window will be open at a certain directory or for example Word will be open with a certain file, until changed by the user. Another possible variation is that the user can for example define group-icons, which means that a single icon can connect a number of icons so that when the user clicks on the group icon a number of applications will open automatically, with or without restoring also for example their exact arrangement of the desktop. This way for example if some users are used to work with Word on the left side of the screen and some excel table on the right side, then clicking on the group icon or saving this as boot default will automatically open the two or more applications in the correct configuration. Another possible variation is that preferably the last sleep mode that was used is by default not erased and the user is offered for example upon normal reboot as one of the options the possibility to return as if from the last sleep mode, except that some programs that were running then will not be restored (since if it is a normal reboot then these processed have already been closed). For this preferably the OS can for example add to the last sleep mode data for example upon normal shutting down and/or when specific processes have ended, the information that these processes are no longer relevant. Of course, various combinations of the above and other variations can also be used.

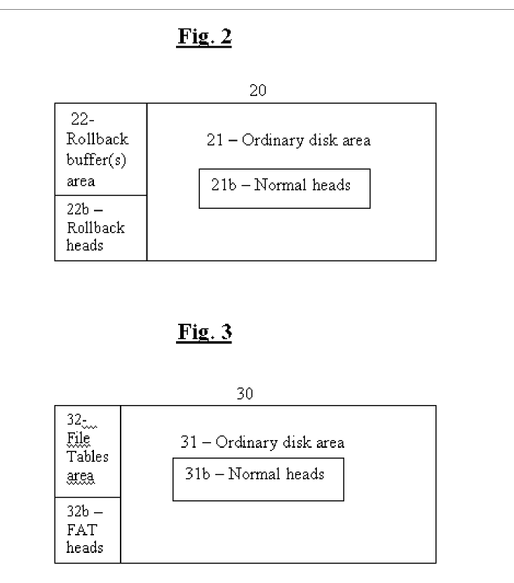

Referring to FIG. 2, 1 show a preferable variation where for example any changes at all that happen for example on the hard disk or other non-volatile preferably fast-access memory (20) (and possibly even on other connected writeable media, such as for example CD or DVD or other backup media) at any time are completely undo-able at least for a certain time period (or as long as there is sufficient room to save the info needed for the undo), in a way similar for example to the undo feature in a single Word document. If this is implemented also for example for other connected media, the rollback areas for them can be for example on those media and/or for example on a separate rollback area or areas or on part of the normal rollback area within the disk (or other fast non-volatile memory). This is preferably accomplished by keeping one or more rollback log, preferably backed up by appropriate hardware on the disk. The rollback can be enabled for example by creating a backup of each changed file or directory in another area at least for a certain time period or until for example the backup buffer becomes full and older backups have to be deleted automatically. Another possible variation, which saves much more space, is for example to keep a rollback log of all changes for example of directories, files, FAT areas, and/or any other data (such as for example even any low-level changes in disk tracks), so that any changes that were made on the storage media can be rolled back by simply tracing back the log of changes (this way only the changes have to be saved). Preferably this log or rollback buffer or buffers are encrypted and are highly guarded and/or are kept also in more than one place, in order to reduce the chance of its destruction by mistake or by some malicious software. This way even if the user has made a horrible mistake and the entire system has been compromised, even the worst damage can preferably still be automatically undone. Preferably the Operating System or a special Security System constantly guards itself and its files and preferably also these logs from any unauthorized changes. Another possible variation is that even commands such as for example format or re-partition or even low-level format are not able to destroy the rollback areas, so that for example at least a certain percent of the disk or other non-volatile memory is always reserved for the rollback info. Preferably the rollback logs or buffers or at least the most recent changes in them are always backed up in at least two or more separate places and/or also protected by additional encryption and/or redundancy data, so that damages can be fixed. Another possible variation is that the rollback feature is supported also by hardware, for example by a special area in the CPU or on the hard disk interface card, so that it is always available for example from a special ROM even if for example the system has been booted from another device, such as for example a diskette or CD or network drive. If it is an inherent part of the hard disk, this has the additional advantage that preferably at least part of the overhead of keeping the rollback files is run by special hardware for example on the hard disk's interface card, so that it does not burden the system or slow down disk operations. This can be done for example by keeping one or more additional read/write heads (22b) constantly near a special area of the disk (22) that is used for the rollback logs, so that accessing it for every disk change causes no additional access or seek activity of the normal read/write heads. Such an implementation can be also more secure since access to the rollback area can be limited for example on a hardware level, so that for example only an explicit command by the user entered directly by the user to the operating system through a direct command can restore changes from the rollback, so no malicious program can for example activate the command. Preferably when the user requests to restore things from the rollback, the following part of the rollback buffer is still kept, so that the user can for example also redo the “undo” by simply moving again forward on the rollback log, thus reinserting the cancelled changes. Preferably new changes to the rollback from that point on are kept on a separate part or buffer or branch, so that making additional changes from that point on will not overwrite the original “forward” part of the rollback, otherwise even changing one character after the undo can destroy the possibility of undoing the undo and returning to the original situation before the undo. (This is unlike for example the undo feature in Word, where undoing something and then adding new changes destroys the ability to go back to the situation before the undo). Preferably when going again forwards the user is shown the various branches that exist and can choose the appropriate one. Another possible variation is to add such features also for example to word processing programs, such as for example Word, so that there too the user can choose which Redo he wants if there are a number of possible branches to choose from. Another possible variation is to add to word processing programs such as for example Word also an option that if the user for example types something by mistake while “overwrite” is pressed when he actually intended to use normal insert mode (which can happen quite often) preferably the overwritten part is always saved automatically for example in some buffer and preferably the user can press some button (or for example a combination of two buttons) which instantly restores the lost text as if the mode has been “insert” instead of “overwrite” (this can be called for example “retroactively changing mode”), instead of having to use cut or copy to save the new part, than use undo, and then use paste again. Preferably the Undo in word processors such as for example Word is also improved so that even deleting the entire contents of the file and saving it is undoable, since in the prior art for example if the user by mistake presses “\hat{ }a” (which stands for “mark all the text”) instead of “\hat{ }s” (save) and then presses backspace to delete one or more characters and then for example presses “\hat{ }s” again, the entire contents of the file can be erased and then saved like this, and then the undo does not work, so the entire file can become lost. Another possible variation is that for example when using cut & paste if the user for example presses by mistake again “\hat{ }C” (copy) instead of \hat{ }v (paste) (for example over the section that was supposed to be written over)(which happens many times since these are adjacent keys on the keyboard), the new copied text normally overwrites the previous one in the copy buffer. So preferably the user can press some undo key which brings back the previous copy buffer. This can be easily implemented for example by saving the copy buffers automatically in some stack.

Since the area assigned for keeping the rollback logs is necessarily limited, preferably the rollback file or files use one or more circular buffers, so when it is full the oldest changes logged are deleted by overwriting them with the new data, and pointers to the logical beginning and end of each circular buffer are updated accordingly. If the rollback is hardware based, another possible variation is that since it can preferably work even below the operating system level, the rollback is based for example on low-level hard disk data, such as for example simply recording all changes in disk tracks or sectors, etc., so that it is independent of any file formats used by the operating system. However, this can be problematic since hard disks today typically have for example auto-moving of bad tracks to a hidden pool of “spare” tracks, so this is preferably taken into consideration. Another possible variation is that the lower level hardware is also aware of upper formats. The variations of using special hardware for example in the hard disk itself are more preferable since this is safer and faster, and can be also immune to changes done while the computer was booted from another source, unless for example a malicious software booted from another source makes on purpose so many changes that the rollback logs become overwritten. In order to prevent this, one possible variation is that for example if the hard disk senses that the boot was not made from it, it will block all further changes for example after the log file becomes too full (for example counting the cumulative amount of changes since the boot), and request the user to boot from the hard disk. Another possible variation is for example some combination between the OS and the hardware support, so that for example there are two types of low-level write commands, one with rollback enabled (for example called RWrite, for Rollback enabled Write, or for example called SafeWrite) and one without, so that for example the operating system decides to use the safe (rollback enabled) write automatically for example when allowing changes in highly strategic directories and/or files, such as for example system files, “.doc” files and program source files. Another possible variation is that for example the Operating System or the computer's security system decide when to use the rollback enabled write and when the normal write, and for example takes care that normal files or directories are changed with the safe write, but for example swap files and other temporary files are changed with the normal write, in order to avoid burdening the rollback buffer with unimportant changes. This is less safe than the variation where every change is logged on the rollback files but has the advantage that the rollback buffer is reserved for more important changes, so they can be kept for a longer time than if also less important changes are kept on the logs. Another possible variation is that for example normal programs can also choose to use it depending on the importance of the files. However, a malicious program might for example try to create on purpose so many changes as to fill the rollback circular buffer and make it lose more real changes. Therefore, such behavior is preferably intercepted by the Operating System or a special Security system as a highly suspicious behavior. Therefore, preferably for example only the security system and/or the operating system can have access to the saving or restoring from the rollback buffer. However, if every change in the disk is automatically saved in the rollback buffer, then still a malicious program might create endless changes on purpose, so preferably it is intercepted preferably after a short time as highly suspicious behavior. Another possible variation is that for example each program or each installation directory has by default only up to a certain percent of the rollback areas allocate to it, so that it cannot take up too much of the rollback resources unless given explicit permission by the user (in this case preferably each has its own rollback circular buffer). However, a hardware based general rollback feature also can have a serious drawback that changes for example in one important file can only be undone by undoing changes in the entire disk, so for example to fix a damage that was caused to that file two months ago the user would have to undo changes of two months in the entire disk, restore the file, and then restore back the last two months on the entire disks—a very dangerous activity if anything goes wrong during the process for some reason. Therefore, a more preferable variation is that the hardware supported rollback or undo can be used also for each file separately, for example by saving a separate rollback buffer or entry for each file, or for example each log entry contains also the name and full path of the relevant file (passed to it for example as a parameter during the write operation), so that the user can choose for example if to use an “undo” on the entire disk or only on a specific file or directory or group of files or group of directories. Preferably this path info changes only when the changes start referring to a separate file, so as long as the changes are in one file, no overhead of repeating the path is needed. Another possible variation is that for example the Security system and/or the operating system use the rollback log automatically for backing up any changes in highly strategic directories and/or files without hardware support. Of course, similar principles can be used also in other types of non-volatile memory that exist or will exist in the future, so that for example if some MRAM (Magnetic RAM) or 3D memory chips are used, preferably the rollback area or areas have independent access control for fast access without slowing down the normal access the actual data areas. These rollback features can be used also independently of any other features of this invention. Of course, various combinations of the above and other variations can also be used.

Referring to FIG. 3, 1 show an illustration of a preferable example of using a separate area or areas (32) with separate read-write heads (32b) on the disk (or other non-volatile memory)(30) for running one or more hardware supported FAT (File Allocation Table) areas. Preferably, during or after a fast-boot or a Reset that uses the memory Image (and/or even during or after a normal boot), if the FAT of the disks needs to be checked, preferably it is done in the background, after the user can already start working, since waiting for scandisk to finish can take several minutes and can be very aggravating to most users. Preferably the Scandisk (disk canning software) or similar software is backed up by special Hard-disk hardware, in a way similar to the hardware that supports automatic disk rollback, described in the reference to FIG. 2. Preferably this is done by using hard-disks wherein a special area or areas (32) is dedicated for FAT information, and preferably independent head or heads (32b) are used for read and write in those areas. Another problem with scandisk is that for example in Windows 98 scanning the drive where the OS is installed (typically drive C:) can take a long time, since many background operations can cause the scan to restart. So preferably even if there are problematic background changes at the time of the scan, preferably the system automatically keeps track of its recent scanning activity and thus preferably can jump back and forth temporarily if needed but does not need to restart the scan after such changes. This has the further advantage that also with normal disk activity any reading or writing of files can become faster even if they are fragmented, since less movements of the heads are needed to access the FAT area each time some jump is needed. Since each disk can have more than one partition, preferably the FAT areas of all partitions are kept in the same special area or areas (32). Preferably these areas are also guarded better in terms of security, so that for example any write-access to them is monitored more closely. Of course, various combinations of the above and other variations can also be used, such as for example various combinations of features of FIG. 2 with features FIG. 3, so that for example both separate FAT area or areas with special access and other separate Rollback area or areas with special access are used, or for example the same special area or areas are used for both the rollback and the FAT. Another possible variation is that the disks or other non-volatile memory contain also one or more processors that can themselves conduct the comparison between the files and the FAT, so that it can be done in the background even with little or no consuming of CPU resources from the computer itself. Of course, similar principles can be used also in other types of non-volatile memory that exist or will exist in the future, so that for example if some MRAM (Magnetic RAM) or 3D memory chips are used, preferably the FAT area or areas have independent access such as for example independent communication channel and/or processor for fast access without slowing down the normal access the actual data areas. Similar principles can be used for example to speed up writing and/or reading for example on CDs, DVDs, and writeable or rewriteable CDs or DVDs (for example by using two or more separate laser beams—one or more for the normal data and one or more for a FAT or similar area), since jumping back and forth between the FAT area and the normal data areas is one of the things that most slow down such devices for example when copying a large number of files to them. Of course, these features can be used also independently of any other features of this invention. Of course, various combinations of the above and other variations can also be used.

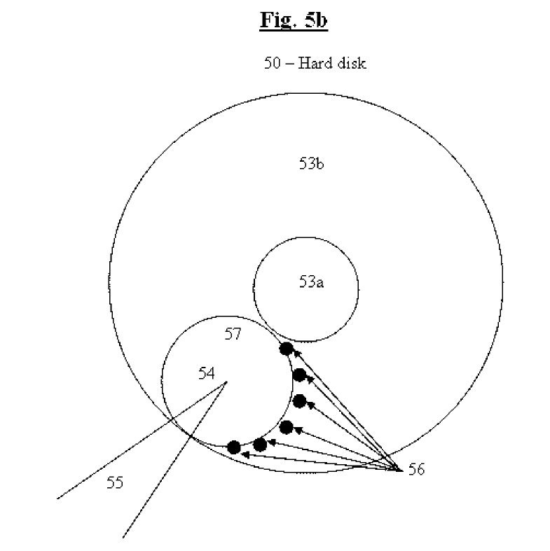

Referring to FIGS. 5a-c I show illustrations of a few preferable configurations that can considerably increase the speed of the hard disk and/or reduce its power consumption. FIG. 5a shows a hard disk (50) with one of the rotating plates (53a) and its central hub (53b). As can be seen, the arm (55) that contains the read-write head (51) rotates part of a circle (along the dotted arc) in order to reach any desired track in the disk. Typically there are multiple such plates, and the arms go also between them, so that typically each arm can read/write the relevant sides of both the plate that is above it and the plate that is below it. (Typically all the arms move together between the plates, thus reading and writing the same tracks on multiple plates at the same time, however making for example one or more of these arms independent from the group can supply for example the desired independent heads for the independent rollback area and/or independent FAT area that were discussed above). By adding for example a preferably small fork with an additional head (52) the arm now only needs to move half of the way in order to reach any desired track, so that head 52 can take care of all the inner tracks and head 51 can take care of all the outer tracks. Since the arm itself is much more massive than the heads, this addition should not cause a significant addition to the total mass of the arm. An additional improvement is that preferably both heads can now read and write at the same time, thus doubling also the speed of data transfer. Of course, this is just an example and for example more than one additional head can be added in a similar way to each arm, so that for example there are a number of such forks (for example all at one side, or more preferably at both sides of the arm, to keep the balance, so that head 51 becomes in the middle. (Like head 51, the added head 52 is preferably actually two heads, one for reading the appropriate side of the plate that is below it and one for reading the appropriate side of the plate that is above it). FIG. 5b shows a similar solution, except that the arm (55) is now stationary, preferably reaching the middle track, and preferably at its tip (54) is connected an additional preferably thin rotating plate (57) which contains preferably multiple read-write heads (56). This plate is preferably rotated by a flat step engine or voice coil, and its mass is now preferably much smaller and also the amount of rotation needed is much smaller (for example only ⅙ or the original arc, if there are now for example 6, preferably double sided, read/write heads). And like in FIG. 5a, preferably each head covers only its own range of tracks and all heads can preferably work simultaneously, so that preferably when the data is written it is also spread between the tracks accordingly, thus increasing the read/write transfer rate by a factor of 6, in this example. (Of course 6 heads is just an example and any other convenient number can also be used). The smaller mass of plate 57 and the much smaller range of rotation that is needed can thus also reduce considerably the power consumption and thus can be especially fit for example also for hard disks in laptops (mobile computers). However, using such a round small plate has a problem that the movement of the heads in relation to the disk is not linear, so that for example the heads that are near the innermost track and near the outermost track move much less then the middle heads, thus creating a large difference in the thickness of the corresponding tracks. Therefore, instead of a round small plate preferably the heads are on a special shape that corrects for this non-linear movement—for example some concave hyperbolic shape or cycloid shape or other mathematically appropriate shape (this can be done for example by changing the shape of the plate and/or by changing the positions of the heads instead of being all on the edges). On the other hand there is no such problem if the additional forks are added to in the configuration of FIG. 50a—if all the tips with the head are on the same dotted arc (Although in this case also the linearity is not complete, the distortions are much smaller due to the remote axis of rotation of the arm, and therefore they are not important, since each head keeps using the same path for writing and for reading). The configuration of FIG. 5c is very similar to that of FIG. 5b, except that the hub (54) of plate 57 is now outside the area of the disk's rotating plates (53b), thus allowing more room for the mechanics of the engine that rotates plate 57 and reducing the non-linearity problem, however the shape of plate 57 is preferably also corrected for linearity in this case like in plate of FIG. 5b. Both in the configurations of FIG. 5b and of FIG. 5c the heads can be for example just on one side of the plate (like in FIG. 5b) or on both sides (like in FIG. 5c), however if both sides are used then preferably the heads on the right are shifted in position compared to the heads on the left, so that altogether each head covers a different range of tracks. This has the advantage that more resolution in dividing the tracks between the heads can be achieved without putting the heads too close to each other. Another advantage of the configurations of FIGS. 50a-c that since each head has its own range of tracks, another possible variation is that preferably the heads that deal with more external tracks use higher frequency and thus can write more data per each track in the external tracks, thus preferably creating more even data density across the disk, unlike the current disks, in which the amount of data on the outer tracks is the same per track as in the inner tracks, thus wasting a lot of space. This can thus in addition increase the available space on the disk on average for example by a factor of 2 or more. In this case preferably each head writes according to the highest density that can be used in the most inner track within its sub-range of tracks, however another possible variation is that each head can also increase it frequency when moving into the more external tracks within its range. Of course these configurations are preferably used for all the layers of the disk, so that preferably multiple such side plates replace the normal arms. Another possible variation is that, for example in the configurations of FIGS. 5b and/or 5c, instead of jumping into a certain position each time, plate 57 for example constantly rotates (thus removing the need for fast acceleration and stopping for each jump), and the rotations of plate 57 and of the disk's plates (53b) are specially correlated. In this case also, the shape of the plates is preferably specially designed to correct for various linearity problems and/or to create special more desired patterns of intersection with the disk's rotating plates. However this solution is much more problematic and requires unusual read/write patterns. Another possible variation is for example independent arms for each sub-range of tracks, but that would be more expensive and less efficient. Of course these are just examples and other configurations with similar principles can also be used. Of course, various combinations of the above variations can also be used. Of course, like other features of this invention, these features can be used also independently of any other features of this invention.

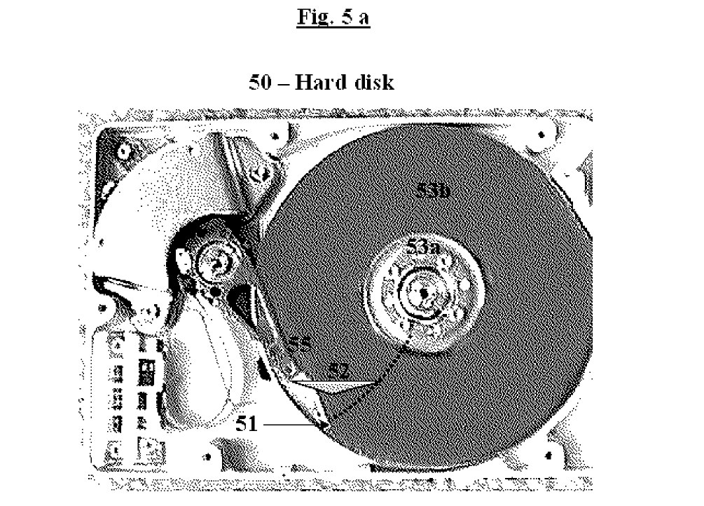

FIGS. 4 & 6 have been mentioned briefly in the patent summary and are just used for illustrating certain points in the prior art.

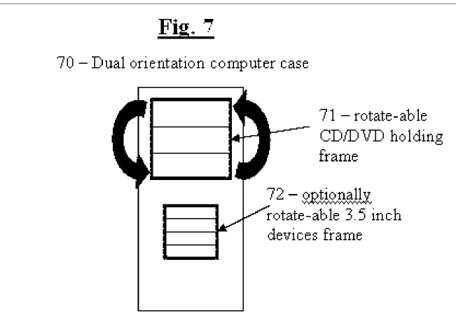

Referring to FIG. 7 1 show an illustration of an improved computer case (70) in which at least the area that supports the external CD and/or DVD drives (71) is preferably rotate-able between two positions, so that the same case can be used either as a desktop case or as a tower case, thus giving the user much more flexibility in choosing the most convenient orientation without having to buy different cases. This is preferably done by making the case strong enough to support even large screen on top of it when used in the desktop orientation, and preferably at least the area that supports the external CD and/or DVD drives (71), is preferably rotate-able between two positions, preferably in 90 degrees (preferably only back and forth between the two position—to avoid excess bending of the cables), so that preferably the user can easily choose one of these two position, at least by screwing the part when the case is open, but even more preferably the user can for example press one or more levers or buttons and then can preferably rotate the part even when the case is closed. Another possible variation is that for example the frame that holds the 3.5 devices (72) is also similarly rotateable, although that is less important since for example zip drives, hard disks and normal diskette devices can work ok both in the horizontal and ion the vertical position. Preferably the rotating frame can be for example pulled a little out to the front and then rotated when slightly outside of the case—so that the corners of the frame can rotate freely (preferably the inner part of the frame has a part with round edges), or for example the rotating frame has its corners always a little in front of the case, so that it can be rotated even without having to pull it out forwards.

While the invention has been described with respect to a limited number of embodiments, it will be appreciated that many variations, modifications, expansions and other applications of the invention may be made which are included within the scope of the present invention, as would be obvious to those skilled in the art.

1. A System for improving the efficiency, comfort, and/or reliability in Operating Systems, comprising at least one of:
a. A mechanism that instantly Reset the OS into the normal state it would be in after a successful boot, without the need to boot at all;
b. A mechanism that automatically scans the nonvolatile memory in the background without significantly slowing down the computer after a boot or a Reset while allowing the user to immediately start working after the boot or Reset;
c. A mechanism that prevents other programs from snatching the focus while the user is typing;
d. A mechanism that allows the user to install a new Operating System in another partition or directory with copying the desktop of the original system to the new system and automatically converting as many programs as possible to work in the new system;
e. An automatic rollback feature that is adapted to enable undoing any changes on the non-volatile memory;
f. Independent access mechanisms to at least one rollback area, so as not to adversely affect speed of access to the normal data areas;
g. Independent access mechanisms to at least one FAT area, so as not to adversely affect speed of access to the normal data areas;
h. Improved versions of at least one of Word processors and Internet browsers and/or other applications.

2. A method for improving the efficiency, comfort, and/or reliability in Operating Systems, based on at least one of the following steps:
a. Providing a mechanism that instantly Resets the OS into the normal state it would be in after a successful boot, without the need to boot at all;
b. Providing a mechanism that automatically scanns the nonvolatile memory in the background without significantly slowing down the computer after a boot or a Reset while allowing the user to immediately start working after the boot or Reset;
c. Providing a mechanism that prevents other programs from snatching the focus while the user is typing;
d. Providing a mechanism that allows the user to install a new Operating System in another partition or directory with copying the desktop of the original system to the new system and automatically converting as many programs as possible to work in the new system;
e. Providing an automatic rollback feature that is adapted to enable undoing any changes on the non-volatile memory;
f. Providing independent access mechanisms to at least one rollback area, so as not to adversely affect speed of access to the normal data areas;
g. Providing independent access mechanisms to at least one FAT area, so as not to adversely affect speed of access to the normal data areas;
h. Providing improved versions of at least one of Word processors and Internet browsers and/or other applications.

3. The method of claim 2 wherein in at least one word processor at least one of the following features exists:
a. Switching the dictionary also automatically switches the language correspondingly in the small window or area where the word has to be entered;
b. When using the dictionary the user can use also forward and/or backwards movement, so that he can go back or forward to previously checked words;
c. When opening files with the windows dialogue box the dialogue box automatically adjusts its size to a size that is sufficiently large to display the full file name if one or more of the file names that are displayed is longer than the default, and/or a slide bar is added (for example at the bottom) that allows the user to scroll and see the full name;
d. When deleting a file in the dialogue box that displays existing file names, by default immediately after the deletion the display is updated so that the list of files is displayed more or less in the same position;
e. The word processor program allows the user also options of searching for the next marked changes;
f. If the user wants to mark large areas with the mouse, pressing some key can significantly increase the speed of the scrolling;
g. If the user wants to mark large areas with the mouse, moving the mouse further to a more extreme position significantly increases the speed of the scrolling;
h. If the user already marked a section for example with the mouse and then uses the mouse to click on something else and then wants to go back and increase or decrease the marked area, he/she can still use the mouse and/or other keys to go back and extend or reduce the section without having to start marking again from the beginning;
i. If the user first marks the entire file he/she can then use the mouse and/or other keys to reduce the marked section or remove parts of it;
j. The user can also search for numbers or letters of logical paragraph numbering;
k. The user can automatically reformat all the logically numbered paragraphs globally or in a marked section that contains multiple indentation levels, by at least on of: defining the indentation for each level, and defining general incremental indentation rules.

4. The method of claim 2 wherein in at least one word processor at least one of the following features exists:
a. The user can also search for numbers or letters of logical paragraph numbering;
b. The user can automatically reformat all the logically numbered paragraphs globally or in a marked section that contains multiple indentation levels, by at least on of: defining the indentation for each level, and defining general incremental indentation rules.
c. When the track changes feature is On and the user breaks an automatically numbered paragraph, only the new break and the change in subsequent renumbering are shown, and the part after the break is not marked as new text, and when comparing files the same consistent difference is shown;
d. When a text is marked as deleted as a result of track changes or of file comparison the user can mark the deleted text or part of it and press a key or button or otherwise execute a command which can instantly undelete it;
e. The user can mark and copy text that is marked as deleted or any part of it and can paste it back at the same place or elsewhere as normal text;
f. The user can use a command that fades (or otherwise changes) the color of the older changes so that all the new changes from that point on will stand out;
g. The user can define separate colors for displaying the changes on the screen and when printed;
h. The user can define separate colors for displaying the changes on the screen and when printed, and by default the on-screen display is the automatic colors, and the printing by default in black if a black and white printer driver is used;
i. When comparing a group of two or more files, a summary table or other type of index can be automatically generated so that the table or index indicates which color was added on which date, so that the user can clearly see which change was entered at each date;
j. When comparing a group of two or more files, the date in which each section or element was added or changed is automatically indicated near the relevant text;
k. When comparing a group of two or more files, the files are automatically sorted by date before creating the comparison, and each new section or element is dated automatically according to the first time it appeared;
l. The user can mark one or more areas in which track changes is marked as On or Off, so that different areas can be with the track changes On or Off at the same time;
m. The user can use a mode which automatically adds the words “(Currently amended)” when the user makes changes in a claim, and the words “(Currently amended)” are automatically added without track changes;
n. The user can use a mode in which deleting an entire claim automatically causes the deleted text to disappear, and the word “(Canceled)” to automatically appear instead, as if track chances has been temporarily suspended:
o. The user can use a mode in which when adding new claims at the end of the claims section, the track changes is automatically set to Off and the word “(New)” is automatically inserted at the beginning of the new claim;
p. The user can mark any area in an image or part of it and at least one of: delete it, copy it, move it, and rotate it so that all the elements in the marked section are rotated in synchrony, etc.;
q. The copy command can also be activated cumulatively, so that a sequence of conv commands can create a cumulative buffer of consecutively pasted texts, so that afterwards for example pasting at a certain position will paste back the consecutive group of pasted texts as one sequence;
r. In searching the dictionary and/or the thesaurus the user can search for synonyms of words with a specific pattern or length, or for the word itself when partial data exists, so that for example the user can use question marks or other designation to designate unknown characters;
s. The automatic error checking includes also at least some statistical and/or semantic checking of unreasonable words or word combinations that are probably a typing error even if there is such a word and/or even if it is grammatically possible, and the word processor uses at least one of the following methods to check for such errors: 1. Using at least some taxonomy of semantic knowledge; 2. Using a database of typical texts in which words and/or word combination of up to a few words are indexed according to their frequency of appearance; 3. Learning from the user's own behavior when such errors are made and then corrected by user.

5. The system of claim 1 wherein at least one of the following features exists:
a. When copying a large group of files the user also has an option of “No to all” if he is asked if to overwrite files with the same name;
b. When the user searches for files on the computer the “find files” window allows him/her to enter also more than one file name at the same time, so that all the files can be searched for during the same disk access;
c. The user can request to run various procedures also on lists of variables defined by exclusion;
d. The user can mark a group of links in the history list and/or in the bookmarks list of the browser, and/or in any web page that contains links, so that after the user marks the desired group or groups of links, the browser can automatically open multiple windows so that each window accesses automatically one of the marked links and/or the browser can save multiple files automatically;
e. If multiple files are saved automatically, they are saved by default with their original names, or the user can define a group name which is incremented automatically to differentiate between the files in the group, and/or the system can automatically read he title in each of the files or web pages and use that as the name;
f. The user can easily reduce or increase the size of the printed fonts, by at least one of: A specific command when printing, and reducing or increasing the size of the fonts on the screen so that this affects automatically also the printing;
g. Reducing or increasing of fonts can be also done for a specific web page and/or for a specific site instead of Globally, since for example in Netscape the changed size remains also when;
h. The same command that reduces or increase the font size on the page (and/or another command) can cause also the images to automatically grow or shrink in addition to or instead of the fonts, and this can be done independently of changing the size of the Window;
i. The http protocol is improved so that images are automatically saved by web servers in more than one size and the browser can automatically request the same image again with some parameter that tells the server to send it in a larger size and then the server automatically sends again the same image in a larger size;
j. The user can mark a group of links in the history list and/or in the bookmarks list of the browser, and/or in any web page displayed by the browser that contains links, and can automatically print the group;
k. In sites where the user has to print separately each page in a document, the browser can allow the user to define a set of steps to be performed automatically, such as pressing the icon or link that leads to the next page and then printing it, so that after pressing the “next page” link and printing it, the user can activate a command that tells the browser for repeat the last N actions an additional M times and/or until it is no longer possible;
l. When pressing a Javascript button which designates a link with the right mouse key, the same options are available as when pressing the right mouse button over normal links, such as Open in a new Window instead of in the current window, or Save the link target instead of opening it;
m. When typing one or more words or part of a url address in the location window of the browser, the browser does not attempt to go automatically to the “.com” address, but can check also if the address can be resolved also to other Top Level Domains or domain extensions, and then preferably the browser opens e a scroll Window of the existing addresses and lets the user choose the desired one, and/or the browser can also check automatically in the background, which of these possibilities shows up higher and then sort the options by popularity or even choose automatically the most popular option;
n. The user can tell the OS and/or the browser and/or the service that the user acquired domain names from, to automatically perform all the actions necessary to renew one or more specific domains on time even if the user forgets to do it, by at least one of the following methods: 1—The browser can automatically login to the site and perform the necessary actions for renewal, 2—The service is instructed to renew it automatically like a subscription if the user does not cancel the automatic renewal until the automatic renewal time;
o. The OS and/or the browser can automatically sense the width or size of the screen and/or the resolution and/or number of fonts available, so that if a table does not fit in the page and necessitates creating automatically a horizontal scroll bar, the browser and/or the OS can decide automatically to reduce the font size accordingly so that the scroll bar is not needed and/or reduce only the width of the fonts, so that the fonts become thinner.

6. (canceled)

7. The method of claim 2 wherein at least one of the following features exists:
a. The user can disable the Autorun feature that enables programs on CD's to start running automatically when the CD is inserted into the computer, without having to disable for that the Auto insert notification for that drive;
b. When printing Internet pages the browser or the printer driver shows the number of pages that will be printed before the user starts the actual printing;
c. The user can logically disable or change the function that pressing various keyboard keys has on the OS and/or on any programs that are running;
d. The dynamic linking possibilities are improved so that the user can call and use any Windows DLL from a DOS program and/or vice versa, so that Windows modules and DOS modules can transfer data between them without having to use intermediary file storage;
e. The dynamic linking possibilities are improved so that the user can call and use any Windows DLL from a DOS program and/or vice versa, by defining appropriate stubs and/or API interfaces that bridge between the two types, including any necessary conversions that are needed for compatibility, and/or using sockets and/or client/server connections within the same computer;
f. When the user searches for programs in the “Start menu” the user can request the System to automatically sort the list of installed programs in the start menu by alphabetic order, or to jump automatically to a given program in the list by typing the first letters of its name and/or a search string that is at least similar to the desired name;
g. In order to market the OS in low-income countries without damaging sales in countries where a normal price can be charged, the OS is sold at the desired low-income countries at the low price with few or no limitations that result in reduced functionality to the user, at least one of the following steps is used: 1. Limiting these cheap versions so that at least part of the interface and/or some application works only in languages that are not useful to most people outside the cheap countries: 2. Displaying a warning whenever the OS is started that it is illegal to use this version of the OS in any either countries than the list of qualifying countries, unless the user has a citizenship of one of these countries and/or is resident there; 3. The OS checks automatically when the user connects to the internet if his/her IP address is in one of the qualified countries and, if not, require some certification to be filed which proves that the user is entitled to use that version of the OS outside of those countries and/or automatically stop working or start working with only limited functionality after a certain time period if said certification has not been filed.

8. The system of claim 1 wherein at least one of the following features exists regarding changing the size of fonts and/or icons and/or images:
a. The user can reduce the size of fonts and/or icons and/or images on the computer's desktop by a command that affects the entire desktop and/or a marked section in it by any desired factor, and without having to restart the computer to see the change, and the change is seen instantly, like when increasing or reducing the font size in the browser;
b. If increasing the size of fonts and/or of icons on the desktop causes a problem that some icons no longer fit on the desktop, this is automatically handled by at least one of: 1. Creating vertical and/or horizontal scroll bars at the edge of the desktop, like in a normal directory window in which there items that don't fit in the Window, so that the user can drag items back in and/or resize the desktop in order to get rid of the scroll bars; 2. The system can automatically reduce spaces between icons and/or recommend to the user the maximum size that can be used without problems;
c. The OS supplies the user with an Undo command and/or a Redo command for changes in the desktop icon sizes and/or for moving icons;
d. The OS supplies the user with an Undo command and/or a Redo command for changes of moving and/or resizing icons in a directory and/or in other windows;
e. The undo of moving and/or resizing icons is incremental, so that the user can roll back till the start of the changes;
f. The OS automatically prevent the possibility that reducing the resolution and/or increasing the system font size can cause the window that asks if to keep the new resolution to appear outside of the desktop and/or cause the text is various system message windows to appear truncated, by automatically calculates the new size and ratios and thus makes sure that all the message windows appear in a visible area and that the text size in them fits the message window;
g. If the user changes the screen resolution, the fonts and/or icons on the desktop and/or in other places or applications by default remain more or less the same size, by automatically correcting for the changes caused by the changed resolution, so that if the user increases the resolution the fonts and/or icons and/or images can be automatically increased in size to compensate for this and if the user decreases the resolution the fonts and/or icons and/or images can be automatically reduced in size to compensate for this, with or without keeping the aspect ratio between height and width;
h. The user can also undo or redo changes such as for removing or adding or changing the position of items that constantly appear near the task bar;
i. By default at least the distances between the icons are corrected in each direction by its appropriate ratio of change.

9. The system of claim 1 wherein in Tablet PC's and/or similar devices and/or other devices that accept direct input by handwriting, when the user enters text in handwriting, the system automatically solves the problem of insufficient room in a text input box or window by at least one of the following ways:
a. Letting the user continue his/her writing even beyond the edge of the input box, and then the Operating System and/or the browser or other application automatically knows from the continuity of the written text and/or from the continuity in time that this is the continuation of the same text, and therefore interprets it correctly as if it is still in the input box even if its spills out;
b. If the user runs out of space in the input box, the System and/or the browser and/or other relevant application automatically extends the box to the appropriate direction;
c. The area where the user is writing can automatically be zoomed in, however this automatic zoom does not effect the user's hand writing itself, so that the handwriting can remains at the same size and position;
d. At least the part of the handwriting that spills out of the input box is at least partially transparent and/or is visible only when the user hovers or positions the pen and/or cursor and/or mouse near it;
e. If the user for example is entering text by handwriting in some open text window and his handwriting exceeds the edge of the window, the System automatically recognizes by the continuity of the hand writing and/or of the temporal sequence that this belongs to the same text and thus the system keeps the focus in the current application even if the user for spills letters on another nearby window of another application.

10-13. (canceled)

14. The system of claim 1 wherein at least one of the following features exists:
a. When more than one OS is installed on the same computer the user can switch the default OS to whichever option he/she wants and/or change the order of the options (where typically the first option becomes the default) by letting the user drag an option line with the mouse to a different position in the screen that asks which system to boot;
b. When more than one OS is installed on the same computer the system automatically remembers the boot option that was last chosen and makes it automatically the default for the next boot until the user changes it;
c. When more than one OS is installed on the same computer the system automatically makes the chosen option in the boot menu into the first choice on the boot menu on the next boot;
d. Network computers in wireless networks use also automatic triangulation of the source of transmissions, so that the coordinates of the allowed space are entered into the system and/or only specific locations of known devices are white-listed, and so any intruder from an outside position cannot pretend to be an authorized user even if he succeeds in finding a vulnerability in the encryption;
e. When the user enters the task manager he/she can mark multiple programs and then tell the OS to close all of them at once;
f. When the user tries to force the closing of an application through the task manager and/or in other contexts, in case said application hasn't been closed, the OS automatically tries again repeatedly to close it at least for a certain number of times and/or till a certain time limit;
g. Opening additional pages in the browser as additional tabs within the same window, the browser and/or OS are changed so that Alt-F4 closes only the current page (tab) and/or Alt-Tab switches also between the tabs, and/or when closing a tab page by Alt-F4 the browser or the OS warns the user or asks if he/she wants to close just that page or the entire browser window with all the open tabs;
h. In at least one of word processing programs and/or Internet browsers and/or other software the user can move any icon and/or any menu item and/or sub-menu item to any desired position by dragging it with the mouse and at least one of the following features exists: 1. The same icon and/or menu item automatically continues functioning on the new position; 2. This new position is saved automatically also after the user closes the application; 3. The user can also undo any such changes: 4. The user can also undo any such changes even after the application has been closed and reopened; 5. This feature is supported automatically for by compilers, so that the programmer does not have to do almost anything in order to enable it;
i. When Internet pages are printed, the browser and/or the OS and/or the printer driver automatically check if lines are about to be truncated in the printing and, if so, this is automatically prevented by at least one of: 1. Automatically converting to landscape mode; 2. Automatic additional line wrapping if possible; 3. Automatically reducing the left and/or right page margins; 4. Automatically reducing the font size; 5. Informing the user about the problem and asking him to choose from a number of possible solutions; 6. Allowing the user to decide to truncate less important parts on the left of the pages; 7. The user can mark just part of the displayed HTML pane and then use a command that prints only the marked area;
j. The installation disk of the OS contains also one or more typical usable disk images, so that the system can be instantly installed from the most appropriate image, and then the system automatically determines the actual computer's configuration and simple corrects and/or adds appropriate device drivers and/or makes other necessary adjustments, as if the system was already installed on that computer and the hardware was later changed;
k. In order to save bandwidth when looking for updates, at least one of the following is done in browsers and/or the html protocol is changed: 1. The html protocol is changed so that it is possible to define “refresh on a need basis”, which means that the refresh command is initiated automatically by the site when there is any change in the page, so that the browser can get a refresh even if it didn't ask for it; 2. The html protocol is changed so that the browser asks for refresh more often, but if nothing has changed then the browser sets just a code that tells it to keep the current page or window as is; 3. When the refresh is sent, it can be a smart refresh, which tells the browser only what to change on the page instead of having to send the entire page again; 4. The pare or part of it can remain open like a streaming audio or video so that the browser always waits for new input but knows how to use the new input for updating the page without having to get the whole page again and doesn't have to do anything until the new input arrives.

15. (canceled)

16. (canceled)

17. The system of claim 1 wherein at least one of the following features exists in
at least one word processor:
a. If track changes is used and the strikeout text contains letters on which it is hard to notice the strikeout, the strikeout line is automatically moved higher or lower on such characters, and/or for strikeout line is automatically made of a different thickness and/or length and/or angle and/or color;
b. Striked-out words behaves like normal words on the dictionary;
c. The user can mark one or more areas in the file and activate the “accept changes” command and then the “accept all changes” can be automatically done only in the marked areas;
d. When there are different sets of marked changes, the user can instruct the word processor to automatically accept all the changes but only from a certain date or dates or a certain source or sources;
e. The dictionary allows the users to use back arrows in order to go back to previous points in the dictionary. Another preferable improvement for example in words processors, and especially for example;
f. When the user wants to correct intermittently two or more sections in the same file, the user can press a key or combination of keys which causes the position in the word processor to jump automatically between the various last edited sections;
g. The word processor automatically checks the date in the system in short intervals and thus updates the date field automatically whenever it has changed, and not just if the user reopens file or prints it;
h. The user can mark with the mouse more than one area at the same time by pressing some key that tells the application not to remove the mark from the previous marked area or areas;
i. When track changes is used and a section is deleted and then reentered next to the deleted text, the word processor can automatically integrate then by removing the deleted redundant part;
j. Word processors and/or other applications and/or the dialogue box can remember and display automatically the last requested file pattern when the user tries to open a new file and if the user presses Enter then this last pattern is used:
k. When the user tries to make a repeated change but confirm it at each step (instead of just global change), the position of the search-and-replace dialogue box is always kept constant and the text itself is automatically always scrolled so that the relevant part is visible;
l. When the user tries to make a repeated change but confirm it at each step (instead of just global change), the position of the search-and-replace dialogue box can move, but when it moves the mouse cursor automatically jumps with it, so the user does not have to move the mouse to correct for the change is the position of the search-and-replace dialogue box;
m. If the user copies and pastes a new http link over a previous http link, the word processor (or other application) automatically replaces also the internal link to automatically comply with the visible link, or saves only the visible link and uses that information when the user tries to access the link;
n. When the thesaurus is used the dictionary shows near each newly found word of the thesaurus also its translation to the other language and/or a short description of its more precise meaning in a few words;
o. The thesaurus and/or the dictionary automatically takes into consideration the context in which the word exists in the file, so that when displaying semantic trees or groups of semantic branches the groups or branches are pre-sorted according to the most likely meaning when taking said context into consideration and/or only the most likely meaning branch is shown;
p. The automatic typing-error-correction system takes into account also the context, and at least one of: The system chooses the word most likely according to context when there is more then one reasonable correction and/or in cases the system is not sure it shows the user that there is more than one likely correct word and asks him/her to choose the preferred one;
q. The user can activate a command which automatically indicates all the words in which spelling errors were previously automatically corrected the word processor, so that the user can check specifically these words to see if there were any such errors of changing the word to something that was not indented by the user;
r. The user can change page definitions also for a single page or range of pages and not just automatically for all the pages;
s. When using cut & paste if the user presses by mistake again “\hat{ }C” (copy) instead of \hat{ }v (paste), the user can press some undo key which brings back the previous copy buffer;
t. word processors and/or editors that are used for editing software programs can mark automatically matching pairs of brackets in a way that the user can easily see the matching pairs and wherein said marking is done by at least one of:
Showing each pair in a different color and Show the matching pairs in a different style or for in a different height.

18. (canceled)

19. The system of claim 1 wherein at least one of the following features exists:
a. If the user aborts a virus scan and later wants to continue, the program can automatically continue from the last point reached;
b. The user can add to a portable computer a mini-keyboard which completes for the side keypad and/or any other keys in a way that tells the portable computer not to regard it as a replacement keyboard that disables the portable's built-in keyboard but regard it as adding certain keys to the internal keyboard;
c. The user can use the combined fax/printer/scanner and/or a normal scanner to send faxes directly through the Internet through the computer's Internet connection, which is enabled by a change in the device's firmware and/or by adding the appropriate software to the computer, so that the user can send faxes directly and instantly the same as he/she would be sending them through a normal phone line, except that the fax is sent through the Internet;
d. If the user for closes an application window he/she can still press some undo button which automatically reopens the last closed file, and this is enabled by the relevant applications and/or the OS creating automatically a temporary backup of the open window or file when the user closes it;
e. When trying to delete a directory through a command prompt window the OS tells the user that it is a directory and tells him/her also the number of subdirectories and/or the total number of files in that directory tree and/or the total size;
f. The user can tell the OS not to enter sleep mode until a specific application has finished running;
g. The user can tell the OS not to enter sleep mode until a specific application has finished running by clicking on the applications window or for example on the square that represents it in the task bar and marking the relevant option in a menu;
h. If the user does not find a certain file name the OS automatically checks for similar names and shows the user the list of closest file names available, sorted by closeness;
i. When an internal Window of a program is in front of a background window of that program and does not allow accessing the background window until the front window is closed, the OS automatically allows the user at least to move the previous window and/or perform at least other acts that do not change the way the software behaves but allows the user at least to control the view of the background window;
j. The fax logs automatically indicate near each communication also the resolution that was used in the transmission and/or if the fax was in B/W or in color;
k. The user can indicate example that the firewall should not close the web and/or the screen saver should not be activated until a certain application has finished performing some operation;
l. When a computer becomes compromised by a Trojan and becomes a spam-relay station, there are special sites or routers which identify the attacking computers and can send the users who's compromised computers have participated in the attack automatic warning messages, directly to their IP address or to their email;
m. IP addresses of compromised computers are automatically updated in one or more special URLs in real time and the OS and/or the browser automatically checks regularly in one of these official sources and sees if the IP address fits the real current IP address of the current user's computer and then warns the user;
n. The firewall and/or the Security system and/or the OS can also indicate to the user automatically whenever some application is trying to download a file, or the user is warned only if an apparently executable file is being downloaded;
o. The firewall allows the user to change the permissions of multiple applications at the same time in the firewall's table by marking entire columns or other areas and then changing automatically the permissions in the marked areas,
p. In the dialogue box that allows the user to choose directories and files and/or in the explorer Window file extensions are shown even when the associated application is known;
q. In the dialogue box that allows the user to choose directories and files and/or in the explorer Window in addition to the icon that shows the associated application the window shows also an additional Icon that represents the general type of the file regardless of the associated application;
r. The user can change the position of the normal boxes on the taskbar that represent normally running programs by draging them with the mouse, so that the user can conveniently re-arrange their position without having to close and reopen these programs.

20. (canceled)

21. (canceled)

22. The system of claim 1 wherein at least one of the following features exists:
a. When uploading a file while submitting form in an Internet browser, the browser specifically warns the user about the file name and/or path and/or size, so that the warning is more specific about such files, instead of or in addition to the normal warning if the user really intends to submit the form itself;
b. When the user types text for entering in some field in a form, the browser and/or the OS can keep it automatically in some buffer, so that if the user starts to type before the actual form field is reached, the typing is not lost but is added automatically the browser or by the OS to the beginning of the input line;
c. The user can perform commands that affect a group of open windows, such as entering a command that prints all of them or that saves all of them or that bookmarks all of them—by entering the global command in one of the open windows of the same application, or by marking multiple boxes in the task bar and then entering the command;
d. The user can perform commands that affect a group of open windows, and in this mode the user choose automatic carrying out of the global command or to be prompted for each of the windows with the option to choose yes or no in each case;
e. The internet browser lets the user to darken with the mouse a group of checkboxes and then with one command mark or unmark the entire group;
f. The internet browser lets the user drag the mouse over a group of checkboxes, so that dragging it with the left button pressed immediately marks each box on the way and dragging it with the other button pressed unmarks each checkbox on the way, or vice versa;
g. When the user is filling Online forms, the Internet browser can automatically take into account the language of the text near each form field and automatically accept by default the input in the appropriate language;
h. The user can unmark a radio button by clicking on it again or by using another mouse key;
i. If there are more than once CD and/or DVD installed on the same computer they can be connected to a common audio connector in parallel or with some multiplexor, or cables from more than one drive can lead to a common connector or multiplexor near or at the sound card;
j. No direct connection to the sound card is needed from any of the drives, and each CD or DVD that contains sound is played by activating the sound card directly through the software that plays the data, in the same way that the sound is played from an avi file on the hard disk.

23. The system of claim 1 wherein at least one of the following steps is used to protect the user from phishing attempts:
a. The browser or the email client automatically indicates to the user when the real href is different from the http address that is visibly shown in a link, or warns the user about this after he/she clicks on the link and gives him/her a chance to cancel before actually going to the link;
b. The browser or email client automatically indicates to the user also the real url that is within the href in the normal display of the page—next to the link or superimposed on it;
c. The browser automatically makes sure that the url in the location window is indeed displayed exactly like the actual url that it connects to, and if there are unprintable characters then they are marked with some sign and do not effect the printing of the rest of the url;
d. If there is any attempt by Javasrcipt or Active-X or some other portable code or any other program on the user's computer to put other data on top of the location Window then this is automatically prevented by the browser and/or the OS and/or the computer's Security System;
e. If there is any attempt by Javasrcipt or Active-X or some other portable code or any other program on the user's computer to put other data on top of the location Window then this is automatically prevented by automatically preventing other programs from putting any windows in front of the browser window unless the user explicitly transfers the focus to them, and/or by automatically intercepting windows that have a suspect size or shape or location or that otherwise have suspicious or unusual qualities;
f. Email messages that contain clearly misleading hrefs where the visible link does not fit the real link can be automatically blocked by spam filters, thus not reaching the user at all;
g. Normal spam filters are also improved to identify automatically for example typical patterns of mixing digits with letters in a way that tries to bypass word filters;
h. When the browser enters a site it automatically checks also a relevant WHOIS database and displays to the user automatically also the name under which that domain is registered and/or the country and/or other details that can easily indicate to the user if a site is phony.

24. A portable computer wherein the computer and/or the OS and/or the relevant part of the hardware can automatically increase or decrease its power consumption according to sensing if the computer is currently connected to the network electricity or is currently running on the batteries and/or the user can request it explicitly for a short time, wherein at least one of the following is done:
a. The hard disk's speed can be considerably improved;
b. The disk has at least two sets of engines or at least two sets of coils, which are used at different combinations in order to work in the low speed or in the fast speed; and/or the disk's DSP automatically starts working at higher MHz when the wall power is sensed, and/or more than one DSP can be used in order to speed up the processing;
c. The speed of the CPU can be improved so that it consumes more power and works faster;
d. The brightness of the screen can be increased.

25-28. (canceled)

29. The system of claim 1 wherein at least one of the following features exists:
a. When the user asks Windows to create a restoration point, the user has a choice of indicating if he/she wants a normal restoration point or also creating a full snapshot of the main system and registry files and/or the user can define in general if and/or when snapshot or normal restoration point will be generated when the system automatically creates them and/or the system automatically creates the snapshot files whenever it is about to make highly significant changes for example in the system;
b. Rollback info is saved automatically in more than one place, together with a copy of a sufficient reference base-point, so that the system has a much better chance of restoring it even if the registry becomes seriously damaged;
c. The registry entries are made independent of each other so that even if part of the registry is damaged it will not effect anything else;
d. The system uses transaction sequences in the registry and/or in other important system files or system areas like in a normal database with automatic rollback in case the transaction has not been completed;
e. If when trying to boot the system discovers that the system needs to load a previous snapshot of the registry and/or other critical system files, during boot the user is advised of the situation and can automatically view a list of the most recent snapshots and/or otherwise possible restoration points and can choose the most referred ones to attempt and then the system restores it automatically and continues to boot;
f. At least one of the registry and other critical system files that are needed for snapshots are always automatically kept in at least two copies so that if one copy becomes unusable there is always an immediate backup of the most up to date version;
g. During boot the system uses the wasted time on the part of the user to display to the user at least one of: Details about the number of safe restoration points that exist, various indicators of the health of the system, the current automatic back-up policy that exists, the amount of remaining free space on the disk, and the percent of disk fragmentation;
h. The user can use a fax card or a combined fax-scanner-printer which is connected to the computer in order to actually send digital data files eventhough the connection starts like a fax communication, and at least one of the following features exists: 1. The sending device can send one or more pseudo fax images which are actually digital data, and when it is transmitted by Fax the sending device uses a special code to tell the receiving device that one or more pseudo page images are actually a digital file, and the receiving fax is either a computer with a fax/modem card or for example a combined fax-scanner-printer which is also connected to a computer and thus can transmit the digital file to the computer as a digital file; 2. The two devices can automatically recognize each other during the handshake as having more than Fax communication capabilities, and thus can automatically switch to some other electronic file transfer protocol between them for exchanging digital files.

30. (canceled)

31. The system of claim 1 wherein the system includes a firewall which allows giving specific applications differently rights for downloading and/or uploading information from the Internet and/or through all available communication channels or through specific communication channels and wherein the different upload versus download permissions are enabled by at least one of:
a. Automatically showing the user the statistics of sending/receiving information near each application that has been allowed to access the Internet;
b. Defining a maximum ratio between upstream and downstream for each application;
c. Defining a maximum ratio between upstream and downstream for each application and automatically blocking excess uploading and/or warning the user and/or asking for his/her authorization;
d. Defining a maximum-absolute amount of information that can be sent out per time;
e. Programs that the user wants to allow only to download data but not upload data are automatically prevented from any real access to the web, and the OS and/or the firewall and/or the security system intercept any attempt that these application make to contact the web and send the requests instead, and so only valid normal protocol requests for accessing web pages and/or for downloading data which are recognized by the firewall or other intermediate agent are allowed to go through;
f. The firewall or other agent for example cal also notice other suspect behaviors, such as requesting a web page with an unreasonable large parameters line or frequent repeated similar connections with parameter lines that keep changing.

32. (canceled)

33. The system of claim 1 wherein at least one of the following features exists:
a. The hard disk has one or more separate heads which are used only for checking the media for errors and move automatically all the time or periodically once in a while to check this without interfering with the normal function of the hard disk;
b. The task manager automatically shows near each process also to which program and/or path and file name it belongs;
c. The OS and/or the word processor can identify automatically incremental updates of the same file according to at least one of the beginning of the file name and/or sequential numbering and/or date and time and/or by keeping automatically a log of the sequence of updating a file incrementally;
d. The OS and/or the word processor can use the knowledge of the update sequence of a series of files to search for each section or sentence when was the first time that it was entered;
e. The word processing program can ask the user automatically if various changes in the way the word processor operates are intended only for the current file or for all the files in the same directory or all the files of the same sequence or all files in general;
f. The word processor is improved so that when automatically saved files are offered after a crash, even if the user closes automatically offered files, he/she can still activate an option that restores them, even if the user in the meantime closes the word processor and then later reopens it;
g. The word processor keeps one or more buffers which point to the automatically saved files and has an indication which groups of files belong together and/or to which crash event they are related, and these files are kept in the original directories of the relevant files and/or in a special directory at least for a certain time period and/or as long as there is sufficient disk space and/or until their cumulative total space exceeds some value;
h. In the word processor the user can mark one or more sections and then toggle automatically between modes so that automatic numbers and/or letters can become manual letters and/or numbers and vice versa;
i. When the user searches for a specific file or file pattern in the windows explorer and/or in similar utilities either the files are displayed by default before the directory names or the user can easily indicate if he/she prefers the directory names before the file names or vice versa;
j. After programs finish installing and request a restart, by default the OS automatically determines if a full restart is needed and then the OS automatically performs just logoff and logon instead of a full restart whenever it can determine that this is sufficient;
k. Program installers are improved so that the software vendors can easily indicate if after installation logoff-logon is sufficient instead of full restart;
l. When the user himself/herself initiates a restart command, the OS automatically asks the user if he/she really wants a full reboot and, if not, offers the user to automatically perform logoff-logon instead;
m. The logon/logoff is added also to the normal Restart/Turnoff menu, so that for instead of showing only 3 options (Standby, Turnoff and Restart) the option of fast Logoff/Logon is also added;
n. If the user chooses full reboot and/or even if he/she chooses just logoff and the system begins to close applications, first of all only user applications are closed and not system processes, and the user can still press some key if he/she changes his/her mind in order to abort the reboot, and then the attempt to reboot is aborted if it has not gone too far, and/or the system can automatically undo the process and even return the OS to the state it was before the reboot was requested;
o. The user can have two or more Operating systems running at the same time so that the user can lump between them by pressing some key or key combination or clicking on some icon, instead of having to shut down Windows and reboot, without using emulation, and at least one of the following features exists: 1. There is a mirror image of the loaded and running OS like in sleep mode, so that while the user is in one OS the other OS is dormant: 2. The user can switch between the OS's after entering sleep mode; 3. Both Operating systems can be actually running at the same time and one or more additional OS elements are operating below the two (or more) Operating Systems and are in charge of the resource sharing between them: 4. Both Operating systems can be actually running at the same time and in this mode certain functions are automatically disabled or are available to only one OS.

34. (canceled)

35. The system of claim 1 wherein at least one of the following features exists:
a. DVDs and/or blue-ray or High Definition DVDs and/or other larger capacity drives support also smaller pocket-size DVD's as burn-able media and/or as ready pre-recorded media;
b. DVD capacity is further increased by using UV or extreme-UV lasers instead of red or blue;
c. The bookmarks list in the internet browser automatically shows also near each bookmark the date it was entered, and/or the bookmarks are automatically grouped by days, with a different color for each group and/or some border marked between the groups;
d. The Internet browser keeps in memory recent changes to various form fields in the same page and/or also on previous pages, so that jumping back to a previously filled field on the same page or also on a previous page or pages will still allow the user to undo changes in that field;
e. If the user wants to copy more than one application at the same time from the “all programs” pop-up list which is activated through the Start button, to the desktop, then the user can mark more than one item at a time and/or the list remains open even after dragging an item;
f. The user can drag a shortcut also from open applications on the taskbar and/or by dragging something from the top and/or other parts of an open window and/or from the file name as it appears in a DOS or cmd window;
g. If the user wants to uninstall more than one program at the same time, the user can mark multiple programs and then all the marked programs are uninstalled automatically;
h. The user can activate a command which automatically jumps each time to the next window in the normal task bar on in the internal group of open windows that belong to the same application or between open tabs in the same application, so that each time the user moves to the next window systematically;
i. The user can define drives and/or directories to become shared when connected by cross-linked Ethernet cable between two computers so that they become automatically not shared when connected by normal cable to the Internet;
j. If the OS gets stuck during or after the boot, the system can automatically sense it after a short time and automatically identify the driver or application that caused it to get stuck and can automatically roll-back to the state it was in before the problematic driver or application was loaded and/or before the registry change or other relevant change and can automatically continue without the problematic driver or application and/or can for automatically search for a replacement driver or application and/or automatically instruct the user what to do in order to fix the problem;
k. At least part of the OS runs below the normal OS and contains also a knowledge base about known problem that can occur, with instructions on how to solve it and automatically tries to follow those self-repairing instructions whenever possible and involves the user only if for some reason it is unable to perform whatever is necessary;
l. At least part of the kernel and/or part of the OS, which is hardware independent, is able to boot properly even if there are a lot of hardware changes, so that any adjustment problems can then be fixed after this initial boot;
m. When the OS does not allow the user to access a file because it is locked by another process, the OS also lets the user know the identity of the clashing process and the clashed resource and allows the user also options such as terminate the clashing process or freezing it temporarily until the user releases again the problematic resource;
n. When there is more than one physical hard disk on the same computer and more than one partition on at least some of these disks, the OS automatically adds some mark to each drive name that indicates to which physical hard disk it belongs.

36. (canceled)

37. (canceled)

38. The system of claim 1 wherein at least one of the following features exists:
a. The user can create a copy of the OS on another partition with an automatic command, and then the system with the installed programs is automatically copied to the new partition and the drive letter references in the new installation are automatically updated to refer to the new drive letter, and the choice of the new partition is automatically added to a boot selector;
b. The user can also change the name of a boot option and/or add comments to it, while booting and/or from one or more applications that are available after the boot;
c. The user can also use an update or synchronize command, which automatically updates any differences between two or more such OS-installed partitions, so that the user can update the other partition according to additional changes made in the original partitions, and/or the opposite—automatically correct the original partition according to one of the backup partitions, and/or the user can also request automatic undo of such updates;
d. Even the new partition itself for the automatically copies OS installation can be automatically created by the special copy command, if needed, so that the user does not even need to have a new partition ready before requesting the special OS-copy command;
e. The user can mark only one or more specific installed programs and/or drivers and/or other parts to be automatically copied to the other partition, instead of automatic full copy of all the installed elements into the other partition;
f. The user can automatically backup one or more installed programs to a back-up media, so that automatically the relevant registry entry is copied to the backup media and all the relevant components are automatically copied through the relevant registry information;
g. When activating for a command like SFC (which checks the integrity of installed system files and/or compares them to their source on the installation CD and restores them when needed), this or similar commands can be used also from another OS or another installation of the OS on another partition and/or from the installation CD or DVD itself;
h. Fax machines are programmed by default (and/or at least the user can choose this option) to respond with fax sounds only if fax sounds are heard in the incoming phone
i. The receiving fax is improved so that it is preferably able to automatically identify voice calls and thus avoids making fax sounds if it identifies human voice and/or stops immediately and gets off the line even if it started making fax sounds, as soon as it identifies the human voice;
i. The ability of the scanner/copier to overcome wrinkles in papers or overcome the black stripe that appears when scanning or photocopying books when the user can't press the book down strongly enough—is improved by adding at least one more light source in the scanner, so that shadows are automatically reduced;
k. The user is supplied with an electronic pen which can write on normal paper and at the same time both writes with visible ink on the paper and transmits the writing sequence to the computer, so that the user can write normally while also obtaining an automatic copy on the computer;
l. In tablet PC's and/or in digital book readers and/or in programs such as Winamp or other software media players and/or in other gadgets for playing songs or films, the software and/or the device is able to measure automatically not only which songs or films or books (or other media) are more or less liked by the user, but also which parts or sections in them are the best and/or which parts are less good or problematic, by noting user activities.

39. The system of claim 1 wherein in order to prevent debug features in motherboard bridges from being used for hardware-based attack below the OS, at least one of the following is done:
a. The motherboard chipset is changed so that such debug features and/or direct communications between hardware cards and the hard disk are enabled only if some hardware element allows it, such as a jumper or a switch which has to be manually enabled by the user;
b. The user can add a card to one of the PCI slots and/or add another external device which keeps sending commands to the bridges which can over-ride any attempt by other devices to tell the bridge to sniff on data or to communicate directly with the hard drive and/or the communication channels;
c. The OS and/or a software Security System is able, through the OS kernel or even below it, to take complete control of the bridge and give it instructions that override any undesired attempts by hardware elements to sniff data and/or access directly the hard disk and/or the communication channels;
d. If some devices need to be able to exchange data with the hard disk directly, at least any command sent from the device to the hard disk can be monitored and filtered by the OS and/or by a security system installed on the OS, so that the OS and/or the security system can control what files and/or directories can be accessed directly from the device and what commands can be transmitted to the hard disk.

40. (canceled)
